(19) United States
(12) Patent Application Publication
(10) Pub. No.: US 2025/0211767 A1
(43) Pub. Date: Jun. 26, 2025

(54) METHODS AND DEVICES USING INTRA BLOCK COPY FOR VIDEO CODING

(71) Applicant: BEIJING DAJIA INTERNET INFORMATION TECHNOLOGY CO., LTD., Beijing (CN)

(72) Inventors: Wei CHEN, San Diego, CA (US); Changyue MA, San Diego, CA (US); Xiaoyu XIU, San Diego, CA (US); Hong-Jheng JHU, San Diego, CA (US); Che-Wei KUO, San Diego, CA (US); Ning YAN, San Diego, CA (US); Xianglin WANG, San Diego, CA (US); Bing YU, Beijing (CN)

(73) Assignee: BEIJING DAJIA INTERNET INFORMATION TECHNOLOGY CO., LTD., Beijing (CN)

(21) Appl. No.: 19/063,593

(22) Filed: Feb. 26, 2025

Related U.S. Application Data
(63) Continuation of application No. PCT/US2023/031313, filed on Aug. 28, 2023.
(63) Continuation of application No. PCT/US2023/031865, filed on Sep. 1, 2023.
(60) Provisional application No. 63/401,569, filed on Aug. 26, 2022.
(60) Provisional application No. 63/403,699, filed on Sep. 2, 2022.

(51) Int. Cl. H04N 19/44; H04N 19/176; H04N 19/189

(52) U.S. Cl. CPC H04N 19/44; H04N 19/176; H04N 19/189

(57) ABSTRACT

Methods for video decoding and encoding, apparatuses and non-transitory computer-readable storage media thereof are provided. In one method for video decoding, a decoder may obtain a current block that is Intra block copy (IBC) coded based on multi-model IBC, wherein the multi-model IBC adaptively switches among different models. Furthermore, the decoder may obtain one or more linear transformation vectors (LTVs) for the current block.

### CROSS-REFERENCE TO RELATED APPLICATION

The present application is a continuation application of PCT Application No. PCT/US2023/031313 and PCT Application No. PCT/US2023/031865, in which PCT/US2023/031313 was filed on Aug. 28, 2023 and claims priority to U.S. Provisional Application No. 63/401,569 filed on Aug. 26, 2022; and PCT/US2023/031865 was filed on Sep. 1, 2023 and claims priority to U.S. Provisional Application No. 63/403,699 filed on Sep. 2, 2022, disclosures of which are incorporated by reference in their entireties for all purposes.

### FIELD

The present disclosure is related to video coding and compression, and in particular but not limited to, methods and apparatus on improving the Intra Block Copy method in a video encoding or decoding process.

### BACKGROUND

Various video coding techniques may be used to compress video data. Video coding is performed according to one or more video coding standards. For example, video coding standards include versatile video coding (VVC), high-efficiency video coding (H.265/HEVC), advanced video coding (H.264/AVC), moving picture expert group (MPEG) coding, or the like. Video coding generally utilizes prediction methods (e.g., inter-prediction, intra-prediction, or the like) that take advantage of redundancy present in video images or sequences. An important goal of video coding techniques is to compress video data into a form that uses a lower bit rate, while avoiding or minimizing degradations to video quality.

The first version of the VVC standard was finalized in July, 2020, which offers approximately 50% bit-rate saving or equivalent perceptual quality compared to the prior generation video coding standard HEVC. Although the VVC standard provides significant coding improvements than its predecessor, there is evidence that superior coding efficiency can be achieved with additional coding tools. Recently, Joint Video Exploration Team (JVET) under the collaboration of ITU-T VECG and ISO/IEC MPEG started the exploration of advanced technologies that can enable substantial enhancement of coding efficiency over VVC. In April 2021, one software codebase, called Enhanced Compression Model (ECM) was established for future video coding exploration work. The ECM reference software was based on VVC Test Model (VTM) that was developed by JVET for the VVC, with several existing modules (e.g., intra/inter prediction, transform, in-loop filter and so forth) are further extended and/or improved. In future, any new coding tool beyond the VVC standard need to be integrated into the ECM platform, and tested using JVET common test conditions (CTCs).

### SUMMARY

The present disclosure provides examples of techniques relating to improving the coding efficiency of the inter blocks.

According to a first aspect of the present disclosure, there is provided a method for video decoding. In the method, a decoder may obtain a current block that is Intra block copy (IBC) coded based on multi-model IBC, where the multi-model IBC adaptively switches among different models. Additionally, the decoder may obtain one or more linear transformation vectors (LTVs) for the current block.

According to a second aspect of the present disclosure, there is provided a method for video encoding. In the method, an encoder may obtain one or more linear transformation vectors (LTVs) for a current block. Additionally, the encoder may encode, based on the one or more LTVs, the current block based on multi-model Intra block copy (IBC) that adaptively switches among different models.

According to a third aspect of the present disclosure, there is provided a method for video decoding. In the method, a decoder may parse magnitude of block vector difference (BVD) components, parse context-coded BVD sign prediction indexes, build a plurality of BV candidates by creating combination between BVD signs and absolute BVD values and add the combination into BV predictors, derive a BVD sign prediction cost for each BV candidate based on template matching cost, sort the plurality of BV candidates based on the BVD sign prediction cost, and derive a BVD sign prediction index corresponding to a true BVD sign.

According to a fourth aspect of the present disclosure, there is provided a method for video encoding. In the method, an encoder may determine magnitude of block vector difference (BVD) components, determine context-coded BVD sign prediction indexes, build a plurality of BV candidates by creating combination between BVD signs and absolute BVD values and add the combination into BV predictors, determine a BVD sign prediction cost for each BV candidate based on template matching cost, sort the plurality of BV candidates based on the BVD sign prediction cost, and determine a BVD sign prediction index corresponding to a true BVD sign.

According to a fifth aspect of the present disclosure, there is provided a method for video decoding. In the method, a decoder may obtain a bitstream including a current block combined by coding blocks based on Intra block copy (IBC) mode and at least one mode of intra mode or inter mode. Furthermore, the decoder may decode the bitstream based on the IBC mode and the at least one mode of the intra or inter mode.

According to a sixth aspect of the present disclosure, there is provided a method for video encoding. In the method, an encoder may encode a current block combined by coding blocks based on Intra block copy (IBC) mode and at least one mode of intra mode or inter mode and transmit a bitstream including the current block to a decoder.

According to a seventh aspect of the present disclosure, there is provided a method for video decoding. In the method, a decoder may obtain two or more block vectors (BVs) for a current block and obtain a final intra block copying (IBC) prediction for the current block based on the two or more block vectors.

According to an eight aspect of the present disclosure, there is provided a method for video encoding. In the method, an encoder may obtain two or more block vectors (BVs) for a current block and obtain a final intra block copying (IBC) prediction for the current block based on the two or more block vectors.

According to a ninth aspect of the present disclosure, there is provided a method for video decoding. In the method, a decoder may obtain one or more Intra Block Copy (IBC) control syntax elements that indicate whether IBC mode is enabled at different granularities. Additionally, the decoder may obtain one or more block vectors for a current block based on the IBC mode in response to determining that the IBC mode is enabled at one or more granularities.

According to a tenth aspect of the present disclosure, there is provided a method for video encoding. In the method, an encoder may determine one or more IBC control syntax elements that indicate whether IBC mode is enabled at different granularities. Additionally, the encoder may encode a current block into a bitstream based on the one or more IBC control syntax elements.

According to an eleventh aspect of the present disclosure, there is provided a method for video decoding. In the method, a decoder may obtain IBC control information according to local information associated with a current block, where the IBC control information indicates whether IBC mode is enabled. Additionally, the decoder may obtain one or more block vectors for the current block based on the IBC mode in response to determining that the IBC mode is enabled.

According to a twelfth aspect of the present disclosure, there is provided a method for video encoding. In the method, an encoder may obtain IBC control information according to local information associated with a current block, where the IBC control information indicates whether an IBC mode is enabled. Additionally, the encoder may encode a current block into a bitstream based on the IBC control information.

According to a thirteenth aspect of the present disclosure, there is provided a method for video decoding. In the method, a decoder may obtain a syntax element that is related to IBC mode, where the syntax element is Context Adaptive Binary Arithmetic Coding (CABAC) context coded. Additionally, the decoder may determine a CABAC context window that is used for each context model related to the IBC mode based on a slice type or a frame type.

According to a fourteenth aspect of the present disclosure, there is provided a method for video encoding. In the method, an encoder may determine a CABAC context window that is used for each context model related to IBC mode based on a slice type or a frame type. Additionally, the encoder may obtain a syntax element that is related to the IBC mode, where the syntax element is CABAC context coded. Furthermore, the encoder may signal the syntax element into a bitstream.

According to a fifteenth aspect of the present disclosure, there is provided an apparatus for video decoding. The apparatus may include one or more processors and a memory coupled to the one or more processors and configured to store instructions executable by the one or more processors. Furthermore, the one or more processors, upon execution of the instructions, are configured to perform the method according to the first aspect, the third aspect, the fifth aspect, the seventh aspect, the nineth aspect, the eleventh aspect or the thirteenth aspect.

According to a sixteenth aspect of the present disclosure, there is provided an apparatus for video encoding. The apparatus may include one or more processors and a memory coupled to the one or more processors and configured to store instructions executable by the one or more processors. Furthermore, the one or more processors, upon execution of the instructions, are configured to perform the method according to the second aspect, the fourth aspect, the sixth aspect, the eighth aspect, the tenth aspect, the twelfth aspect, or the fourteenth aspect.

According to a seventeenth aspect of the present disclosure, there is provided a non-transitory computer-readable storage medium for storing computer-executable instructions that, when executed by one or more computer processors, cause the one or more computer processors to receive a bitstream, and perform the method according to the first aspect, the third aspect, the fifth aspect, the seventh aspect, the nineth aspect, the eleventh aspect or the thirteenth aspect based on the bitstream.

According to an eighteenth aspect of the present disclosure, there is provided a non-transitory computer-readable storage medium for storing computer-executable instructions that, when executed by one or more computer processors, cause the one or more computer processors to perform the method according to the second aspect, the fourth aspect, the sixth aspect, the eighth aspect, the tenth aspect, the twelfth aspect, or the fourteenth aspect to encode the current block into a bitstream, and transmit the bitstream.

According to a nineteenth aspect of the present disclosure, there is provided a non-transitory computer-readable storage medium for storing a bitstream to be decoded by the method according to the first aspect, the third aspect, the fifth aspect, the seventh aspect, the nineth aspect, the eleventh aspect or the thirteenth aspect.

According to a twentieth aspect of the present disclosure, there is provided a non-transitory computer-readable storage medium for storing a bitstream generated by the method according to the second aspect, the fourth aspect, the sixth aspect, the eighth aspect, the tenth aspect, the twelfth aspect, or the fourteenth aspect.

### BRIEF DESCRIPTION OF THE DRAWINGS

A more particular description of the examples of the present disclosure will be rendered by reference to specific examples illustrated in the appended drawings. Given that these drawings depict only some examples and are not therefore considered to be limiting in scope, the examples will be described and explained with additional specificity and details through the use of the accompanying drawings.

FIG. 1A is a block diagram illustrating a system for encoding and decoding video blocks in accordance with some examples of the present disclosure.

FIG. 1B is a block diagram of an encoder in accordance with some examples of the present disclosure.

FIGS. 1C-1F are block diagrams illustrating how a frame is recursively partitioned into multiple video blocks of different sizes and shapes in accordance with some examples of the present disclosure.

FIG. 1G is a block diagram illustrating an exemplary video encoder in accordance with some examples of the present disclosure

FIG. 2A is a block diagram of a decoder in accordance with some examples of the present disclosure.

FIG. 2B is a block diagram illustrating an exemplary video decoder in accordance with some examples of the present disclosure.

FIG. 3A is a diagram illustrating block partitions in a multi-type tree structure in accordance with some examples of the present disclosure.

FIG. 3B is a diagram illustrating block partitions in a multi-type tree structure in accordance with some examples of the present disclosure.

FIG. 3C is a diagram illustrating block partitions in a multi-type tree structure in accordance with some examples of the present disclosure.

FIG. 3D is a diagram illustrating block partitions in a multi-type tree structure in accordance with some examples of the present disclosure.

FIG. 3E is a diagram illustrating block partitions in a multi-type tree structure in accordance with some examples of the present disclosure.

FIGS. 4A-4B shows an example of 4-parameter affine model in accordance with some examples of the present disclosure.

FIG. 5 shows an example of 6-parameter affine model in accordance with some examples of the present disclosure.

FIG. 6 shows adjacent neighboring blocks for inherited affine merge candidates in accordance with some examples of the present disclosure.

FIG. 7 shows adjacent neighboring blocks for constructed affine merge candidates in accordance with some examples of the present disclosure.

FIG. 8 shows a current CTU processing order and its available reference samples in current and left CTU in accordance with some examples of the present disclosure.

FIG. 9 shows padding candidates for the replacement of the zero-vector in the IBC list in accordance with some examples of the present disclosure.

FIG. 10 shows reference area for IBC when CTU (m,n) is coded in accordance with some examples of the present disclosure.

FIG. 11 shows IBC reference area for camera-captured content in accordance with some examples of the present disclosure.

FIGS. 12A-12B show the division methods for angular modes in accordance with some examples of the present disclosure.

FIG. 13 shows examples of different linear transformation models with different number of vectors in accordance with some examples of the present disclosure.

FIG. 14 shows reference sample location for a 6-parameter linear transformation model in accordance with some examples of the present disclosure.

FIG. 15 shows adjacent and non-adjacent neighbor blocks used for inherited candidate generation in accordance with some examples of the present disclosure.

FIG. 16 shows adjacent and non-adjacent neighbor blocks used for constructed candidate generation in accordance with some examples of the present disclosure.

FIG. 17 shows LTV inheritance from neighboring blocks by vector concatenation in accordance with some examples of the present disclosure.

FIG. 18 is a diagram illustrating a computing environment coupled with a user interface in accordance with some examples of the present disclosure.

FIG. 19 is a flow chart illustrating a method for video decoding in accordance with some examples of the present disclosure.

FIG. 20 is a flow chart illustrating a method for video encoding corresponding to the method for video decoding as shown in FIG. 19 in accordance with some examples of the present disclosure.

FIG. 21 is a flow chart illustrating a method for video decoding in accordance with some examples of the present disclosure.

FIG. 22 is a flow chart illustrating a method for video encoding corresponding to the method for video decoding as shown in FIG. 21 in accordance with some examples of the present disclosure.

FIG. 23 is a flow chart illustrating a method for video decoding in accordance with some examples of the present disclosure.

FIG. 24 is a flow chart illustrating a method for video encoding corresponding to the method for video decoding as shown in FIG. 23 in accordance with some examples of the present disclosure.

FIG. 25 is a flow chart illustrating a method for video decoding in accordance with some examples of the present disclosure.

FIG. 26 is a flow chart illustrating a method for video encoding corresponding to the method for video decoding as shown in FIG. 25 in accordance with some examples of the present disclosure.

FIG. 27A shows spatial neighboring blocks used by ATVMP in accordance with some examples of the present disclosure.

FIG. 27B shows an example of deriving sub-CU motion field by applying a motion shift from spatial neighbor and scaling the motion information from the corresponding collocated sub-CUs in accordance with some examples of the present disclosure.

FIG. 28 is a flow chart of decoding a bin in accordance with some examples of the present disclosure.

FIG. 29 is a flow chart illustrating a method for video decoding in accordance with some examples of the present disclosure.

FIG. 30 is a flow chart illustrating a method for video encoding corresponding to the method for video decoding as shown in FIG. 29 in accordance with some examples of the present disclosure.

FIG. 31 is a flow chart illustrating a method for video decoding in accordance with some examples of the present disclosure.

FIG. 32 is a flow chart illustrating a method for video encoding corresponding to the method for video decoding as shown in FIG. 31 in accordance with some examples of the present disclosure.

FIG. 33 is a flow chart illustrating a method for video decoding in accordance with some examples of the present disclosure.

FIG. 34 is a flow chart illustrating a method for video encoding corresponding to the method for video decoding as shown in FIG. 33 in accordance with some examples of the present disclosure.

### DETAILED DESCRIPTION

Reference will now be made in detail to specific implementations, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used. For example, it will be apparent to one of ordinary skill in the art that the subject matter presented herein can be implemented on many types of electronic devices with digital video capabilities.

Terms used in the disclosure are only adopted for the purpose of describing specific embodiments and not intended to limit the disclosure. “A/an,” “said,” and “the” in a singular form in the disclosure and the appended claims are also intended to include a plural form, unless other meanings are clearly denoted throughout the disclosure. It is also to be understood that term “and/or” used in the disclosure refers to and includes one or any or all possible combinations of multiple associated items that are listed.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

Throughout the disclosure, the terms “first,” “second,” “third,” etc. are all used as nomenclature only for references to relevant elements, e.g., devices, components, compositions, steps, etc., without implying any spatial or chronological orders, unless expressly specified otherwise. For example, a “first device” and a “second device” may refer to two separately formed devices, or two parts, components, or operational states of a same device, and may be named arbitrarily.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

As used herein, the term “if” or “when” may be understood to mean “upon” or “in response to” depending on the context. These terms, if appear in a claim, may not indicate that the relevant limitations or features are conditional or optional. For example, a method may comprise steps of: i) when or if condition X is present, function or action X′ is performed, and ii) when or if condition Y is present, function or action Y′ is performed. The method may be implemented with both the capability of performing function or action X′, and the capability of performing function or action Y′. Thus, the functions X′ and Y′ may both be performed, at different times, on multiple executions of the method.

A unit or module may be implemented purely by software, purely by hardware, or by a combination of hardware and software. In a pure software implementation, for example, the unit or module may include functionally related code blocks or software components, that are directly or indirectly linked together, so as to perform a particular function.

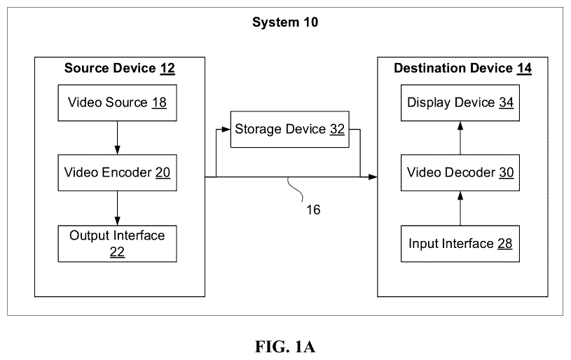

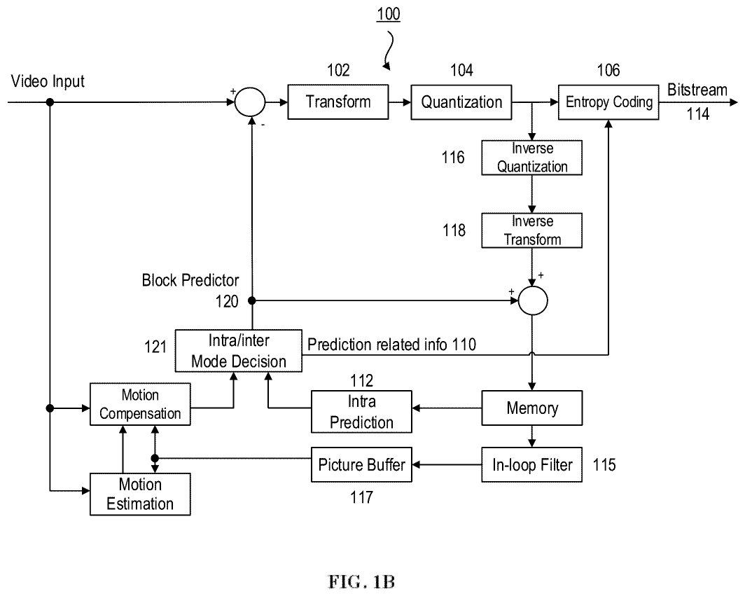

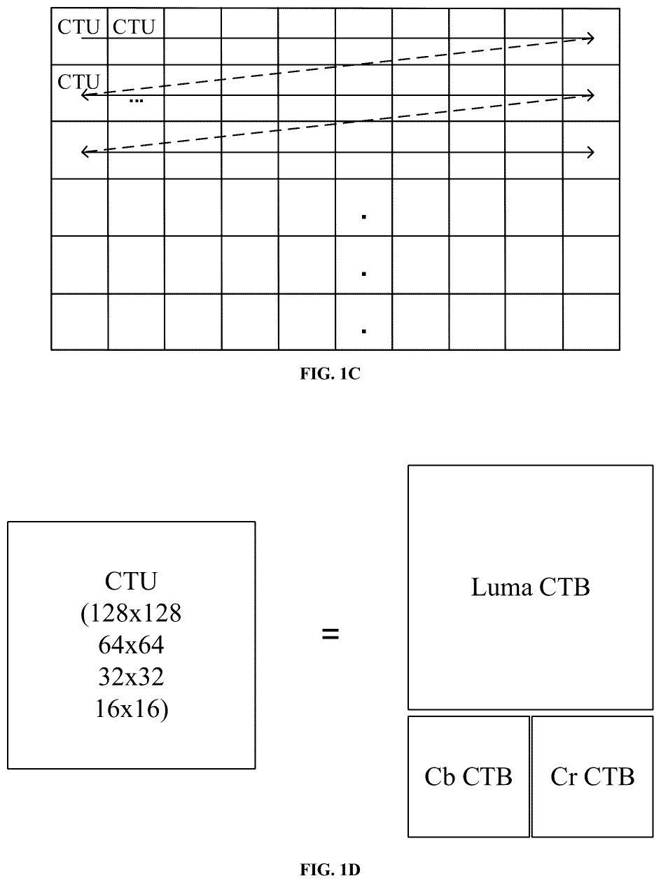

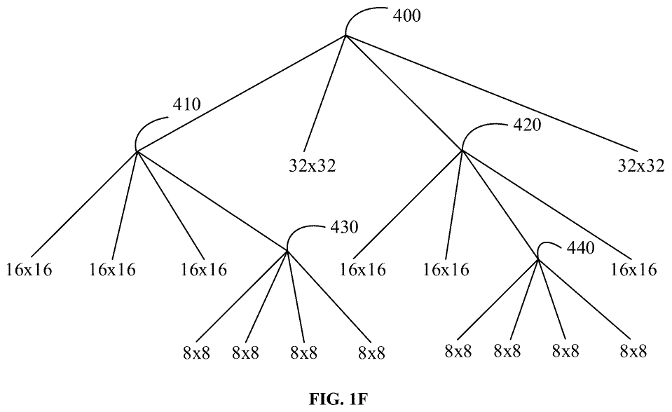

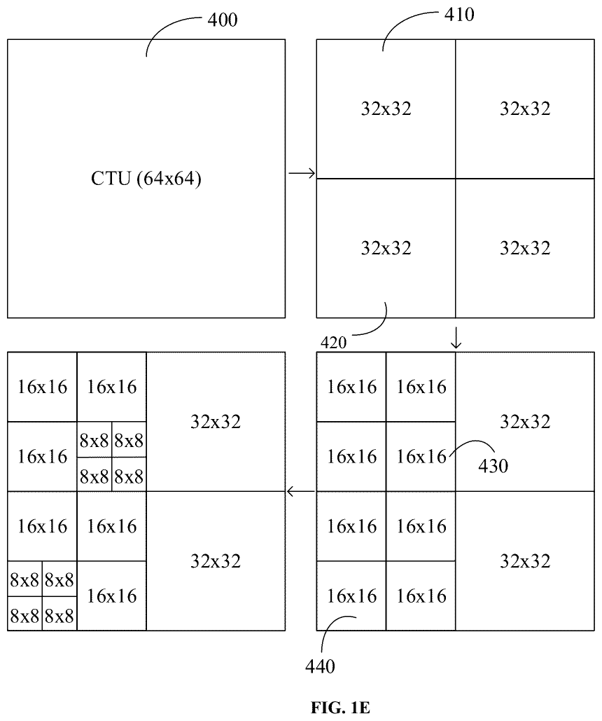

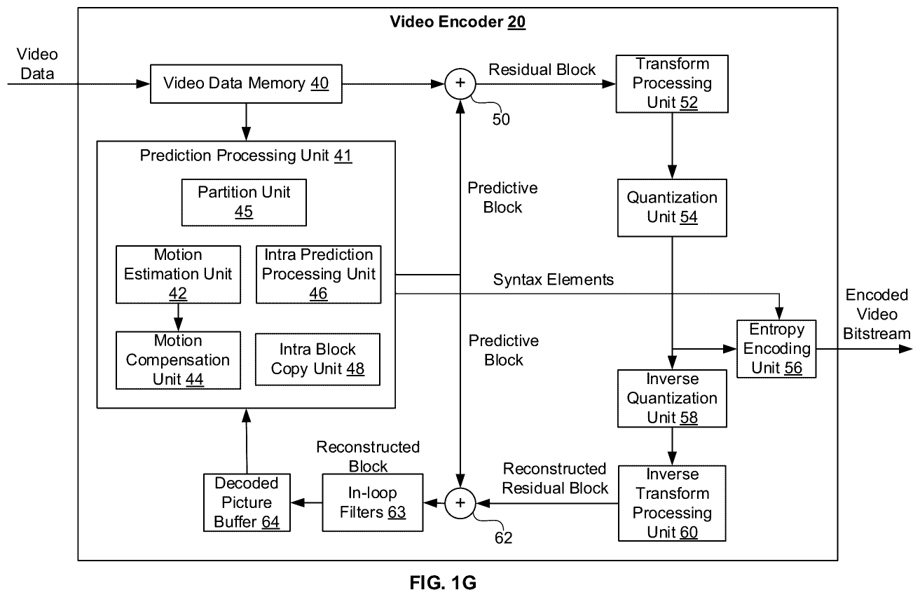

FIG. 1A is a block diagram illustrating an exemplary system 10 for encoding and decoding video blocks in parallel in accordance with some implementations of the present disclosure. As shown in FIG. 1A, the system 10 includes a source device 12 that generates and encodes video data to be decoded at a later time by a destination device 14. The source device 12 and the destination device 14 may include any of a wide variety of electronic devices, including desktop or laptop computers, tablet computers, smart phones, set-top boxes, digital televisions, cameras, display devices, digital media players, video gaming consoles, video streaming device, or the like. In some implementations, the source device 12 and the destination device 14 are equipped with wireless communication capabilities.

In some implementations, the destination device 14 may receive the encoded video data to be decoded via a link 16. The link 16 may include any type of communication medium or device capable of moving the encoded video data from the source device 12 to the destination device 14. In one example, the link 16 may include a communication medium to enable the source device 12 to transmit the encoded video data directly to the destination device 14 in real time. The encoded video data may be modulated according to a communication standard, such as a wireless communication protocol, and transmitted to the destination device 14. The communication medium may include any wireless or wired communication medium, such as a Radio Frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from the source device 12 to the destination device 14.

In some other implementations, the encoded video data may be transmitted from an output interface 22 to a storage device 32. Subsequently, the encoded video data in the storage device 32 may be accessed by the destination device 14 via an input interface 28. The storage device 32 may include any of a variety of distributed or locally accessed data storage media such as a hard drive, Blu-ray discs, Digital Versatile Disks (DVDs), Compact Disc Read-Only Memories (CD-ROMs), flash memory, volatile or non-volatile memory, or any other suitable digital storage media for storing the encoded video data. In a further example, the storage device 32 may correspond to a file server or another intermediate storage device that may hold the encoded video data generated by the source device 12. The destination device 14 may access the stored video data from the storage device 32 via streaming or downloading. The file server may be any type of computer capable of storing the encoded video data and transmitting the encoded video data to the destination device 14. Exemplary file servers include a web server (e.g., for a website), a File Transfer Protocol (FTP) server, Network Attached Storage (NAS) devices, or a local disk drive. The destination device 14 may access the encoded video data through any standard data connection, including a wireless channel (e.g., a Wireless Fidelity (Wi-Fi) connection), a wired connection (e.g., Digital Subscriber Line (DSL), cable modem, etc.), or a combination of both that is suitable for accessing encoded video data stored on a file server. The transmission of the encoded video data from the storage device 32 may be a streaming transmission, a download transmission, or a combination of both.

As shown in FIG. 1A, the source device 12 includes a video source 18, a video encoder 20 and the output interface 22. The video source 18 may include a source such as a video capturing device, e.g., a video camera, a video archive containing previously captured video, a video feeding interface to receive video from a video content provider, and/or a computer graphics system for generating computer graphics data as the source video, or a combination of such sources. As one example, if the video source 18 is a video camera of a security surveillance system, the source device 12 and the destination device 14 may form camera phones or video phones. However, the implementations described in the present application may be applicable to video coding in general, and may be applied to wireless and/or wired applications.

The captured, pre-captured, or computer-generated video may be encoded by the video encoder 20. The encoded video data may be transmitted directly to the destination device 14 via the output interface 22 of the source device 12. The encoded video data may also (or alternatively) be stored onto the storage device 32 for later access by the destination device 14 or other devices, for decoding and/or playback. The output interface 22 may further include a modem and/or a transmitter.

The destination device 14 includes the input interface 28, a video decoder 30, and a display device 34. The input interface 28 may include a receiver and/or a modem and receive the encoded video data over the link 16. The encoded video data communicated over the link 16, or provided on the storage device 32, may include a variety of syntax elements generated by the video encoder 20 for use by the video decoder 30 in decoding the video data. Such syntax elements may be included within the encoded video data transmitted on a communication medium, stored on a storage medium, or stored on a file server.

In some implementations, the destination device 14 may include the display device 34, which can be an integrated display device and an external display device that is configured to communicate with the destination device 14. The display device 34 displays the decoded video data to a user, and may include any of a variety of display devices such as a Liquid Crystal Display (LCD), a plasma display, an Organic Light Emitting Diode (OLED) display, or another type of display device.

The video encoder 20 and the video decoder 30 may operate according to proprietary or industry standards, such as VVC, HEVC, MPEG-4, Part 10, AVC, or extensions of such standards. It should be understood that the present application is not limited to a specific video encoding/decoding standard and may be applicable to other video encoding/decoding standards. It is generally contemplated that the video encoder 20 of the source device 12 may be configured to encode video data according to any of these current or future standards. Similarly, it is also generally contemplated that the video decoder 30 of the destination device 14 may be configured to decode video data according to any of these current or future standards.

The video encoder 20 and the video decoder 30 each may be implemented as any of a variety of suitable encoder and/or decoder circuitry, such as one or more microprocessors, Digital Signal Processors (DSPs), Application Specific Integrated Circuits (ASICs), Field Programmable Gate Arrays (FPGAs), discrete logic, software, hardware, firmware or any combinations thereof. When implemented partially in software, an electronic device may store instructions for the software in a suitable, non-transitory computer-readable medium and execute the instructions in hardware using one or more processors to perform the video encoding/decoding operations disclosed in the present disclosure. Each of the video encoder 20 and the video decoder 30 may be included in one or more encoders or decoders, either of which may be integrated as part of a combined encoder/decoder (CODEC) in a respective device.

Like HEVC, VVC is built upon the block-based hybrid video coding framework. FIG. 1B is a block diagram illustrating a block-based video encoder in accordance with some implementations of the present disclosure. In the encoder 100, the input video signal is processed block by block, called coding units (CUs). The encoder 100 may be the video encoder 20 as shown in FIG. 1A. In VTM-1.0, a CU can be up to 128×128 pixels. However, different from the HEVC which partitions blocks only based on quad-trees, in VVC, one coding tree unit (CTU) is split into CUs to adapt to varying local characteristics based on quad/binary/ternary-tree. Additionally, the concept of multiple partition unit type in the HEVC is removed, i.e., the separation of CU, prediction unit (PU) and transform unit (TU) does not exist in the VVC anymore; instead, each CU is always used as the basic unit for both prediction and transform without further partitions. In the multi-type tree structure, one CTU is firstly partitioned by a quad-tree structure. Then, each quad-tree leaf node can be further partitioned by a binary and ternary tree structure.

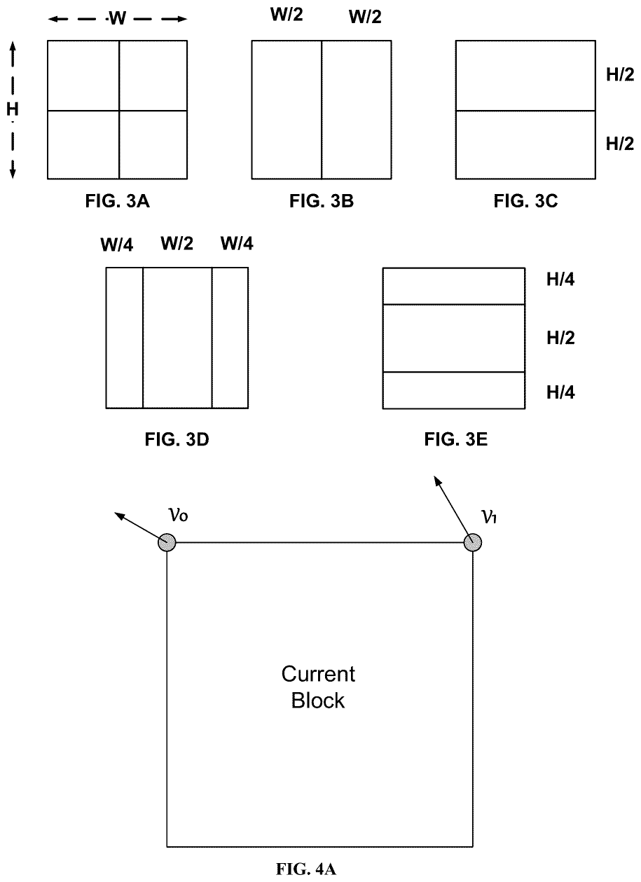

FIGS. 3A-3E are schematic diagrams illustrating multi-type tree splitting modes in accordance with some implementations of the present disclosure. FIGS. 3A-3E respectively show five splitting types including quaternary partitioning (FIG. 3A), vertical binary partitioning (FIG. 3B), horizontal binary partitioning (FIG. 3C), vertical ternary partitioning (FIG. 3D), and horizontal ternary partitioning (FIG. 3E).

For each given video block, spatial prediction and/or temporal prediction may be performed. Spatial prediction (or “intra prediction”) uses pixels from the samples of already coded neighboring blocks (which are called reference samples) in the same video picture/slice to predict the current video block. Spatial prediction reduces spatial redundancy inherent in the video signal. Temporal prediction (also referred to as “inter prediction” or “motion compensated prediction”) uses reconstructed pixels from the already coded video pictures to predict the current video block. Temporal prediction reduces temporal redundancy inherent in the video signal. Temporal prediction signal for a given CU is usually signaled by one or more motion vectors (MVs) which indicate the amount and the direction of motion between the current CU and its temporal reference. Also, if multiple reference pictures are supported, one reference picture index is additionally sent, which is used to identify from which reference picture in the reference picture store the temporal prediction signal comes.

After spatial and/or temporal prediction, an intra/inter mode decision circuitry 121 in the encoder 100 chooses the best prediction mode, for example based on the rate-distortion optimization method. The block predictor 120 is then subtracted from the current video block; and the resulting prediction residual is de-correlated using the transform circuitry 102 and the quantization circuitry 104. The resulting quantized residual coefficients are inverse quantized by the inverse quantization circuitry 116 and inverse transformed by the inverse transform circuitry 118 to form the reconstructed residual, which is then added back to the prediction block to form the reconstructed signal of the CU. Further, in-loop filtering 115, such as a deblocking filter, a sample adaptive offset (SAO), and/or an adaptive in-loop filter (ALF) may be applied on the reconstructed CU before it is put in the reference picture store of the picture buffer 117 and used to code future video blocks. To form the output video bitstream 114, coding mode (inter or intra), prediction mode information, motion information, and quantized residual coefficients are all sent to the entropy coding unit 106 to be further compressed and packed to form the bit-stream.

For example, a deblocking filter is available in AVC, HEVC as well as the now-current version of VVC. In HEVC, an additional in-loop filter called SAO is defined to further improve coding efficiency. In the now-current version of the VVC standard, yet another in-loop filter called ALF is being actively investigated, and it has a good chance of being included in the final standard.

These in-loop filter operations are optional. Performing these operations helps to improve coding efficiency and visual quality. They may also be turned off as a decision rendered by the encoder 100 to save computational complexity.

It should be noted that intra prediction is usually based on unfiltered reconstructed pixels, while inter prediction is based on filtered reconstructed pixels if these filter options are turned on by the encoder 100.

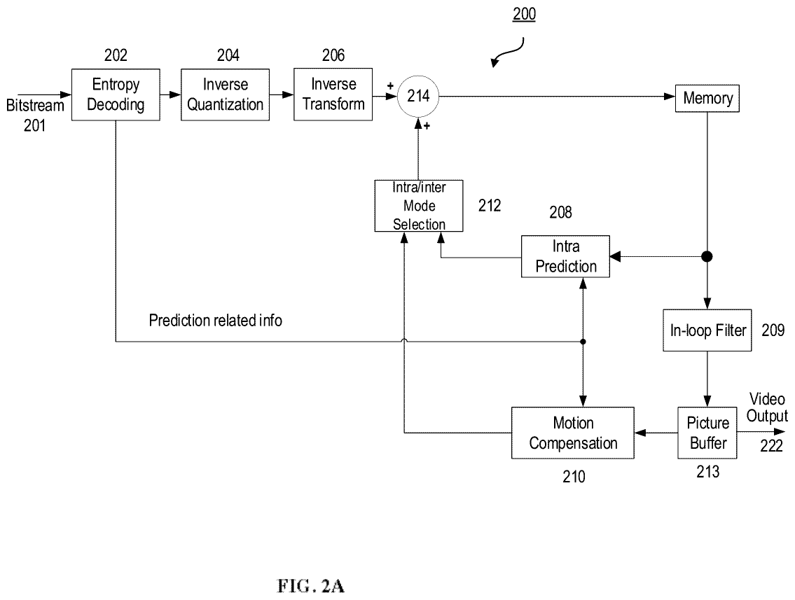

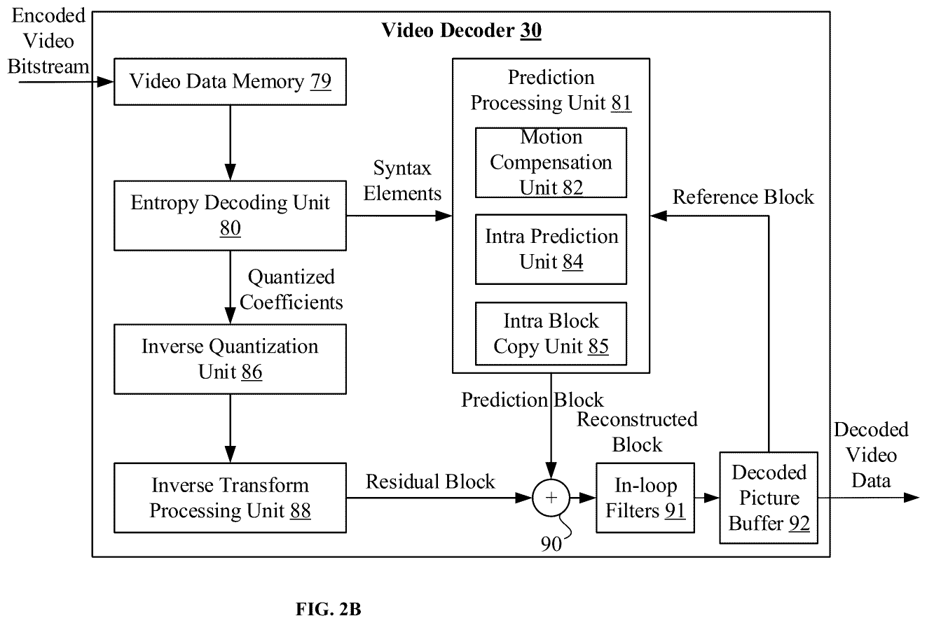

FIG. 2A is a block diagram illustrating a block-based video decoder 200 which may be used in conjunction with many video coding standards. This decoder 200 is similar to the reconstruction-related section residing in the encoder 100 of FIG. 1B. The block-based video decoder 200 may be the video decoder 30 as shown in FIG. 1A. In the decoder 200, an incoming video bitstream 201 is first decoded through an Entropy Decoding 202 to derive quantized coefficient levels and prediction-related information. The quantized coefficient levels are then processed through an Inverse Quantization 204 and an Inverse Transform 206 to obtain a reconstructed prediction residual. A block predictor mechanism, implemented in an Intra/inter Mode Selector 212, is configured to perform either an Intra Prediction 208, or a Motion Compensation 210, based on decoded prediction information. A set of unfiltered reconstructed pixels are obtained by summing up the reconstructed prediction residual from the Inverse Transform 206 and a predictive output generated by the block predictor mechanism, using a summer 214.

The reconstructed block may further go through an In-Loop Filter 209 before it is stored in a Picture Buffer 213 which functions as a reference picture store. The reconstructed video in the Picture Buffer 213 may be sent to drive a display device, as well as used to predict future video blocks. In situations where the In-Loop Filter 209 is turned on, a filtering operation is performed on these reconstructed pixels to derive a final reconstructed Video Output 222.

FIG. 1G is a block diagram illustrating another exemplary video encoder 20 in accordance with some implementations described in the present application. The video encoder 20 may perform intra and inter predictive coding of video blocks within video frames. Intra predictive coding relies on spatial prediction to reduce or remove spatial redundancy in video data within a given video frame or picture. Inter predictive coding relies on temporal prediction to reduce or remove temporal redundancy in video data within adjacent video frames or pictures of a video sequence. It should be noted that the term “frame” may be used as synonyms for the term “image” or “picture” in the field of video coding.

As shown in FIG. 1G, the video encoder 20 includes a video data memory 40, a prediction processing unit 41, a Decoded Picture Buffer (DPB) 64, a summer 50, a transform processing unit 52, a quantization unit 54, and an entropy encoding unit 56. The prediction processing unit 41 further includes a motion estimation unit 42, a motion compensation unit 44, a partition unit 45, an intra prediction processing unit 46, and an intra Block Copy (BC) unit 48. In some implementations, the video encoder 20 also includes an inverse quantization unit 58, an inverse transform processing unit 60, and a summer 62 for video block reconstruction. An in-loop filter 63, such as a deblocking filter, may be positioned between the summer 62 and the DPB 64 to filter block boundaries to remove blockiness artifacts from reconstructed video. Another in-loop filter, such as Sample Adaptive Offset (SAO) filter and/or Adaptive in-Loop Filter (ALF), may also be used in addition to the deblocking filter to filter an output of the summer 62. In some examples, the in-loop filters may be omitted, and the decoded video block may be directly provided by the summer 62 to the DPB 64. The video encoder 20 may take the form of a fixed or programmable hardware unit or may be divided among one or more of the illustrated fixed or programmable hardware units.

The video data memory 40 may store video data to be encoded by the components of the video encoder 20. The video data in the video data memory 40 may be obtained, for example, from the video source 18 as shown in FIG. 1A. The DPB 64 is a buffer that stores reference video data (for example, reference frames or pictures) for use in encoding video data by the video encoder 20 (e.g., in intra or inter predictive coding modes). The video data memory 40 and the DPB 64 may be formed by any of a variety of memory devices. In various examples, the video data memory 40 may be on-chip with other components of the video encoder 20, or off-chip relative to those components.

As shown in FIG. 1G, after receiving the video data, the partition unit 45 within the prediction processing unit 41 partitions the video data into video blocks. This partitioning may also include partitioning a video frame into slices, tiles (for example, sets of video blocks), or other larger Coding Units (CUs) according to predefined splitting structures such as a Quad-Tree (QT) structure associated with the video data. The video frame is or may be regarded as a two-dimensional array or matrix of samples with sample values. A sample in the array may also be referred to as a pixel or a pel. A number of samples in horizontal and vertical directions (or axes) of the array or picture define a size and/or a resolution of the video frame. The video frame may be divided into multiple video blocks by, for example, using QT partitioning. The video block again is or may be regarded as a two-dimensional array or matrix of samples with sample values, although of smaller dimension than the video frame. A number of samples in horizontal and vertical directions (or axes) of the video block define a size of the video block. The video block may further be partitioned into one or more block partitions or sub-blocks (which may form again blocks) by, for example, iteratively using QT partitioning, Binary-Tree (BT) partitioning or Triple-Tree (TT) partitioning or any combination thereof. It should be noted that the term “block” or “video block” as used herein may be a portion, in particular a rectangular (square or non-square) portion, of a frame or a picture. With reference, for example, to HEVC and VVC, the block or video block may be or correspond to a Coding Tree Unit (CTU), a CU, a Prediction Unit (PU) or a Transform Unit (TU) and/or may be or correspond to a corresponding block, e.g., a Coding Tree Block (CTB), a Coding Block (CB), a Prediction Block (PB) or a Transform Block (TB) and/or to a sub-block.

The prediction processing unit 41 may select one of a plurality of possible predictive coding modes, such as one of a plurality of intra predictive coding modes or one of a plurality of inter predictive coding modes, for the current video block based on error results (e.g., coding rate and the level of distortion). The prediction processing unit 41 may provide the resulting intra or inter prediction coded block to the summer 50 to generate a residual block and to the summer 62 to reconstruct the encoded block for use as part of a reference frame subsequently. The prediction processing unit 41 also provides syntax elements, such as motion vectors, intra-mode indicators, partition information, and other such syntax information, to the entropy encoding unit 56.

In order to select an appropriate intra predictive coding mode for the current video block, the intra prediction processing unit 46 within the prediction processing unit 41 may perform intra predictive coding of the current video block relative to one or more neighbor blocks in the same frame as the current block to be coded to provide spatial prediction. The motion estimation unit 42 and the motion compensation unit 44 within the prediction processing unit 41 perform inter predictive coding of the current video block relative to one or more predictive blocks in one or more reference frames to provide temporal prediction. The video encoder 20 may perform multiple coding passes, e.g., to select an appropriate coding mode for each block of video data.

In some implementations, the motion estimation unit 42 determines the inter prediction mode for a current video frame by generating a motion vector, which indicates the displacement of a video block within the current video frame relative to a predictive block within a reference video frame, according to a predetermined pattern within a sequence of video frames. Motion estimation, performed by the motion estimation unit 42, is the process of generating motion vectors, which estimate motion for video blocks. A motion vector, for example, may indicate the displacement of a video block within a current video frame or picture relative to a predictive block within a reference frame relative to the current block being coded within the current frame. The predetermined pattern may designate video frames in the sequence as P frames or B frames. The intra BC unit 48 may determine vectors, e.g., block vectors, for intra BC coding in a manner similar to the determination of motion vectors by the motion estimation unit 42 for inter prediction, or may utilize the motion estimation unit 42 to determine the block vector.

A predictive block for the video block may be or may correspond to a block or a reference block of a reference frame that is deemed as closely matching the video block to be coded in terms of pixel difference, which may be determined by Sum of Absolute Difference (SAD), Sum of Square Difference (SSD), or other difference metrics. In some implementations, the video encoder 20 may calculate values for sub-integer pixel positions of reference frames stored in the DPB 64. For example, the video encoder 20 may interpolate values of one-quarter pixel positions, one-eighth pixel positions, or other fractional pixel positions of the reference frame. Therefore, the motion estimation unit 42 may perform a motion search relative to the full pixel positions and fractional pixel positions and output a motion vector with fractional pixel precision.

The motion estimation unit 42 calculates a motion vector for a video block in an inter prediction coded frame by comparing the position of the video block to the position of a predictive block of a reference frame selected from a first reference frame list (List 0) or a second reference frame list (List 1), each of which identifies one or more reference frames stored in the DPB 64. The motion estimation unit 42 sends the calculated motion vector to the motion compensation unit 44 and then to the entropy encoding unit 56.

Motion compensation, performed by the motion compensation unit 44, may involve fetching or generating the predictive block based on the motion vector determined by the motion estimation unit 42. Upon receiving the motion vector for the current video block, the motion compensation unit 44 may locate a predictive block to which the motion vector points in one of the reference frame lists, retrieve the predictive block from the DPB 64, and forward the predictive block to the summer 50. The summer 50 then forms a residual video block of pixel difference values by subtracting pixel values of the predictive block provided by the motion compensation unit 44 from the pixel values of the current video block being coded. The pixel difference values forming the residual video block may include luma or chroma component differences or both. The motion compensation unit 44 may also generate syntax elements associated with the video blocks of a video frame for use by the video decoder 30 in decoding the video blocks of the video frame. The syntax elements may include, for example, syntax elements defining the motion vector used to identify the predictive block, any flags indicating the prediction mode, or any other syntax information described herein. Note that the motion estimation unit 42 and the motion compensation unit 44 may be highly integrated, but are illustrated separately for conceptual purposes.

In some implementations, the intra BC unit 48 may generate vectors and fetch predictive blocks in a manner similar to that described above in connection with the motion estimation unit 42 and the motion compensation unit 44, but with the predictive blocks being in the same frame as the current block being coded and with the vectors being referred to as block vectors as opposed to motion vectors. In particular, the intra BC unit 48 may determine an intra-prediction mode to use to encode a current block. In some examples, the intra BC unit 48 may encode a current block using various intra-prediction modes, e.g., during separate encoding passes, and test their performance through rate-distortion analysis. Next, the intra BC unit 48 may select, among the various tested intra-prediction modes, an appropriate intra-prediction mode to use and generate an intra-mode indicator accordingly. For example, the intra BC unit 48 may calculate rate-distortion values using a rate-distortion analysis for the various tested intra-prediction modes, and select the intra-prediction mode having the best rate-distortion characteristics among the tested modes as the appropriate intra-prediction mode to use. Rate-distortion analysis generally determines an amount of distortion (or error) between an encoded block and an original, unencoded block that was encoded to produce the encoded block, as well as a bitrate (i.e., a number of bits) used to produce the encoded block. Intra BC unit 48 may calculate ratios from the distortions and rates for the various encoded blocks to determine which intra-prediction mode exhibits the best rate-distortion value for the block.

In other examples, the intra BC unit 48 may use the motion estimation unit 42 and the motion compensation unit 44, in whole or in part, to perform such functions for Intra BC prediction according to the implementations described herein. In either case, for Intra block copy, a predictive block may be a block that is deemed as closely matching the block to be coded, in terms of pixel difference, which may be determined by SAD, SSD, or other difference metrics, and identification of the predictive block may include calculation of values for sub-integer pixel positions.

Whether the predictive block is from the same frame according to intra prediction, or a different frame according to inter prediction, the video encoder 20 may form a residual video block by subtracting pixel values of the predictive block from the pixel values of the current video block being coded, forming pixel difference values. The pixel difference values forming the residual video block may include both luma and chroma component differences.

The intra prediction processing unit 46 may intra-predict a current video block, as an alternative to the inter-prediction performed by the motion estimation unit 42 and the motion compensation unit 44, or the intra block copy prediction performed by the intra BC unit 48, as described above. In particular, the intra prediction processing unit 46 may determine an intra prediction mode to use to encode a current block. To do so, the intra prediction processing unit 46 may encode a current block using various intra prediction modes, e.g., during separate encoding passes, and the intra prediction processing unit 46 (or a mode selection unit, in some examples) may select an appropriate intra prediction mode to use from the tested intra prediction modes. The intra prediction processing unit 46 may provide information indicative of the selected intra-prediction mode for the block to the entropy encoding unit 56. The entropy encoding unit 56 may encode the information indicating the selected intra-prediction mode in the bitstream.

After the prediction processing unit 41 determines the predictive block for the current video block via either inter prediction or intra prediction, the summer 50 forms a residual video block by subtracting the predictive block from the current video block. The residual video data in the residual block may be included in one or more TUs and is provided to the transform processing unit 52. The transform processing unit 52 transforms the residual video data into residual transform coefficients using a transform, such as a Discrete Cosine Transform (DCT) or a conceptually similar transform.

The transform processing unit 52 may send the resulting transform coefficients to the quantization unit 54. The quantization unit 54 quantizes the transform coefficients to further reduce the bit rate. The quantization process may also reduce the bit depth associated with some or all of the coefficients. The degree of quantization may be modified by adjusting a quantization parameter. In some examples, the quantization unit 54 may then perform a scan of a matrix including the quantized transform coefficients. Alternatively, the entropy encoding unit 56 may perform the scan.

Following quantization, the entropy encoding unit 56 entropy encodes the quantized transform coefficients into a video bitstream using, e.g., Context Adaptive Variable Length Coding (CAVLC), Context Adaptive Binary Arithmetic Coding (CABAC), Syntax-based context-adaptive Binary Arithmetic Coding (SBAC), Probability Interval Partitioning Entropy (PIPE) coding or another entropy encoding methodology or technique. The encoded bitstream may then be transmitted to the video decoder 30 as shown in FIG. 1A, or archived in the storage device 32 as shown in FIG. 1A for later transmission to or retrieval by the video decoder 30. The entropy encoding unit 56 may also entropy encode the motion vectors and the other syntax elements for the current video frame being coded.

The inverse quantization unit 58 and the inverse transform processing unit 60 apply inverse quantization and inverse transformation, respectively, to reconstruct the residual video block in the pixel domain for generating a reference block for prediction of other video blocks. As noted above, the motion compensation unit 44 may generate a motion compensated predictive block from one or more reference blocks of the frames stored in the DPB 64. The motion compensation unit 44 may also apply one or more interpolation filters to the predictive block to calculate sub-integer pixel values for use in motion estimation.

The summer 62 adds the reconstructed residual block to the motion compensated predictive block produced by the motion compensation unit 44 to produce a reference block for storage in the DPB 64. The reference block may then be used by the intra BC unit 48, the motion estimation unit 42 and the motion compensation unit 44 as a predictive block to inter predict another video block in a subsequent video frame.

FIG. 2B is a block diagram illustrating another exemplary video decoder 30 in accordance with some implementations of the present application. The video decoder 30 includes a video data memory 79, an entropy decoding unit 80, a prediction processing unit 81, an inverse quantization unit 86, an inverse transform processing unit 88, a summer 90, and a DPB 92. The prediction processing unit 81 further includes a motion compensation unit 82, an intra prediction unit 84, and an intra BC unit 85. The video decoder 30 may perform a decoding process generally reciprocal to the encoding process described above with respect to the video encoder 20 in connection with FIG. 1G. For example, the motion compensation unit 82 may generate prediction data based on motion vectors received from the entropy decoding unit 80, while the intra-prediction unit 84 may generate prediction data based on intra-prediction mode indicators received from the entropy decoding unit 80.

In some examples, a unit of the video decoder 30 may be tasked to perform the implementations of the present application. Also, in some examples, the implementations of the present disclosure may be divided among one or more of the units of the video decoder 30. For example, the intra BC unit 85 may perform the implementations of the present application, alone, or in combination with other units of the video decoder 30, such as the motion compensation unit 82, the intra prediction unit 84, and the entropy decoding unit 80. In some examples, the video decoder 30 may not include the intra BC unit 85 and the functionality of intra BC unit 85 may be performed by other components of the prediction processing unit 81, such as the motion compensation unit 82.

The video data memory 79 may store video data, such as an encoded video bitstream, to be decoded by the other components of the video decoder 30. The video data stored in the video data memory 79 may be obtained, for example, from the storage device 32, from a local video source, such as a camera, via wired or wireless network communication of video data, or by accessing physical data storage media (e.g., a flash drive or hard disk). The video data memory 79 may include a Coded Picture Buffer (CPB) that stores encoded video data from an encoded video bitstream. The DPB 92 of the video decoder 30 stores reference video data for use in decoding video data by the video decoder 30 (e.g., in intra or inter predictive coding modes). The video data memory 79 and the DPB 92 may be formed by any of a variety of memory devices, such as dynamic random access memory (DRAM), including Synchronous DRAM (SDRAM), Magneto-resistive RAM (MRAM), Resistive RAM (RRAM), or other types of memory devices. For illustrative purpose, the video data memory 79 and the DPB 92 are depicted as two distinct components of the video decoder 30 in FIG. 2B. But it will be apparent to one skilled in the art that the video data memory 79 and the DPB 92 may be provided by the same memory device or separate memory devices. In some examples, the video data memory 79 may be on-chip with other components of the video decoder 30, or off-chip relative to those components.

During the decoding process, the video decoder 30 receives an encoded video bitstream that represents video blocks of an encoded video frame and associated syntax elements. The video decoder 30 may receive the syntax elements at the video frame level and/or the video block level. The entropy decoding unit 80 of the video decoder 30 entropy decodes the bitstream to generate quantized coefficients, motion vectors or intra-prediction mode indicators, and other syntax elements. The entropy decoding unit 80 then forwards the motion vectors or intra-prediction mode indicators and other syntax elements to the prediction processing unit 81.

When the video frame is coded as an intra predictive coded (I) frame or for intra coded predictive blocks in other types of frames, the intra prediction unit 84 of the prediction processing unit 81 may generate prediction data for a video block of the current video frame based on a signaled intra prediction mode and reference data from previously decoded blocks of the current frame.

When the video frame is coded as an inter-predictive coded (i.e., B or P) frame, the motion compensation unit 82 of the prediction processing unit 81 produces one or more predictive blocks for a video block of the current video frame based on the motion vectors and other syntax elements received from the entropy decoding unit 80. Each of the predictive blocks may be produced from a reference frame within one of the reference frame lists. The video decoder 30 may construct the reference frame lists, List 0 and List 1, using default construction techniques based on reference frames stored in the DPB 92.

In some examples, when the video block is coded according to the intra BC mode described herein, the intra BC unit 85 of the prediction processing unit 81 produces predictive blocks for the current video block based on block vectors and other syntax elements received from the entropy decoding unit 80. The predictive blocks may be within a reconstructed region of the same picture as the current video block defined by the video encoder 20.

The motion compensation unit 82 and/or the intra BC unit 85 determines prediction information for a video block of the current video frame by parsing the motion vectors and other syntax elements, and then uses the prediction information to produce the predictive blocks for the current video block being decoded. For example, the motion compensation unit 82 uses some of the received syntax elements to determine a prediction mode (e.g., intra or inter prediction) used to code video blocks of the video frame, an inter prediction frame type (e.g., B or P), construction information for one or more of the reference frame lists for the frame, motion vectors for each inter predictive encoded video block of the frame, inter prediction status for each inter predictive coded video block of the frame, and other information to decode the video blocks in the current video frame.

Similarly, the intra BC unit 85 may use some of the received syntax elements, e.g., a flag, to determine that the current video block was predicted using the intra BC mode, construction information of which video blocks of the frame are within the reconstructed region and should be stored in the DPB 92, block vectors for each intra BC predicted video block of the frame, intra BC prediction status for each intra BC predicted video block of the frame, and other information to decode the video blocks in the current video frame.

The motion compensation unit 82 may also perform interpolation using the interpolation filters as used by the video encoder 20 during encoding of the video blocks to calculate interpolated values for sub-integer pixels of reference blocks. In this case, the motion compensation unit 82 may determine the interpolation filters used by the video encoder 20 from the received syntax elements and use the interpolation filters to produce predictive blocks.

The inverse quantization unit 86 inverse quantizes the quantized transform coefficients provided in the bitstream and entropy decoded by the entropy decoding unit 80 using the same quantization parameter calculated by the video encoder 20 for each video block in the video frame to determine a degree of quantization. The inverse transform processing unit 88 applies an inverse transform, e.g., an inverse DCT, an inverse integer transform, or a conceptually similar inverse transform process, to the transform coefficients in order to reconstruct the residual blocks in the pixel domain.

After the motion compensation unit 82 or the intra BC unit 85 generates the predictive block for the current video block based on the vectors and other syntax elements, the summer 90 reconstructs decoded video block for the current video block by summing the residual block from the inverse transform processing unit 88 and a corresponding predictive block generated by the motion compensation unit 82 and the intra BC unit 85. An in-loop filter 91 such as deblocking filter, SAO filter and/or ALF may be positioned between the summer 90 and the DPB 92 to further process the decoded video block. In some examples, the in-loop filter 91 may be omitted, and the decoded video block may be directly provided by the summer 90 to the DPB 92. The decoded video blocks in a given frame are then stored in the DPB 92, which stores reference frames used for subsequent motion compensation of next video blocks. The DPB 92, or a memory device separate from the DPB 92, may also store decoded video for later presentation on a display device, such as the display device 34 of FIG. 1A.

In the current VVC and AVS3 standards, motion information of the current coding block is either copied from spatial or temporal neighboring blocks specified by a merge candidate index or obtained by explicit signaling of motion estimation. The focus of the present disclosure is to improve the accuracy of the motion vectors for affine merge mode by improving the derivation methods of affine merge candidates. To facilitate the description of the present disclosure, the existing affine merge mode design in the VVC standard is used as an example to illustrate the proposed ideas. Please note that though the existing affine mode design in the VVC standard is used as the example throughout the present disclosure, to a person skilled in the art of modem video coding technologies, the proposed technologies can also be applied to a different design of affine motion prediction mode or other coding tools with the same or similar design spirit.

In a typical video coding process, a video sequence typically includes an ordered set of frames or pictures. Each frame may include three sample arrays, denoted SL, SCb, and SCr. SL is a two-dimensional array of luma samples. SCb is a two-dimensional array of Cb chroma samples. SCr is a two-dimensional array of Cr chroma samples. In other instances, a frame may be monochrome and therefore includes only one two-dimensional array of luma samples.

As shown in FIG. 1C, the video encoder 20 (or more specifically a partition unit in a prediction processing unit of the video encoder 20) generates an encoded representation of a frame by first partitioning the frame into a set of CTUs. A video frame may include an integer number of CTUs ordered consecutively in a raster scan order from left to right and from top to bottom. Each CTU is a largest logical coding unit and the width and height of the CTU are signaled by the video encoder 20 in a sequence parameter set, such that all the CTUs in a video sequence have the same size being one of 128×128, 64×64, 32×32, and 16×16. But it should be noted that the present application is not necessarily limited to a particular size. As shown in FIG. 1D, each CTU may include one CTB of luma samples, two corresponding coding tree blocks of chroma samples, and syntax elements used to code the samples of the coding tree blocks. The syntax elements describe properties of different types of units of a coded block of pixels and how the video sequence can be reconstructed at the video decoder 30, including inter or intra prediction, intra prediction mode, motion vectors, and other parameters. In monochrome pictures or pictures having three separate color planes, a CTU may include a single coding tree block and syntax elements used to code the samples of the coding tree block. A coding tree block may be an N×N block of samples.

To achieve a better performance, the video encoder 20 may recursively perform tree partitioning such as binary-tree partitioning, ternary-tree partitioning, quad-tree partitioning or a combination thereof on the coding tree blocks of the CTU and divide the CTU into smaller CUs. As depicted in FIG. 1E, the 64×64 CTU 400 is first divided into four smaller CUs, each having a block size of 32×32. Among the four smaller CUs, CU 410 and CU 420 are each divided into four CUs of 16×16 by block size. The two 16×16 CUs 430 and 440 are each further divided into four CUs of 8×8 by block size. FIG. 1F depicts a quad-tree data structure illustrating the end result of the partition process of the CTU 400 as depicted in FIG. 1E, each leaf node of the quad-tree corresponding to one CU of a respective size ranging from 32×32 to 8×8. Like the CTU depicted in FIG. 1D, each CU may include a CB of luma samples and two corresponding coding blocks of chroma samples of a frame of the same size, and syntax elements used to code the samples of the coding blocks. In monochrome pictures or pictures having three separate color planes, a CU may include a single coding block and syntax structures used to code the samples of the coding block. It should be noted that the quad-tree partitioning depicted in FIGS. 1E-1F is only for illustrative purposes and one CTU can be split into CUs to adapt to varying local characteristics based on quad/ternary/binary-tree partitions. In the multi-type tree structure, one CTU is partitioned by a quad-tree structure and each quad-tree leaf CU can be further partitioned by a binary and ternary tree structure. As shown in FIGS. 3A-3E, there are five possible partitioning types of a coding block having a width W and a height H, i.e., quaternary partitioning, horizontal binary partitioning, vertical binary partitioning, horizontal ternary partitioning, and vertical ternary partitioning.

In some implementations, the video encoder 20 may further partition a coding block of a CU into one or more MxN PBs. A PB is a rectangular (square or non-square) block of samples on which the same prediction, inter or intra, is applied. A PU of a CU may include a PB of luma samples, two corresponding PBs of chroma samples, and syntax elements used to predict the PBs. In monochrome pictures or pictures having three separate color planes, a PU may include a single PB and syntax structures used to predict the PB. The video encoder 20 may generate predictive luma, Cb, and Cr blocks for luma, Cb, and Cr PBs of each PU of the CU.

The video encoder 20 may use intra prediction or inter prediction to generate the predictive blocks for a PU. If the video encoder 20 uses intra prediction to generate the predictive blocks of a PU, the video encoder 20 may generate the predictive blocks of the PU based on decoded samples of the frame associated with the PU. If the video encoder 20 uses inter prediction to generate the predictive blocks of a PU, the video encoder 20 may generate the predictive blocks of the PU based on decoded samples of one or more frames other than the frame associated with the PU.

After the video encoder 20 generates predictive luma, Cb, and Cr blocks for one or more PUs of a CU, the video encoder 20 may generate a luma residual block for the CU by subtracting the CU's predictive luma blocks from its original luma coding block such that each sample in the CU's luma residual block indicates a difference between a luma sample in one of the CU's predictive luma blocks and a corresponding sample in the CU's original luma coding block. Similarly, the video encoder 20 may generate a Cb residual block and a Cr residual block for the CU, respectively, such that each sample in the CU's Cb residual block indicates a difference between a Cb sample in one of the CU's predictive Cb blocks and a corresponding sample in the CU's original Cb coding block and each sample in the CU's Cr residual block may indicate a difference between a Cr sample in one of the CU's predictive Cr blocks and a corresponding sample in the CU's original Cr coding block.

Furthermore, as illustrated in FIG. 1E, the video encoder 20 may use quad-tree partitioning to decompose the luma, Cb, and Cr residual blocks of a CU into one or more luma, Cb, and Cr transform blocks respectively. A transform block is a rectangular (square or non-square) block of samples on which the same transform is applied. A TU of a CU may include a transform block of luma samples, two corresponding transform blocks of chroma samples, and syntax elements used to transform the transform block samples. Thus, each TU of a CU may be associated with a luma transform block, a Cb transform block, and a Cr transform block. In some examples, the luma transform block associated with the TU may be a sub-block of the CU's luma residual block. The Cb transform block may be a sub-block of the CU's Cb residual block. The Cr transform block may be a sub-block of the CU's Cr residual block. In monochrome pictures or pictures having three separate color planes, a TU may include a single transform block and syntax structures used to transform the samples of the transform block.

The video encoder 20 may apply one or more transforms to a luma transform block of a TU to generate a luma coefficient block for the TU. A coefficient block may be a two-dimensional array of transform coefficients. A transform coefficient may be a scalar quantity. The video encoder 20 may apply one or more transforms to a Cb transform block of a TU to generate a Cb coefficient block for the TU. The video encoder 20 may apply one or more transforms to a Cr transform block of a TU to generate a Cr coefficient block for the TU.

After generating a coefficient block (e.g., a luma coefficient block, a Cb coefficient block or a Cr coefficient block), the video encoder 20 may quantize the coefficient block. Quantization generally refers to a process in which transform coefficients are quantized to possibly reduce the amount of data used to represent the transform coefficients, providing further compression. After the video encoder 20 quantizes a coefficient block, the video encoder 20 may entropy encode syntax elements indicating the quantized transform coefficients. For example, the video encoder 20 may perform CABAC on the syntax elements indicating the quantized transform coefficients. Finally, the video encoder 20 may output a bitstream that includes a sequence of bits that forms a representation of coded frames and associated data, which is either saved in the storage device 32 or transmitted to the destination device 14.

After receiving a bitstream generated by the video encoder 20, the video decoder 30 may parse the bitstream to obtain syntax elements from the bitstream. The video decoder 30 may reconstruct the frames of the video data based at least in part on the syntax elements obtained from the bitstream. The process of reconstructing the video data is generally reciprocal to the encoding process performed by the video encoder 20. For example, the video decoder 30 may perform inverse transforms on the coefficient blocks associated with TUs of a current CU to reconstruct residual blocks associated with the TUs of the current CU. The video decoder 30 also reconstructs the coding blocks of the current CU by adding the samples of the predictive blocks for PUs of the current CU to corresponding samples of the transform blocks of the TUs of the current CU. After reconstructing the coding blocks for each CU of a frame, video decoder 30 may reconstruct the frame.

As noted above, video coding achieves video compression using primarily two modes, i.e., intra-frame prediction (or intra-prediction) and inter-frame prediction (or inter-prediction). It is noted that IBC could be regarded as either intra-frame prediction or a third mode. Between the two modes, inter-frame prediction contributes more to the coding efficiency than intra-frame prediction because of the use of motion vectors for predicting a current video block from a reference video block.

But with the ever improving video data capturing technology and more refined video block size for preserving details in the video data, the amount of data required for representing motion vectors for a current frame also increases substantially. One way of overcoming this challenge is to benefit from the fact that not only a group of neighboring CUs in both the spatial and temporal domains have similar video data for predicting purpose but the motion vectors between these neighboring CUs are also similar. Therefore, it is possible to use the motion information of spatially neighboring CUs and/or temporally co-located CUs as an approximation of the motion information (e.g., motion vector) of a current CU by exploring their spatial and temporal correlation, which is also referred to as “Motion Vector Predictor (MVP)” of the current CU.

Instead of encoding, into the video bitstream, an actual motion vector of the current CU determined by the motion estimation unit as described above in connection with FIG. 1B, the motion vector predictor of the current CU is subtracted from the actual motion vector of the current CU to produce a Motion Vector Difference (MVD) for the current CU. By doing so, there is no need to encode the motion vector determined by the motion estimation unit for each CU of a frame into the video bitstream and the amount of data used for representing motion information in the video bitstream can be significantly decreased.

Like the process of choosing a predictive block in a reference frame during inter-frame prediction of a code block, a set of rules need to be adopted by both the video encoder 20 and the video decoder 30 for constructing a motion vector candidate list (also known as a “merge list”) for a current CU using those potential candidate motion vectors associated with spatially neighboring CUs and/or temporally co-located CUs of the current CU and then selecting one member from the motion vector candidate list as a motion vector predictor for the current CU. By doing so, there is no need to transmit the motion vector candidate list itself from the video encoder 20 to the video decoder 30 and an index of the selected motion vector predictor within the motion vector candidate list is sufficient for the video encoder 20 and the video decoder 30 to use the same motion vector predictor within the motion vector candidate list for encoding and decoding the current CU.

The present disclosure is to further enhance the Intra Block Copy method by either improving the coding efficiency and/or reducing its coding complexities.

### Affine Model

In HEVC, only translation motion model is applied for motion compensated prediction. While in the real world, there are many kinds of motion, e.g. zoom in/out, rotation, perspective motions and other irregular motions. In the VVC, affine motion compensated prediction is applied by signaling one flag for each inter coding block to indicate whether the translation motion model or the affine motion model is applied for inter prediction. In the current VVC, two affine modes, including 4-parameter affine mode and 6-parameter affine mode, are supported for one affine coding block.

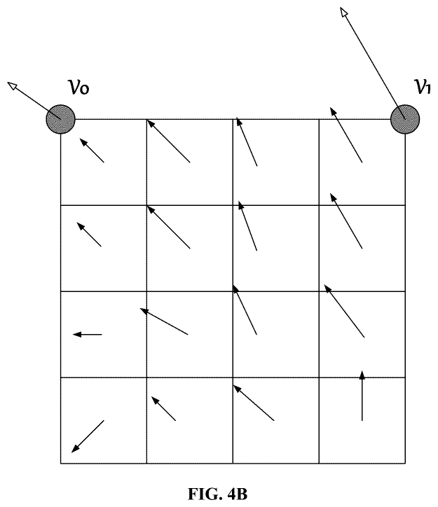

The 4-parameter affine model has the following parameters: two parameters for translation movement in horizontal and vertical directions respectively, one parameter for zoom motion and one parameter for rotational motion for both directions. In this model, horizontal zoom parameter is equal to vertical zoom parameter, and horizontal rotation parameter is equal to vertical rotation parameter. To achieve a better accommodation of the motion vectors and affine parameter, those affine parameters are to be derived from two MVs (which are also called control point motion vector (CPMV)) located at the top-left corner and top-right corner of a current block. As shown in FIGS. 4A-4B, the affine motion field of the block is described by two CPMVs (V₀, V₁). Based on the control point motion, the motion field (vₓ, v_{y}) of one affine coded block is described as

$${v}_{x} = \frac{( {v}_{1 x} - {v}_{0 x} )}{w} x - \frac{( {v}_{1 y} - {v}_{0 y} )}{w} y + {v}_{0 x} \qquad ( 1 )$$

$${v}_{y} = \frac{( {v}_{1 y} - {v}_{0 x} )}{w} x + \frac{( {v}_{1 x} - {v}_{0 x} )}{w} y + {v}_{0 y}$$

The 6-parameter affine mode has the following parameters: two parameters for translation movement in horizontal and vertical directions respectively, two parameters for zoom motion and rotation motion respectively in horizontal direction, another two parameters for zoom motion and rotation motion respectively in vertical direction. The 6-parameter affine motion model is coded with three CPMVs. As shown in FIG. 5, the three control points of one 6-parameter affine block are located at the top-left, top-right and bottom left corner of the block. The motion at top-left control point is related to translation motion, and the motion at top-right control point is related to rotation and zoom motion in horizontal direction, and the motion at bottom-left control point is related to rotation and zoom motion in vertical direction. Compared to the 4-parameter affine motion model, the rotation and zoom motion in horizontal direction of the 6-parameter may not be same as those motion in vertical direction. Assuming (V₀, V₁, V₂) are the MVs of the top-left, top-right and bottom-left corners of the current block in FIG. 5, the motion vector of each sub-block (vₓ, v_{y}) is derived using the three MVs at control points as:

$$\begin{matrix}{v}_{x} = {v}_{0 x} + ( {v}_{1 x} - {v}_{0 x} ) * \frac{x}{w} + ( {v}_{2 x} - {v}_{0 x} ) * \frac{y}{h} \\ {v}_{y} = {v}_{0 y} + ( {v}_{1 y} - {v}_{0 y} ) * \frac{x}{w} + ( {v}_{2 y} - {v}_{0 y} ) * \frac{y}{h}\end{matrix} \qquad ( 2 )$$

### Affine Merge Mode

In affine merge mode, the CPMVs for the current block are not explicitly signaled but derived from neighboring blocks. Specifically, in this mode, motion information of spatial neighbor blocks is used to generate CPMVs for the current block. The affine merge mode candidate list has a limited size. For example, in the current VVC design, there may be up to five candidates. The encoder may evaluate and choose the best candidate index based on rate-distortion optimization algorithms. The chosen candidate index is then signaled to the decoder side. The affine merge candidates can be decided in three ways:
Inherited from neighboring affine coded blocks
Constructed from translational MVs from neighboring blocks
Zero MVs

For the inherited method, there may be up to two candidates. The candidates are obtained from the neighboring blocks located at the bottom-left of the current block (e.g., scanning order is from A0 to A1 as shown in FIG. 6) and from the neighboring blocks located at the top-right of the current block (e.g., scanning order is from B0 to B2 as shown in FIG. 6), if available.

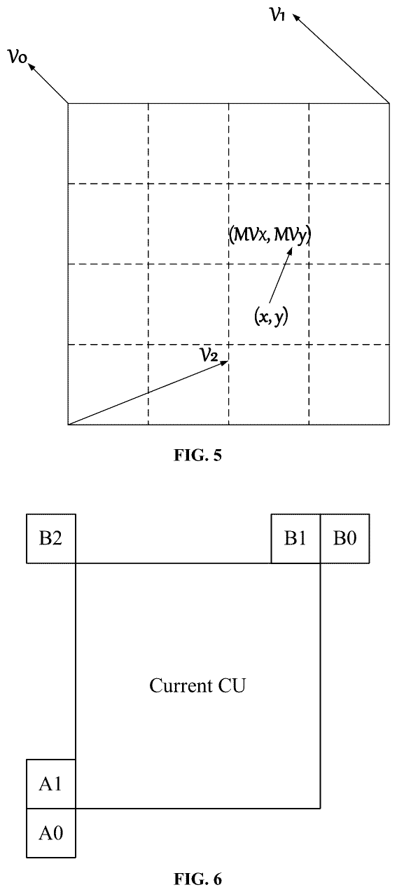

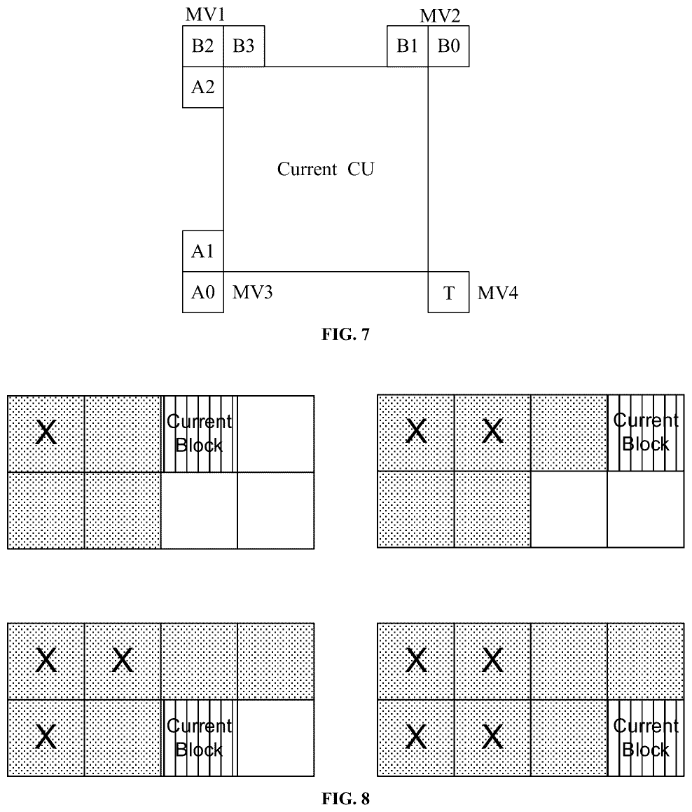

For the constructed method, the candidates are the combinations of neighbor blocks' translational MVs, which are generated by two steps.
Step 1: obtain four translational MVs from available neighbor blocks.
   MV1: MV from the one of the three neighboring blocks close to the top-left corner of the current block. As shown in the FIG. 7, the scanning order is B2, B3 and A2.
   MV2: MV from the one of the one from the two neighboring blocks close to the top-right corner of the current block. As shown in the FIG. 7, the scanning order is Bland B0.
   MV3: MV from the one of the one from the two neighboring blocks close to the bottom-left corner of the current block. As shown in the FIG. 7, the scanning order is A1 and A0.
   MV4: MV from the temporally collocated block of the neighboring block close to the bottom-right corner of current block. As shown in the Fig, the neighboring block is T.
Step 2: derive combinations based on the four translational MVs from step 1.
   Combination 1: MV1, MV2, MV3
   Combination 2: MV1, MV2, MV4
   Combination 3: MV1, MV3, MV4
   Combination 4: MV2, MV3, MV4
   Combination 5: MV1, MV2
   Combination 6: MV1, MV3

When the merge candidate list is not full after filling with inherited and constructed candidates, zero MVs are inserted at the end of the list.

### Affine AMVP Mode

Affine AMVP (advanced motion vector prediction) mode may be applied for CUs with both width and height larger than or equal to 16. An affine flag in CU level is signalled in the bitstream to indicate whether affine AMVP mode is used and then another flag is signalled to indicate whether 4-parameter affine or 6-parameter affine. In this mode, the difference of the CPMVs of current CU and their predictors CPMVPs is signalled in the bitstream. The affine AMVP candidate list size is 2 and the affine AMVP candidate list is generated by using the following four types of CPMV candidate in order:
Inherited affine AMVP candidates that extrapolated from the CPMVs of the neighbour CUs
Constructed affine AMVP candidates CPMVPs that are derived using the translational MVs of the neighbour CUs
Translational MVs from neighboring CUs
Temporal MVs from collocated CUs
Zero MVs

The checking order of inherited affine AMVP candidates is the same to the checking order of inherited affine merge candidates. The only difference is that, for AMVP candidate, only the affine CU that has the same reference picture as in current block is considered. No pruning process is applied when inserting an inherited affine motion predictor into the candidate list.

Constructed AMVP candidate is derived from the same spatial neighbor blocks as affine merge mode. The same checking order is used as done in affine merge candidate construction. In addition, reference picture index of the neighboring block is also checked. The first block in the checking order that is inter coded and has the same reference picture as in current CUs is used. When the current CU is coded with 4-parameter affine mode, and mv₀ and my₁ are both available, mv₀ and my₁ are added as one candidate in the affine AMVP candidate list. When the current CU is coded with 6-parameter affine mode, and all three CPMVs are available, they are added as one candidate in the affine AMVP candidate list. Otherwise, constructed AMVP candidate is set as unavailable.

If affine AMVP list candidates are still less than 2 after valid inherited affine AMVP candidates and constructed AMVP candidate are inserted, mv₀, my₁ and mV₂ will be added, in order, as the translational MVs to predict all control point MVs of the current CU, when available. Finally, zero MVs are used to fill the affine AMVP list if it is still not full.

### Intra Block Copy in Versatile Video Coding (VVC)

Intra block copy (IBC) is a tool adopted in HEVC extensions on SCC. It is well known that it significantly improves the coding efficiency of screen content materials. Since IBC mode is implemented as a block level coding mode, block matching (BM) is performed at the encoder to find the optimal block vector (or motion vector) for each CU. Here, a block vector is used to indicate the displacement from the current block to a reference block, which is already reconstructed inside the current picture. The luma block vector of an IBC-coded CU is in integer precision. The chroma block vector rounds to integer precision as well. When combined with AMVR, the IBC mode can switch between 1-pel and 4-pel motion vector precisions. An IBC-coded CU is treated as the third prediction mode other than intra or inter prediction modes. The IBC mode is applicable to the CUs with both width and height smaller than or equal to 64 luma samples.

At the encoder side, hash-based motion estimation is performed for IBC. The encoder performs RD check for blocks with either width or height no larger than 16 luma samples. For non-merge mode, the block vector search is performed using hash-based search first. If hash search does not return valid candidate, block matching based local search will be performed.

In the hash-based search, hash key matching (32-bit CRC) between the current block and a reference block is extended to all allowed block sizes. The hash key calculation for every position in the current picture is based on 4×4 subblocks. For the current block of a larger size, a hash key is determined to match that of the reference block when all the hash keys of all 4×4 subblocks match the hash keys in the corresponding reference locations. If hash keys of multiple reference blocks are found to match that of the current block, the block vector costs of each matched reference are calculated and the one with the minimum cost is selected.

In block matching search, the search range is set to cover both the previous and current CTUs.

At CU level, IBC mode is signalled with a flag and it can be signaled as IBC AMVP mode or IBC skip/merge mode as follows:
IBC skip/merge mode: a merge candidate index is used to indicate which of the block vectors in the list from neighboring candidate IBC coded blocks is used to predict the current block. The merge list consists of spatial, HMVP, and pairwise candidates.
IBC AMVP mode: block vector difference is coded in the same way as a motion vector difference. The block vector prediction method uses two candidates as predictors, one from left neighbor block and one from above neighbor block (if IBC coded). When either neighbor block is not available, a default block vector will be used as a predictor. A flag is signaled to indicate the block vector predictor index.

### IBC Reference Region

To reduce memory consumption and decoder complexity, the IBC in VVC allows only the reconstructed portion of the predefined area including the region of current CTU and some region of the left CTU. FIG. 8 illustrates the reference region of IBC Mode, where each block represents 64×64 luma sample unit.

Depending on the location of the current coding CU location within the current CTU, the following applies:
If current block falls into the top-left 64×64 block of the current CTU, then in addition to the already reconstructed samples in the current CTU, it can also refer to the reference samples in the bottom-right 64×64 blocks of the left CTU, using CPR mode. The current block can also refer to the reference samples in the bottom-left 64×64 block of the left CTU and the reference samples in the top-right 64×64 block of the left CTU, using CPR mode.
If current block falls into the top-right 64×64 block of the current CTU, then in addition to the already reconstructed samples in the current CTU, if luma location (0, 64) relative to the current CTU has not yet been reconstructed, the current block can also refer to the reference samples in the bottom-left 64×64 block and bottom-right 64×64 block of the left CTU, using CPR mode; otherwise, the current block can also refer to reference samples in bottom-right 64×64 block of the left CTU.
If current block falls into the bottom-left 64×64 block of the current CTU, then in addition to the already reconstructed samples in the current CTU, if luma location (64, 0) relative to the current CTU has not yet been reconstructed, the current block can also refer to the reference samples in the top-right 64×64 block and bottom-right 64×64 block of the left CTU, using CPR mode. Otherwise, the current block can also refer to the reference samples in the bottom-right 64×64 block of the left CTU, using CPR mode.
If current block falls into the bottom-right 64×64 block of the current CTU, it can only refer to the already reconstructed samples in the current CTU, using CPR mode.

This restriction allows the IBC mode to be implemented using local on-chip memory for hardware implementations.

IBC Interaction with Other Coding Tools

The interaction between IBC mode and other inter coding tools in VVC, such as pairwise merge candidate, history based motion vector predictor (HMVP), combined intra/inter prediction mode (CIIP), merge mode with motion vector difference (MMVD), and geometric partitioning mode (GPM) are as follows:
IBC can be used with pairwise merge candidate and HMVP. A new pairwise IBC merge candidate can be generated by averaging two IBC merge candidates. For HMVP, IBC motion is inserted into history buffer for future referencing.
IBC cannot be used in combination with the following inter tools: affine motion, CIIP, MMVD, and GPM.
IBC is not allowed for the chroma coding blocks when DUAL_TREE partition is used.

Unlike in the HEVC screen content coding extension, the current picture is no longer included as one of the reference pictures in the reference picture list 0 for IBC prediction. The derivation process of motion vectors for IBC mode excludes all neighboring blocks in inter mode and vice versa. The following IBC design aspects are applied:
IBC shares the same process as in regular MV merge including with pairwise merge candidate and history-based motion predictor, but disallows TMVP and zero vector because they are invalid for IBC mode.
Separate HMVP buffer (5 candidates each) is used for conventional MV and IBC.
Block vector constraints are implemented in the form of bitstream conformance constraint, the encoder needs to ensure that no invalid vectors are present in the bitstream, and merge shall not be used if the merge candidate is invalid (out of range or 0). Such bitstream conformance constraint is expressed in terms of a virtual buffer as described below.
For deblocking, IBC is handled as inter mode.
If the current block is coded using IBC prediction mode, AMVR does not use quarter-pel; instead, AMVR is signaled to only indicate whether MV is inter-pel or 4 integer-pel.
The number of IBC merge candidates can be signaled in the slice header separately from the numbers of regular, subblock, and geometric merge candidates.

A virtual buffer concept is used to describe the allowable reference region for IBC prediction mode and valid block vectors. Denote CTU size as ctbSize, the virtual buffer, ibcBuf, has width being wIbcBuf=128×128/ctbSize and height hIbcBuf=ctbSize. For example, for a CTU size of 128×128, the size of ibcBuf is also 128×128; for a CTU size of 64×64, the size of ibcBuf is 256×64; and a CTU size of 32×32, the size of ibcBuf is 512×32.

The size of a VPDU is min(ctbSize, 64) in each dimension, Wᵥ=min(ctbSize, 64).

The virtual IBC buffer, ibcBuf is maintained as follows.
At the beginning of decoding each CTU row, refresh the whole ibcBuf with an invalid value −1.
At the beginning of decoding a VPDU (xVPDU, yVPDU) relative to the top-left corner of the picture, set the ibcBuf[x][y]=−1, with x=xVPDU % wIbcBuf, . . . , xVPDU % wIbcBuf+Wᵥ−1; y=yVPDU % ctbSize, . . . , yVPDU % ctbSize+Wᵥ−1.
After decoding a CU contains (x, y) relative to the top-left corner of the picture, set
ibcBuf[x % wIbcBuf][y % ctbSize]=recSample[x][y]

For a block covering the coordinates (x, y), if the following is true for a block vector bv=(bv[0], bv[1]), then it is valid; otherwise, it is not valid:
ibcBuf[(x+bv[0])% wIbcBuf][(y+bv[1]) % ctbSize] shall not be equal to −1.

### Intra Block Copy in Enhanced Compression Model (ECM)

In ECM, IBC is improved from aspects below.

### IBC Merge/AMVP List Construction

The IBC merge/AMVP list construction is modified as follows:
Only if an IBC merge/AMVP candidate is valid, it can be inserted into the IBC merge/AMVP candidate list.
Above-right, bottom-left, and above-left spatial candidates and one pairwise average candidate can be added into the IBC merge/AMVP candidate list.
Template based adaptive reordering (ARMC-TM) is applied to IBC merge list.

The HMVP table size for IBC is increased to 25. After up to 20 IBC merge candidates are derived with full pruning, they are reordered together. After reordering, the first 6 candidates with the lowest template matching costs are selected as the final candidates in the IBC merge list.

The zero vectors' candidates to pad the IBC Merge/AMVP list are replaced with a set of BVP candidates located in the IBC reference region. A zero vector is invalid as a block vector in IBC merge mode, and consequently, it is discarded as BVP in the IBC candidate list.

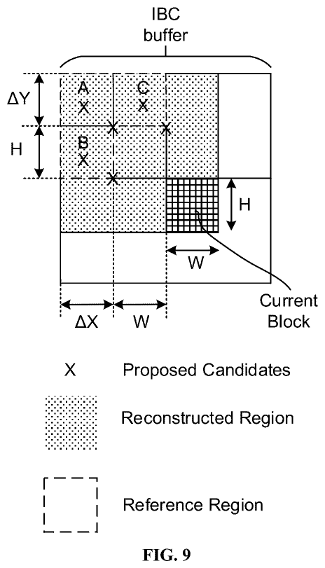

Three candidates are located on the nearest corners of the reference region, and three additional candidates are determined in the middle of the three sub-regions (A, B, and C), whose coordinates are determined by the width, and height of the current block and the ΔX and ΔY parameters, as is depicted in FIG. 9.

IBC with Template Matching

Template Matching is used in IBC for both IBC merge mode and IBC AMVP mode.

The IBC-TM merge list is modified compared to the one used by regular IBC merge mode such that the candidates are selected according to a pruning method with a motion distance between the candidates as in the regular TM merge mode. The ending zero motion fulfillment is replaced by motion vectors to the left (−W, 0), top (0, −H) and top-left (−W, −H), where W is the width and H the height of the current CU.

In the IBC-TM merge mode, the selected candidates are refined with the Template Matching method prior to the RDO or decoding process. The IBC-TM merge mode has been put in competition with the regular IBC merge mode and a TM-merge flag is signaled.

In the IBC-TM AMVP mode, up to 3 candidates are selected from the IBC-TM merge list. Each of those 3 selected candidates are refined using the Template Matching method and sorted according to their resulting Template Matching cost. Only the 2 first ones are then considered in the motion estimation process as usual.

The Template Matching refinement for both IBC-TM merge and AMVP modes is quite simple since IBC motion vectors are constrained (i) to be integer and (ii) within a reference region as shown in FIG. 8. So, in IBC-TM merge mode, all refinements are performed at integer precision, and in IBC-TM AMVP mode, they are performed either at integer or 4-pel precision depending on the AMVR value. Such a refinement accesses only to samples without interpolation. In both cases, the refined motion vectors and the used template in each refinement step must respect the constraint of the reference region.

### IBC Reference Area

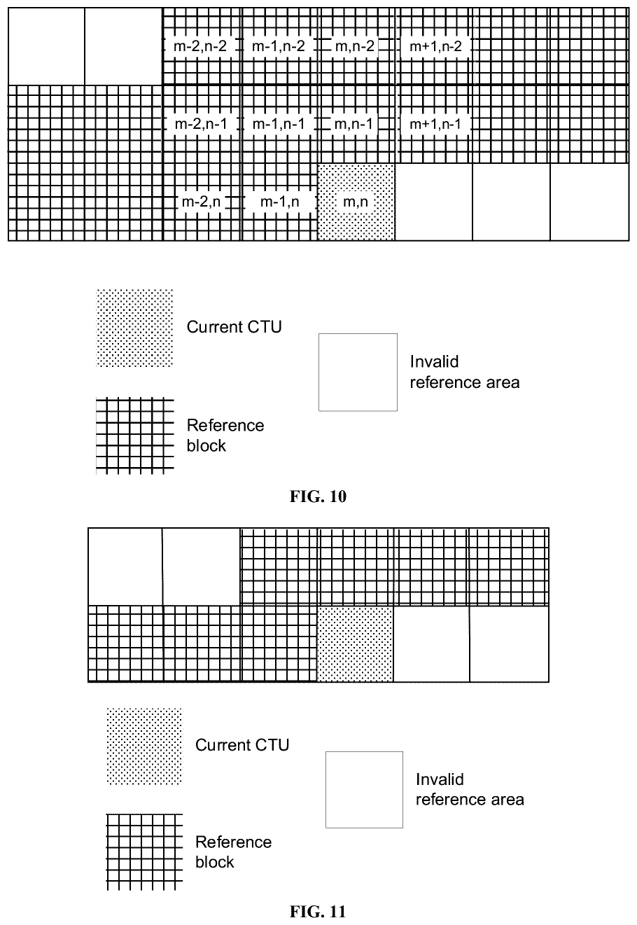

The reference area for IBC is extended to two CTU rows above. FIG. 10 illustrates the reference area for coding CTU (m,n). Specifically, for CTU (m,n) to be coded, the reference area includes CTUs with index (m−2,n−2) . . . (W,n−2), (0,n−1) . . . (W,n−1), (0,n) . . . (m,n), where W denotes the maximum horizontal index within the current tile, slice or picture. This setting ensures that for CTU size being 128, IBC does not require extra memory in the current ETM platform. The per-sample block vector search (or called local search) range is limited to [−(C<<1), C>>2] horizontally and [−C, C>>2] vertically to adapt to the reference area extension, where C denotes the CTU size.

IBC Merge Mode with Block Vector Differences

IBC merge mode with block vector differences is adopted in ECM. The distance set is {1-pel, 2-pel, 4-pel, 8-pel, 12-pel, 16-pel, 24-pel, 32-pel, 40-pel, 48-pel, 56-pel, 64-pel, 72-pel, 80-pel, 88-pel, 96-pel, 104-pel, 112-pel, 120-pel, 128-pel}, and the BVD directions are two horizontal and two vertical directions.

The base candidates are selected from the first five candidates in the reordered IBC merge list. And based on the SAD cost between the template (one row above and one column left to the current block) and its reference for each refinement position, all the possible MBVD refinement positions (20×4) for each base candidate are reordered. Finally, the top 8 refinement positions with the lowest template SAD costs are kept as available positions, consequently for MBVD index coding.

### IBC Adaptation for Camera-Captured Content

When adapt IBC for camera-captured content, IBC reference range is reduced from 2 CTU rows to 2×128 rows as shown in FIG. 11. At encoder side to reduce the complexity, the local search range is set to [−8,8] horizontally and [−8,8] vertically centered at the first block vector predictor of the current CU. This encoder modification is not applied to SCC sequences.

### MVD Sign Prediction

In this method, possible MVD sign combinations are sorted according to the template matching cost and index corresponding to the true MVD sign is derived and context coded. At decoder side, the MVD signs are derived as following:
1. Parse the magnitude of MVD components
2. Parse context-coded MVD sign prediction index
3. Build MV candidates by creating combination between possible signs and absolute MVD value and add it to the MV predictor
4. Derive MVD sign prediction cost for each derived MV based on template matching cost and sort
5. Use MVD sign prediction index to pick the true MVD sign MVD sign prediction is applied to inter AMVP, affine AMVP, MMVD and affine MMVD modes.

### Combined Inter-Intra Prediction (CIIP)

Inter prediction uses the signaled motion data to reference the temporal information from different pictures to perform motion compensation which shows significant benefit in video compression. Among inter prediction, merge mode is one special inter prediction which uses simpler signaling scheme to derive the motion data based on a previously coded CU. On the other hand, intra prediction tends to provide more accurate spatial prediction when a sample is closer to the reference sample. To take the advantages of both inter-prediction merge mode and intra prediction, a new merge mode, called CIIP mode, is designed for the CU which contains at least 64 luma samples and has both CU width and CU height smaller than 128. In CIIP mode, a weighted combination of inter-prediction merge mode and intra prediction is utilized for prediction as follows. The merge prediction is derived with the inter-prediction process for a regular merge mode and the intra prediction is derived with the intra-prediction process for planar mode. Then, a weighted averaging process is applied to combine both predictions. The sum of prediction weights is equal to 4 and a right-shift operation is used after adding two weighted predictions. The final prediction for CIIP, denoted as p_{CIIP}, is formed as follows.

$${P}_{CIIP} = ( {W}_{m e r g e} * {P}_{m e r g e} + {W}_{intra} * {P}_{intra} + 2 ) ≫ 2 \qquad ( 3 )$$

wherein Wᵢₙₜᵣₐ is the weight for the intra prediction, denoted as pᵢₙₜᵣₐ, W_{merge} is the weight for the merge prediction, denoted as p_{merge}, and sum of W_{merge} and Wᵢₙₜᵣₐ is equal to 4. The weights for intra- and merge-predicted samples are uniform in the whole CU and decided based on the number of neighboring intra blocks. If both top and left neighboring blocks are intra-coded, Wᵢₙₜᵣₐ is set as 3 which means intra prediction is preferred. Otherwise, if only one of these blocks is intra-coded, Wᵢₙₜᵣₐ is set as 2 which implies identical weights are used for two predictions. Otherwise, Wᵢₙₜᵣₐ is set as 1. The weights for CIIP are the same for luma and chroma components. By weighted averaging one existing merge prediction and another existing intra prediction with a simple weighting process, better coding efficiency could be achieved. Moreover, to avoid 2×N intra blocks, only the merge prediction is used for the chroma CB when the chroma CB has width smaller than 4. To indicate the usage of CIIP mode, an additional flag is conditionally signaled to indicate whether CIIP is used or not when regular merge mode is selected.
Combination of CIIP with TIMD and TM Merge

In CIIP mode, the prediction samples are generated by weighting an inter prediction signal predicted using CIIP-TM merge candidate and an intra prediction signal predicted using TIMD derived intra prediction mode. The method is only applied to coding blocks with an area less than or equal to 1024.

The TIMD derivation method is used to derive the intra prediction mode in CIIP. Specifically, the intra prediction mode with the smallest SATD values in the TIMD mode list is selected and mapped to one of the 67 regular intra prediction modes.

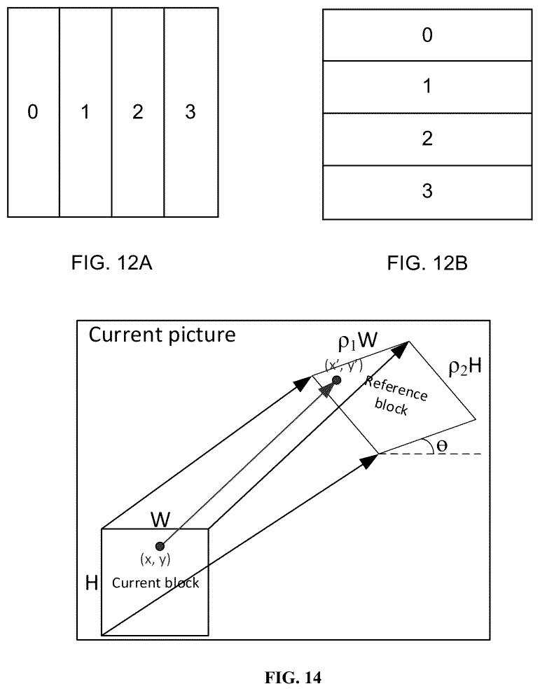

In addition, it is also proposed to modify the weights (wIntra, wInter) for the two tests if the derived intra prediction mode is an angular mode. For near-horizontal modes (2<=angular mode index <34), the current block is vertically divided as shown in FIG. 12A; for near-vertical modes (34<=angular mode index <=66), the current block is horizontally divided as shown in FIG. 12B.

The (wIntra, wInter) for different sub-blocks are shown in Table 1.

TABLE 1
The modified weights used for angular modes.

| The sub-block index | (wIntra, wInter) |
|---|---|
| 0 | (6, 2) |
| 1 | (5, 3) |
| 2 | (3, 5) |
| 3 | (2, 6) |

With CIIP-TM, a CIIP-TM merge candidate list is built for the CIIP-TM mode. The merge candidates are refined by template matching. The CIIP-TM merge candidates are also reordered by the ARMC method as regular merge candidates. The maximum number of CIIP-TM merge candidates is equal to two.

### Multi-Hypothesis Prediction (MHP)

In the multi-hypothesis inter prediction mode, one or more additional motion-compensated prediction signals are signaled, in addition to the conventional bi prediction signal. The resulting overall prediction signal is obtained by sample-wise weighted superposition. With the bi prediction signal p_{bi} and the first additional inter prediction signal/hypothesis h₃, the resulting prediction signal p₃ is obtained as follows:

$${p}_{3} = ( 1 - α ) {p}_{b i} + α {h}_{3}$$

The weighting factor α is specified by the new syntax element add_hyp_weight_idx, according to the mapping presented in Table 2:

TABLE 2
The mapping between add_hyp_weight_idx and α.

| add_hyp_weight_idx | α |
|---|---|
| 0 | ¼ |
| 1 | −⅛ |

Analogously to above, more than one additional prediction signal can be used. The resulting overall prediction signal is accumulated iteratively with each additional prediction signal.

$${p}_{n + 1} = ( 1 - {α}_{n + 1} ) {p}_{n} + {α}_{n + 1} {h}_{n + 1}$$

The resulting overall prediction signal is obtained as the last pₙ (i.e., the pₙ having the largest index n). Within this mode, up to two additional prediction signals can be used (i.e., n is limited to 2).

The motion parameters of each additional prediction hypothesis can be signaled either explicitly by specifying the reference index, the motion vector predictor index, and the motion vector difference, or implicitly by specifying a merge index. A separate multi-hypothesis merge flag distinguishes between these two signalling modes.

For inter AMVP mode, MHP is only applied if non-equal weight in BCW is selected in bi-prediction mode.

Combination of MHP and BDOF is possible, however the BDOF is only applied to the bi-prediction signal part of the prediction signal (i.e., the ordinary first two hypotheses).

In the latest video coding standards such as VVC, intra block copy is well known to accurately predict screen content and artificially generated content where patterns and edges may repeat within the frame. However, the content predicted by intra block copy is limited to translational transformations, which is achieved by simply copying neighboring pixels. For the video content which is subject to more complex geometrical transformations such as stretches, zooms, rotations and reflections, etc., the current intra block copy method may not be able to provide accurate predictions. It is straightforward to expand the capability of the traditional IBC mode by not only predicting translational transformations but also more complicated transformations.

Currently, the block vector difference (BVD) sign in the IBC tool is encoded by bypass mode, it is straightforward to adapt the MVD sign prediction technology for BVD sign prediction, which may decrease the bits overhead of the BVD sign coding.

Currently, after adapting the IBC tool to camera-captured content, the coding block coded with IBC mode can be combined with the coding block coded with intra mode or inter mode, which may improve the prediction accuracy and improve the coding performance.

Currently, after adapting the IBC tool to camera-captured content, the block vector (BV) number in the IBC tool can be increased and the prediction results can be combined, which may improve the prediction accuracy and improve the coding performance.

According to the present disclosure, the coding tool of intra block copy is improved from aspects including: Multi-model intra block copy, BVD sign prediction, Combined IBC-intra/inter prediction, and Multiple hypothesis IBC prediction.

### Multi-Model Intra Block Copy

Within a piece of video or image content, the presence of distinct linear transformations may be classified into two categories:
Translational transformation
Non-translational transformation, or termed as affine transformation, including rotations, stretches (scaling in one direction), zooms (scaling in two directions), reflections, etc.

Generally speaking, it requires higher model complexity when it aims to support more complex transformations. As the diversity of the transformations is highly content dependent, it is desirable to make the IBC capability to be adaptive to various video content. To this end, a multi-model IBC approach is provided to support adaptive linear transformations, which allows IBC to be adaptively switched among three models: 2-parameter model, 4-parameter model and 6-parameter model.

In summary, this disclosure provides several methods to adaptively switch the capability of the intra block copy method in order to provide better tradeoff between compression efficiency and complexity, which may include following aspects:
1. Adaptive switch between explicit derivation and implicit derivation of the linear transformation vector.
2. Adaptive switch among 2-parameter, 4-parameter, or 6-parameter linear transformation models.
3. Adaptive switch of different mode decision flows.
4. Adaptive switch of different precisions of the linear transformation vectors.
5. Adaptive switch of different representations of the linear transformation vectors.

### Explicit Derivation of Linear Transformation Vector

In the explicit derivation method, linear transformation vectors are determined at the encoder side, and signaled to the decoder side. To reduce the magnitude and potentially the number of signaling bits, the linear transformation vectors (LTV) may include two parts: linear transformation vector predictor (LTVP) and difference (LTVD). The best LTVP is evaluated and selected from a list of LTVP candidates by the encoder and the index of the selected best LTVP is signaled to the decoder. The selected LTVP is then refined at the encoder side by adding a difference value, termed as LTVD, and then the LTVD value is compressed and signaled to the decoder side.

A list of potential LTVP candidates may be built by using any combinations of methods below:
2-parameter LTVP
   Inherited LTVP from adjacent neighbor blocks
   Inherited LTVP from non-adjacent neighbor blocks
   Constructed LTVP from adjacent neighbor blocks
   Constructed LTVP from adjacent neighbor blocks
4-parameter LTVP
   Inherited LTVP from adjacent neighbor blocks
   Inherited LTVP from non-adjacent neighbor blocks
   Constructed LTVP from adjacent neighbor blocks
   Constructed LTVP from adjacent neighbor blocks
6-parameter LTVP
   Inherited LTVP from adjacent neighbor blocks
   Inherited LTVP from non-adjacent neighbor blocks
   Constructed LTVP from adjacent neighbor blocks
   Constructed LTVP from adjacent neighbor blocks
Zero padded LTVP

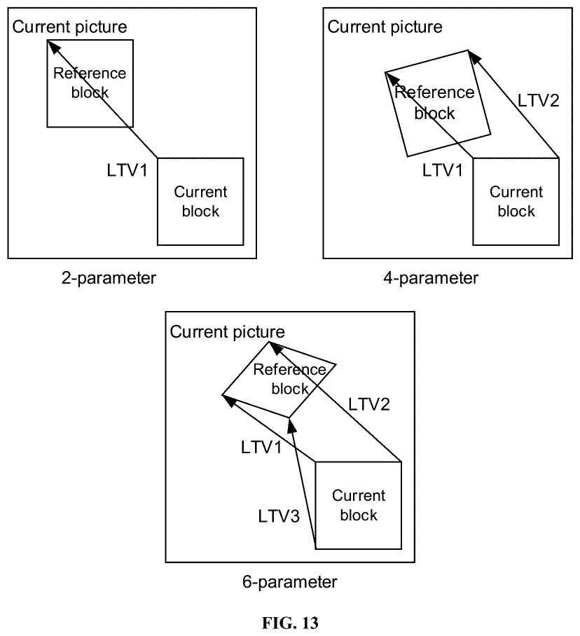

The examples representing the 2-parameter, 4-parameter and 6-parameter linear transformations are shown in FIG. 13.

As shown in FIG. 14, given a current block with width W and height H, for a specific sample/pixel location at (x, y), the location of its corresponding reference sample/pixel under a 6-parameter model may be represented as:

$$\{ \begin{matrix}{x}^{′} = p 1 \cdot cos θ \cdot x + p 2 \cdot sin θ \cdot y + c \\ {y}^{′} = - p 1 \cdot sin θ \cdot x + p 2 \cdot cos θ \cdot y + f\end{matrix} \qquad ( 3 )$$

where p1 and p2 are the horizontal and vertical scaling factors, θ is the rotation angle, while c and f are translational displacement at horizontal and vertical direction. From equation (3), the displacement vector (DV) from any current sample (x, y) to its reference sample (x′, y′) may be derived as:

$$\{ \begin{matrix}{DV}_{( x , y )}^{h} = {x}^{′} - x = ( p 1 \cdot cos θ - 1 ) \cdot x + p 2 \cdot sin θ \cdot y + c = ax + by + c \\ {DV}_{( x , y )}^{v} = {y}^{′} - y = - p 1 \cdot sin θ \cdot x + ( p 2 \cdot cos θ - 1 ) \cdot y + f = dx + ey + f\end{matrix} \qquad ( 4 )$$

In one or more embodiments, the model parameters (a, b, c, d, e, f) in (4) may be represented by the associated LTVs located at the top-left (LTV1), top-right (LTV2) and bottom-left (LTV3) positions, as shown in FIG. 13. In this case, depending on which model is used, the displacement vector of any sample/pixel (x,y) within the current block may be derived as:

$$\begin{matrix}2 - parameter model : & \{ \begin{matrix}{DV}_{( x , y )}^{h} = c \\ {DV}_{( x , y )}^{v} = f\end{matrix}\end{matrix} \qquad ( 5 )$$

$$4 - parameter model : \{ \begin{matrix}{DV}_{( x , y )}^{h} = ax - by + c = LTV {1}^{h} + \frac{( LTV {2}^{h} - LTV {1}^{h} )}{w} \cdot x - \frac{( LTV {2}^{v} - LTV {1}^{v} )}{w} \cdot y \\ {DV}_{( x , y )}^{v} = bx + ay + f = LTV {1}^{v} + \frac{( LTV {2}^{v} - LTV {1}^{v} )}{w} \cdot x - \frac{( LTV {2}^{h} - LTV {1}^{h} )}{w} \cdot y\end{matrix} \qquad ( 6 )$$

$$6 - parameter model : \{ \begin{matrix}{DV}_{( x , y )}^{h} = ax + by + c = LTV {1}^{h} + \frac{( LTV {2}^{h} - LTV {1}^{h} )}{w} \cdot x - \frac{( LTV {3}^{h} - LTV {1}^{h} )}{h} \cdot y \\ {DV}_{( x , y )}^{v} = dx + ey + f = LTV {1}^{v} + \frac{( LTV {2}^{v} - LTV {1}^{v} )}{w} \cdot x - \frac{( LTV {3}^{v} - LTV {1}^{v} )}{h} \cdot y\end{matrix} \qquad ( 7 )$$

Given the candidate list of LTVP, one or more candidates from the list are iteratively refined at the encoder side such that the candidate with minimal Sum of Absolute Transformed Difference (SATD) cost between the compensated reference samples and the original samples is selected.

In some examples, the candidate list may be reordered according to bilateral matching cost or template cost, such that the most accurate candidates are likely to be replaced in the front of the list.

In some examples, the candidate refinement process may be similarly performed as the gradient-based iterative motion estimation process used for affine inter prediction mode, as shown in the equation (5).

In some examples, each candidate in the candidate list may be considered as an initial LTV, the iterative motion estimation process is performed to refine each candidate. The candidate with minimum SATD cost is selected as the best candidate and the corresponding index is signaled. The refinements obtained for the best candidate are considered to be the LTVD, which are then compressed and signaled to the decoder.

Alternatively or additionally, the best candidate is determined before the iterative motion estimation process. In one determination method, each LTVP may be directly set to be the final LTV, and the affine motion compensation process is performed to find best candidate with minimum SATD cost. Once the best candidate is determined, the subsequent refinement process may be the same as the iterative motion estimation process.

In some examples, when performing gradient-based iterative motion estimation process, the newly update LTV is always compared with the best N final candidates from the parent block. Note that, if only one candidate of the parent block is iteratively refined, the value of N may be set to 1. Alternatively, the best N final candidates may be scaled up based on the ratio of sizes between the current block and the parent block. The parent block is a block that contains the current block, i.e., the block from which the current block is split from. When an encoder tests the best partition granularity, the encoder will test large blocks, e.g., the parent blocks, first, then further split the current large blocks into smaller blocks. The encoder may explicitly derive the best motion by performing the motion estimation, then signal the best candidate index and the motion difference to the decoder, the motion difference=best motion—best candidate, where the candidate is called motion predictor which are selected from the candidate list. That is, the motion estimation process may be performed only at the encoder, but the output (motion predictor that is determined by the signaled candidate index, and the motion difference) is signaled to the decoder.

In some examples, at each iteration of the gradient-based motion estimation process, the delta refinements may be arbitrarily large and cause potential large deviations. In this case, regularization items may be added to the error function for solving the best delta refinements at each iteration.

In some examples, at each iteration of the gradient-based motion estimation process, if the refined LTV yields higher SATD cost than the refined LTV from previous iteration, the delta refinements are reduced by half before being added.

$$\frac{\partial {\sum }_{( x , y ) ∈ B l k} {\vert error ( x , y ) + g ( x , y ) T ( x , y ) dmv \vert}^{2}}{\partial d m v} = 0 \qquad ( 8 )$$

where, for each sample (x,y) from the current block, the error(x,y) represent that in the (i+1) iteration, the sample value error between the compensated reference sample from the ith iteration and the original sample, the g(x, y) is the gradient value at the compensated reference sample from the ith iteration, and the T(x, y) is the transformation matrix from one of the three model.

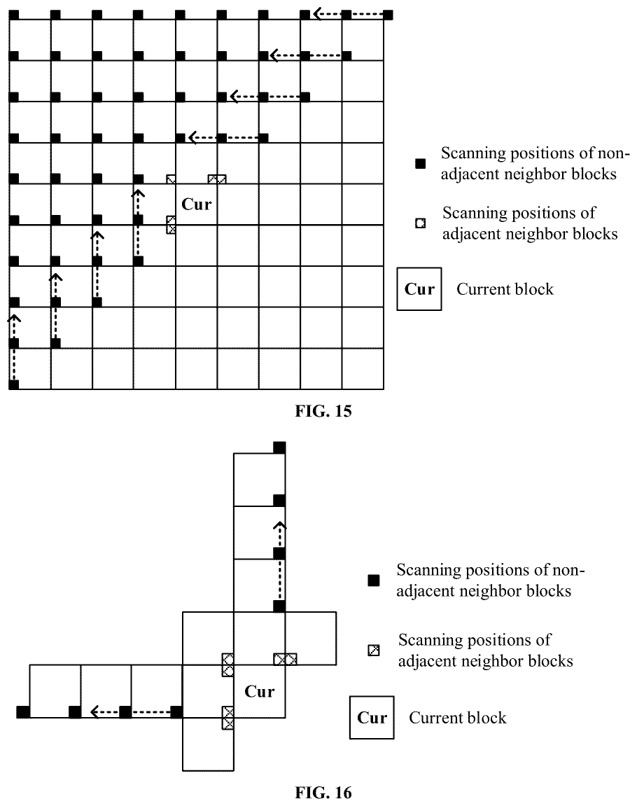

When the list of potential LTVP candidates is built, the LTVs from adjacent or non-adjacent neighbor blocks may be used for candidate derivation. In one or more embodiments, the adjacent and non-adjacent neighboring blocks used for the candidate generation may be defined as in FIG. 15 and FIG. 16.

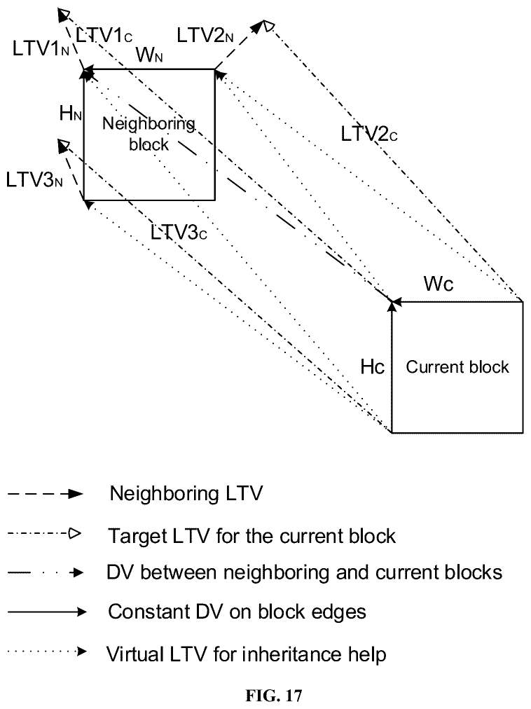

In FIG. 15, only the neighbor blocks (adjacent or non-adjacent) with 4-parameter or 6-parameter models are considered to be valid and used for inherited candidate generation. In one or more embodiments, the inheritance method may be similarly defined as the affine AMVP or merge mode for inter prediction. In another one or more embodiments, the inheritance method may be based on vector concatenation. One example of vector concatenation is shown in FIG. 17.

According to the known vectors (LTV1_{N}, LTV2_{N}, LTV3_{N}, LTV_{NC}, W_{N}, H_{N}, W_{C}, H_{C}) shown in FIG. 17, the LTVs for current block may be derived as:

$$\begin{matrix}LTV {1}_{C} = LTV {1}_{N} + {LTV}_{NC} \\ LTV {2}_{C} = {W}_{C} + {LTV}_{NC} - {W}_{N} + L T V {2}_{N} \\ LTV {3}_{C} = {H}_{C} + L T {V}_{N C} - {H}_{N} + L T V {3}_{N}\end{matrix}$$

For inheritance based LTVP candidate generation, neighboring block models with higher degree of parameters may generate same or lower degree of parameters for the current block, but may not generate higher degree of parameters. For example, 6-parameter models from neighboring blocks may generate 4-parameter or 6-parameter models for the current block, but 4-parameter models from neighboring blocks may not generate 6-parameter models for the current block.

In FIG. 16, only the translational part of each model is needed for constructed candidate generation. In one or more embodiments, the construction method may be similarly defined as the affine AMVP or merge mode for inter prediction.

### Implicit Derivation of Linear Transformation Vector

In the implicit derivation method, the LTVs for the current block are not explicitly signaled but derived from neighboring blocks. Specifically, in this mode, LTVs of spatial neighbor blocks are used to generate LTVs for the current block. To achieve this purpose, a list of LTV candidates with limited size is built at the decoder side. The encoder may evaluate and choose the best candidate index based on rate-distortion optimization algorithms. The chosen candidate index is then signaled to the decoder side. The list of the candidates (LTV candidate list) may be decided in a similar way as the decision of aforementioned LTVP candidate list.

In this implicit derivation method, the candidate list may be reordered according to bilateral matching cost or template cost, such that the most accurate candidates are likely to be replaced in the front of the list.

In this implicit derivation method, LTV with vector differences (LTVD) may be supported.

The distance set of LTVD may be predefined, and the LTVD directions may include two horizontal and two vertical directions.

The base candidates may be selected from the first N candidates in the reordered LTV candidate list. And based on the SAD cost between the template (e.g., one row above and one column left to the current block) and its reference for each refinement position, all the possible LTVD refinement positions (the size of the distance set x the size of LTVD directions) for each base candidate may be reordered. The first M refinement positions with the lowest template SAD costs may be kept as available positions, consequently for LTVD index coding.

### Non-Translational Reference Area

When LVT values are derived at the decoder or encoder side, sub-block based motion compensation may be performed. As each sub-block of the current block may use different displacement vector, each corresponding reference block needs to be checked whether it is within the reconstructed area. In one or more embodiments, only the four reference blocks corresponding the four corner sub-blocks (top-left, top-right, bottom-left and bottom-right positions) of the current block may be checked. If any of the four reference blocks falls beyond the reconstructed area, the whole set of LVTs are considered to be invalid, and the current block falls back to traditional IBC mode, which only allows two-parameter model.

### Prediction Process

In one or more embodiment, the precision of LTV may be restricted to be integer values. To this end, the output of the explicit or implicit derivation method may be rounded to the nearest integer values.

In another one or more embodiment, the precision of LTV may be restricted to be not finer than a specific sub-pel precision (e.g., not higher than ½ or -pixel precision). When sub-pel precision LTV is allowed, interpolation filters and pixel padding operations may be needed.

In case LTVs have equal values, the current block falls back to traditional IBC mode, which only allows two-parameter model. If the model has higher degree of parameters than 2-parameter, only the two translational parameters are used.

In another one or more embodiments, it proposes that IBC mode never falls back to traditional mode, but at least use 2-parameter model. This is because IBC fallback mode only derive one MV for the whole CU. As a result, it loses the advantage of sub-block based prediction. Once the current CU selects this IBC fallback mode, the model parameters can propagate to other following CUs with implicit mode. So, the overall coding efficiency is degraded.

### IBC Fallback Mode

IBC fall back mode is defined as the traditional IBC mode which is based on one translational block vector and block (PU or CU) level motion compensation.

In the multi-model based IBC mode, one of the multiple models may be based on 2 parameters. One example is shown in FIG. 13, where the 2-parameter model contains only one linear transformation vector LTV1.

In one embodiment, this 2-parameter model is the same as the IBC fallback mode (the traditional IBC mode), which contains one translational vector and performs block (PU or CU) level motion compensation.

In another embodiment, this 2-parameter model is not exactly the same as IBC fallback mode. In this case, the 2-paratmeter model may also contain one translational vector but perform sub-block (e.g., 2×2, 4×4 or 8×8 blocks with fixed size) level motion compensation.

### BVD Sign Prediction

In the second aspect of this disclosure, it is proposed to adapt the MVD sign prediction technology for BVD sign prediction. Specifically, possible BVD sign combinations are sorted according to the template matching cost and index corresponding to the true BVD sign is derived and context coded. At decoder side, the BVD signs are derived as following:
1. Parse the magnitude of BVD components
2. Parse context-coded BVD sign prediction index
3. Build BV candidates by creating combination between possible signs and absolute BVD value and add it to the BV predictor
4. Derive BVD sign prediction cost for each derived BV based on template matching cost and sort
5. Use BVD sign prediction index to pick the true BVD sign
BVD sign prediction are applied to IBC AMVP, IBC affine AMVP, IBC MMVD and IBC affine MMVD modes.

### Combined IBC-Intra/Inter Prediction

According to the one or more embodiments of the disclosure, the coding block coded with IBC mode are combined with the coding block coded with intra mode or inter mode. Different methods may be used to achieve this goal.

In the first method, it is proposed to combine the coding block coded with IBC mode with the coding block coded with intra mode. Various methods can be utilized in this combination. In one example, similar to the CIIP technology in VVC, the coding block coded with IBC merge mode is regarded as the coding block coded with inter merge mode, and it is combined with the coding block coded with planar intra prediction mode. In another example, similar to the Combination of CIIP with TIMD and TM merge technology in ECM, the coding block coded with IBC merge-TM mode is combined with the coding block coded with TIMD derived intra prediction mode.

In the second method, it is proposed to combine the coding block coded with IBC mode with the coding block coded with inter mode. Various methods can be utilized in this combination. In one example, similar to the CIIP technology in VVC, the coding block coded with IBC merge mode is regarded as the coding block coded with planar intra mode, and it is combined with the coding block coded with inter merge mode. In another example, the coding block coded with IBC merge mode is regarded as the coding block coded with inter merge mode, and it is combined with the coding block coded with inter merge mode by equally averaging.

In the third method, it is proposed to combine the coding block coded with IBC mode with the coding block coded with intra mode and the coding block coded with inter mode. Various methods can be utilized in this combination. In one example, the coding block coded with IBC mode, the coding block coded with intra mode, and the coding block coded with inter mode are directly combined by equally averaging. In another example, firstly the coding block coded with IBC mode is separately combined with the coding block coded with intra mode and inter mode as presented in the first and second method. Then, the separate combined results are combined by equally averaging.

### Multiple Hypothesis IBC Prediction

According to the one or more embodiments of the disclosure, the block vector (BV) number in IBC tool is increased to 2 or more, and 2 or more hypothesis are combined to obtain the final prediction result. Different methods may be used to achieve this goal.

In the first method, it is proposed to combine 2 hypotheses corresponding to 2 BVs to obtain the final prediction result. Various methods can be utilized to achieve this goal. In one example, the 2 BVs corresponding the smallest and the second smallest rate distortion metrics in IBC AMVP mode are equally averaged to obtain the final prediction result. In another example, the prediction result corresponding to IBC AMVP mode and the prediction result corresponding to IBC merge mode are equally averaged to obtain the final prediction result.

In the second method, it is proposed to combine more hypothesis corresponding to more BVs to obtain the final prediction result. Various methods can be utilized to achieve this goal. In one example, the iterative accumulation method proposed in multi-hypothesis prediction (MHP) technology is utilized to obtain the final prediction result. In another example, all the BVs corresponding the smallest, the second smallest, the third smallest, . . . , rate distortion metrics in IBC AMVP mode are equally averaged to obtain the final prediction result.

### Subblock-Based Temporal Motion Vector Prediction (SbTMVP)

VVC supports the subblock-based temporal motion vector prediction (SbTMVP) method. Similar to the temporal motion vector prediction (TMVP) in HEVC, SbTMVP uses the motion field in the collocated picture to improve motion vector prediction and merge mode for CUs in the current picture. The same collocated picture used by TMVP is used for SbTVMP. SbTMVP differs from TMVP in the following two main aspects:
TMVP predicts motion at CU level but SbTMVP predicts motion at sub-CU level;
Whereas TMVP fetches the temporal motion vectors from the collocated block in the collocated picture (the collocated block is the bottom-right or center block relative to the current CU), SbTMVP applies a motion shift before fetching the temporal motion information from the collocated picture, where the motion shift is obtained from the motion vector from one of the spatial neighboring blocks of the current CU.

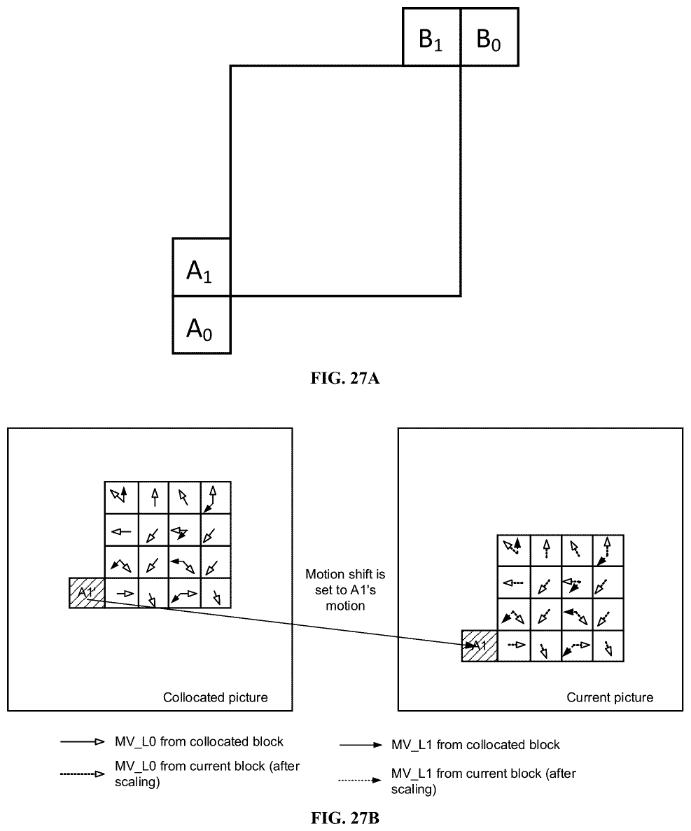

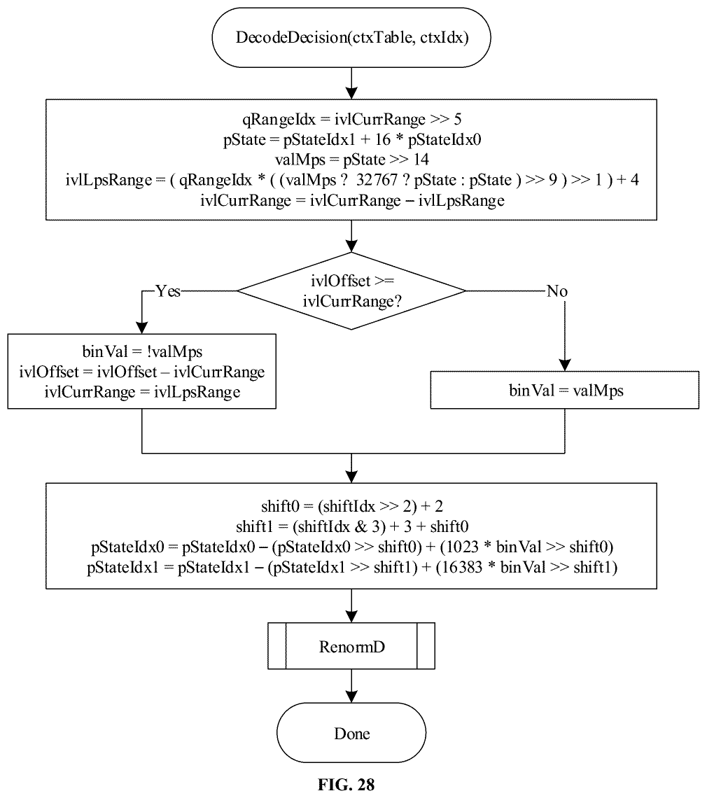

The SbTVMP process is illustrated in FIGS. 27A-27B. SbTMVP predicts the motion vectors of the sub-CUs within the current CU in two steps. In the first step, the spatial neighbor A1 in FIG. 27A is examined. If A1 has a motion vector that uses the collocated picture as its reference picture, this motion vector is selected to be the motion shift to be applied. If no such motion is identified, then the motion shift is set to (0, 0).

In the second step, the motion shift identified in Step 1 is applied (i.e., added to the current block's coordinates) to obtain sub-CU-level motion information (motion vectors and reference indices) from the collocated picture as shown in FIG. 27B. The example in FIG. 27B assumes the motion shift is set to block A1's motion. Then, for each sub-CU, the motion information of its corresponding block (the smallest motion grid that covers the center sample) in the collocated picture is used to derive the motion information for the sub-CU. After the motion information of the collocated sub-CU is identified, it is converted to the motion vectors and reference indices of the current sub-CU in a similar way as the TMVP process of HEVC, where temporal motion scaling is applied to align the reference pictures of the temporal motion vectors to those of the current CU.

In VVC, a combined subblock based merge list which contains both SbTVMP candidate and affine merge candidates is used for the signalling of subblock based merge mode. The SbTVMP mode is enabled/disabled by a sequence parameter set (SPS) flag. If the SbTMVP mode is enabled, the SbTMVP predictor is added as the first entry of the list of subblock based merge candidates, and followed by the affine merge candidates. The size of subblock based merge list is signalled in SPS and the maximum allowed size of the subblock based merge list is 5 in VVC.

The sub-CU size used in SbTMVP is fixed to be 8×8, and as done for affine merge mode, SbTMVP mode is only applicable to the CU with both width and height are larger than or equal to 8.

The encoding logic of the additional SbTMVP merge candidate is the same as for the other merge candidates, that is, for each CU in P or B slice, an additional RD check is performed to decide whether to use the SbTMVP candidate.

### The Probability Estimation Technique for the CABAC in the AVC and HEVC

The CABAC (the context-based adaptive binary arithmetic coding) was originally introduced in the H.264/AVC standard, as one of two supported entropy coding schemes. In the CABAC, arithmetic coding is composed of two modules: codeword mapping (also known as binarization) and probability estimation. In the process of codeword mapping, the syntax elements are mapped into strings of bins. The mapping is realized by the so-called binarizer which translates the syntax elements into several group of bins based on different binarization schemes. In practice, various binarization schemes may be applied for such translation, such as fixed-length code, unary code, truncated unary code, and kth-order Exponential-Golomb code and so forth. The purpose of the probability estimation module is to determine the likelihood of one bin having the value of 1 or 0. In the AVC, the probabilities of bins are calculated based on an exponential aging model, where the probability that one current bin is equal to 1 or 0 is dependent on the values of previous bins that are previously coded. Additionally, according to common data statistics, the influence of bins that are immediately precede one current bin are usually larger than the bins that are coded long ago. Taking such into consideration, one parameter α is introduced in the CABAC, which controls the number N of previously coded bins that are used to estimate the probability of the current bin, i.e., N=1/α. The parameter translates into the adaptation speed with which the probability is updated along with the increased coded bins. Specifically, with the adaptation parameter α, the probability that one bin is the least probable symbol (LPS) is calculated recursively as

$$p ( t + 1 ) = p ( t ) \cdot ( 1 - α ) + x ( t ) \cdot α \qquad ( 9 )$$

where p(t) is the probability of the LPS symbol at instant t; p(t+1) is the updated probability of the LPS symbol at instant t+1; x(t) is equal to 1 when the current bin is LPS symbol and 0 when the current bin is the most probable symbol (MPS). In the CABAC engine of the AVC and the HEVC, the probability is independently updated according to (9) for each syntax element with a fixed value of α≈1/19.69, i.e., around 19.69 previously coded bins are considered when estimating the probability of one current bin. Moreover, in order to avoid multiplications during the probability estimation, the probability p(t) in (9), which is real number and ranges from 0 to 1, is quantized into a set of fixed probability states. For example, in both the AVC and the HEVC, the probability has 7-bit precision, corresponding to 128 probability states.

In the AVC and the HEVC, a video bitstream usually consists one or more independently decodable slices. At beginning of each slice, the probabilities of all the contexts are initialized to some pre-defined values. Theoretically, with knowing the statistic nature of one given context, uniform distribution (i.e., pᵢₙᵢₜ=0.5) should be used to initialize the context probability. However, to enable a faster catchup of the probability of one context to its corresponding statistical distribution, it was found that to be beneficial to provide some appropriate initial probability values (which may not be equiprobable) for each context. Specifically, in the AVC and HEVC, given the initial QP of one slice SliceQp_{Y}, the initial probability state of one context InitProbState is calculated as follows:

$$\begin{matrix}m = SlopeIdx \cdot 5 - 45 \\ n = ( OffsetIdx ≪ 3 ) - 16 \\ InitProbState = Clip 3 ( 1 , 1 \; 27 , ( m \cdot SliceQ {P}_{Y} ) ≫ 4 + n )\end{matrix} \qquad ( 10 )$$

where SlopeIdx and OffsetIdx (both in the range from 0 to 15) are two initialization parameters, which are predefined and stored as look-up table (LUT), to calculate the initial probability of one context. As shown in (10), the initial probability state is modeled by a linear function of the slice QP with the slope equal to (m>>4) and the offset equal to n. The probability estimation technique for the CABAC in the VVC

The probability estimation module that is applied in the VVC is kept almost the same as that in the AVC and HEVC, except for the following key differences:
1. VVC maintains two probability estimates for each context, where each has its own probability adaptation rate a in (9). The final probability that is actually used for arithmetic coding is the average of the two estimates.
2. In the VVC, multiple probability LUTs are predefined and used to initialize the probabilities of different contexts of one slice. Meanwhile, similar to the AVC and the HEVC, the initial estimate of the probability is built upon one linear model taking the slice QP as the input. However, in the VVC, the derived value represents the actual probability value; whereas in the AVC/HEVC, it represents the index of the probability state.

### Multi-Hypothesis Probability Estimation

It is obvious that using one fixed adaptation parameter for all the syntax elements may not be optimal due to their different statistical characteristics. On the other hand, it has been proven in several scientific research that better estimation accuracy can be achieved by using multiple probability estimators compared to one single estimator. Therefore, one multi-hypothesis probability estimation scheme is applied in the CABAC design of the VVC, where two different adaptation parameter α₀ and α₁ are utilized, which correspond to one slow and fast speed for the probability adaptation. By such way, two different probabilities can be calculated for each bin using two adaptation parameters, which are then averaged to generate the final probability of the bin, i.e.,

$$\begin{matrix}{p}_{0} ( t + 1 ) = {p}_{0} ( t ) \cdot ( 1 - {α}_{0} ) + x ( t ) \cdot {α}_{0} \\ {p}_{1} ( t + 1 ) = {p}_{1} ( t ) \cdot ( 1 - {α}_{1} ) + x ( t ) \cdot {α}_{1} \\ p ( t + 1 ) = ( {p}_{0} ( t + 1 ) + {p}_{1} ( t + 1 ) ) / 2\end{matrix} \qquad ( 11 )$$

where α₀ and α₁ are the two adaptation parameters associated with the two probability hypotheses. In the VVC, the values of α₀ and α₁ are independently selected for each context using one training algorithm that is designed to jointly optimize the adaptation parameters as well as the initial probabilities. Specifically, according to the current design, each context is allowed to select α₀ from one set of predefined values of {¼, ⅛, 1/16, 1/32} and α₁ from another set of predefined values of { 1/32, 1/64, 1/128, 1/256, 1/512}.

### Initial Probability Calculation

As in the AVC/HEVC, the CABCA process of the VVC also invoke one QP dependent probability initialization process at the beginning of each slice. However, compared to the AVC/HEVC which initializes the state of one probability state machine, the actual value of the initial probability is directly derived, as depicted as

$$\begin{matrix}m = ( SlopeIdx ≫ 3 ) - 4 \\ n = ( ( OffsetIdx \& 7 ) \cdot 18 ) + 1 \\ InitState = Clip 3 ( 1 , 1 \; 27 , ( m \cdot ( SliceQ {P}_{Y} - 16 ) ) ≫ 1 + n ) \\ {p}_{0}^{init} = initState ≪ 7 \\ {p}_{1}^{init} = initState ≪ 3\end{matrix} \qquad ( 12 )$$

where SlopeIdx and OffsetIdxare two initialization parameters for calculating the slope and offset of the linear model, each being represented in the precision of 3 bit; p₀^{init} and p₁^{init} are the two initial probabilities calculated for two probability estimators.

### Entropy Coding in ECM

### Extended Precision

The intermediate precision used in the arithmetic coding engine is increased, including three elements. First, the precisions for two probability states are both increased to 15 bits, in comparison to 10 bits and 14 bits in VVC. Second, the LPS range update process is modified as below,

$$\begin{matrix}if q >= 16384 \\ q = {2}^{15} - 1 - q \\ {R}_{LPS} = ( ( range * ( q >> 6 ) ) >> 9 ) + 1 ,\end{matrix}$$

where range is a 9-bit variable representing the width of the current interval, q is a 15-bit variable representing the probability state of the current context model, and RLPS is the updated range for LPS. This operation can also be realized by looking up a 512×256-entry in 9-bit look-up table. Third, at the encoder side, the 256-entry look-up table used for bits estimation in VTM is extended to 512 entries.

### Slice-Type-Based Window Size

Since statistics are different with different slice types, it is beneficial to have a context's probability state updated at a rate that may provide more accurate probability estimation (e.g., to more accurately predict the likelihood of one bin having the value of 1 or 0) under the given slice type. Therefore, for each context model, three window sizes are pre-defined for I-, B-, and P-slices, respectively, like the initialization parameters.

The context initialization parameters and window sizes are retrained.

### Improved Probability Estimation for CABAC

Multi-Hypothesis Probability Estimation with Adaptive Weight

The multi-hypothesis-based probability is estimated based on adaptive weights (MHP-AW). Specifically, two separate probability estimates p₀ and p₁ are maintained for each context and updated according to their own adaptation rates. However, instead of using simple average, multiple weights are introduced to derive the resulting probability p used for the binary arithmetic coding, as illustrated as follows:

$$p = ( {ω}_{0} \cdot {p}_{0} + {ω}_{1} \cdot {p}_{1} ) ≫ s$$

where ω₀ and ω₁ are the weights selected from a pre-defined set {10, 12, 16, 20, 22}; s is the bitwise right-shift value, which is equal to 5 when (ω₀+ω₁)≤32 and 6 otherwise. Three different sets of weights are pre-determined for each context model at I-, B- and P-slice types. The weights of I-slice type are only allowed for intra slices while the weights of B- and P-slice types are allowed to be switched for inter slices at slice level.
   CABAC Initialization from Previous Inter Slice and Windows Adjustment

Context initialization stored at previously coded picture after coding the last CTU can be used to initialize an inter slice having the same slice type, QP, and temporal ID. The buffer size for storing previous initializations is set equal to 5 for each slice type, when the buffer is full, the entry with the smallest QP and temporal ID is removed first before storing the initialization.

The CABAC employs two probability states that are updated with a short and a long window size, respectively. The window sizes, predefined for each context model, are not optimal for varying statistics in different regions, hence window sizes are adjusted according to the previously coded bin of each context.

The short and long window sizes used in CABAC update are adjusted by two delta parameters stored in a look-up table per context and retrieved by a previous coded bin used as an index. The previous coded bin is used as an index to get the adjustment parameters from a look-up table: delta0 for the short window and delta1 for the long window. Denote the original short and long window sizes stored in the existed initialization tables and defined for the context model as shift0 and shift1, respectively. The actual window sizes used to code the current bin after adjustment are respectively (shift0+delta0) and (shift1+delta1), where shift0 and shift1 are existed predefined windows sizes stored in the context initialization tables.

### Problem Statement

In video coding, intra block copy is well known to accurately predict screen content and artificially generated content where patterns and edges may repeat within the frame. Intra block copy may also be beneficial for natural content predictions where the current frame has repeated textures. For the coding scenarios without too much repeated content, the mode of intra block copy may not be selected while its minimum signaling bits are still transmitted. In this case, to further enhance the coding efficiency of intra block copy, it is desired to provide more flexible on/off control mechanisms at different granularities.

In this disclosure, the coding tool of intra block copy is improved from aspects below:
Flexible on/off control mechanisms
CABAC context window
   Flexible on/Off Control Mechanisms

In this section, several methods are proposed to do on/off control for the application of the IBC mode. The on/off control indicates whether the IBC mode is allowed to be possibly enabled for the current sequence, frame, slice, CTU, or block which is at different granularities. If IBC mode is on, further flags (e.g., whether IBC mode is enabled or disabled for a specific block) or/and information (e.g., block vectors) may be signaled. If IBC mode is off, no more flags or information is signaled.

In some embodiments, the on/off control of intra block copy may be based on explicit signaling methods.

In one embodiment, the on/off control is based on one or more, sequence level, or frame level, or slice level or Coding tree unit (CTU) level, or block level flag, or any combination of different levels of flags. When any combination of different levels of flags are used, the transmission of lower level of flags are dependent on the on/off of higher level of flags. In one example, if the frame level flag indicates the turned off of IBC mode, no more flags are transmitted at slice or block level. Otherwise, lower level flag(s) is/are further transmitted.

In another embodiment, the on/off control is based on different regions. The purpose of the region concept is to provide a more flexible granularity for IBC on/off control.

In one embodiment, the region here may be defined as non-overlapping areas within a frame or a slice or a CTU. For all the blocks located within a specific region, a single on/off control flag may be signaled to indicate whether IBC mode is turned off for all these blocks are not. The size of the regions may be predefined as a set of fixed values such as M×N, or a group of signaled values.

In some other embodiments, the on/off control of intra block copy may be based on local information, and no explicit signaling is required.

In some embodiments, the on/off control is based on the prediction information.

In one embodiment, the IBC mode is always turned off for inter predicted blocks (e.g., in inter-coded frames such as B and P frames). While for intra-coded blocks, either in inter-coded frames (such as B and P frames) or intra-coded frames (such as I frame), IBC mode may be always turned on.

In another embodiment, the IBC mode is always turned off for uni-predicted or/and bi-predicted inter blocks.

Yet in another embodiment, the IBC mode is always turned off for blocks which are coded at sub-block modes. The sub-block mode is the mode which divides current block into sub-blocks and each sub-block may have its own motion information. For example, affine mode, SbTMVP mode.

In another embodiment, the IBC mode is always turned off for blocks which are not coded at sub-block modes.

In some other embodiments, the on/off control is based on the other coding information.

In one embodiment, the IBC model is always turned off when one or more other coding mode(s) is/are applied for the current block. For example, the IBC mode is always turned off when affine mode is enabled.

In some other embodiments, the on/off control is based on the frame type.

In one embodiment, the IBC mode are always turned off for B frame or/and P frame.

In some other embodiments, the on/off control is based on the block information.

In one embodiment, the IBC mode is always turned off for coding blocks smaller than a specific size (e.g., 8×8 blocks) or larger than a specific size (e.g., 64×64).

In one embodiment, the IBC mode is always turned off for wide blocks (e.g., a block with its width is M times longer than its height) or long blocks (e.g., a block with its height is N times longer than its width), while the value of M and N may be fixed values (e.g., M=2, N=3) or signaled at sequence or frame level.

### CABAC Context Window

In the current IBC design, there may be one or more IBC mode related flags which are CABAC context coded. For example, the IBC enabling flag at block level is context coded. Since statistics may be different with different slice or frame types, it is desirable to have a context's probability state updated at a rate that may provide more accurate probability estimation (e.g., to more accurately predict the likelihood of one bin having the value of 1 or 0) under the given slice/frame type.

In some embodiments, for each context model related to IBC mode, three windows may be predefined for three different slices, including I, B and P slices, respectively.

In some embodiments, for each context model related to IBC mode, two windows may be predefined for different slices with two different prediction modes, including intra-predicted (I slice) and inter-predicted slices (B and P slices), respectively.

When multiple windows are defined for different slices or frames, the context window sizes and initialization parameters may also be retrained separately or jointly.

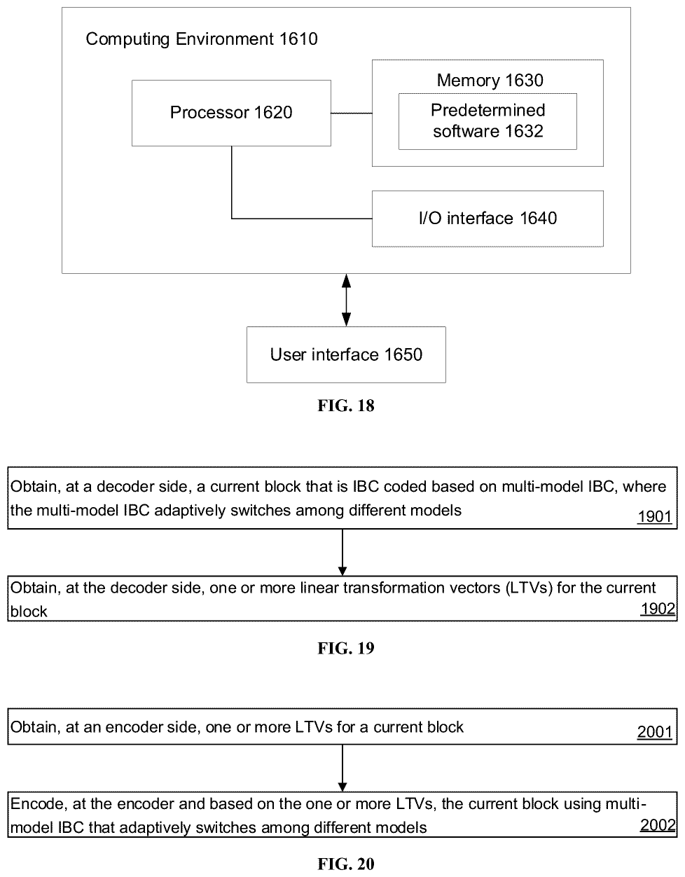

FIG. 18 shows a computing environment (or a computing device) 1610 coupled with a user interface 1660. The computing environment 1610 can be part of a data processing server. In some embodiments, the computing device 1610 can perform any of various methods or processes (such as encoding/decoding methods or processes) as described hereinbefore in accordance with various examples of the present disclosure. The computing environment 1610 may include a processor 1620, a memory 1640, and an I/O interface 1650.

The processor 1620 typically controls overall operations of the computing environment 1610, such as the operations associated with the display, data acquisition, data communications, and image processing. The processor 1620 may include one or more processors to execute instructions to perform all or some of the steps in the above-described methods. Moreover, the processor 1620 may include one or more modules that facilitate the interaction between the processor 1620 and other components. The processor may be a Central Processing Unit (CPU), a microprocessor, a single chip machine, a GPU, or the like.

The memory 1640 is configured to store various types of data to support the operation of the computing environment 1610. Memory 1640 may include predetermine software 1642. Examples of such data include instructions for any applications or methods operated on the computing environment 1610, video datasets, image data, etc. The memory 1640 may be implemented by using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The I/O interface 1650 provides an interface between the processor 1620 and peripheral interface modules, such as a keyboard, a click wheel, buttons, and the like. The buttons may include but are not limited to, a home button, a start scan button, and a stop scan button. The I/O interface 1650 can be coupled with an encoder and decoder.

In some embodiments, there is also provided a non-transitory computer-readable storage medium including a plurality of programs, such as included in the memory 1640, executable by the processor 1620 in the computing environment 1610, for performing the above-described methods. For example, the non-transitory computer-readable storage medium may be a ROM, a RAM, a CD-ROM, a magnetic tape, a floppy disc, an optical data storage device or the like.

The non-transitory computer-readable storage medium has stored therein a plurality of programs for execution by a computing device having one or more processors, where the plurality of programs when executed by the one or more processors, cause the computing device to perform the above-described method for motion prediction.

In some embodiments, the computing environment 1610 may be implemented with one or more application-specific integrated circuits (ASICs), digital signal processors (DSPs), digital signal processing devices (DSPDs), programmable logic devices (PLDs), field-programmable gate arrays (FPGAs), graphical processing units (GPUs), controllers, micro-controllers, microprocessors, or other electronic components, for performing the above methods.

FIG. 19 is a flowchart illustrating a method for video decoding according to an example of the present disclosure. The method may be implemented for decoding an inter coding block.

In Step 1901, the processor 1620, at the side of a decoder, may obtain a current block that is IBC coded based on multi-model IBC, where the multi-model IBC adaptively switches among different models.

In some examples, the multi-model IBC may adaptively switch among the different models, including one of following manners: the multi-model IBC adaptively switches between explicit derivation of the one or more LTVs and implicit derivation of the one or more LTVs; the multi-model IBC adaptively switches among a 2-parameter linear transformation model, a 4-parameter linear transformation model, and a 6-parameter linear transformation model; the multi-model IBC adaptively switches among different mode decision flows; the multi-model IBC adaptively switches among different precisions of the one or more LTVs; or the multi-model IBC adaptively switches among different representations of the one or more LTVs.

In Step 1902, the processor 1620 may obtain one or more linear transformation vectors (LTVs) for the current block.

In some examples, the processor 1620, at the side of the decoder, may obtain the one or more LTVs signaled by an encoder, where at least one of the one or more LTVs may include a linear transformation vector predictor (LTVP) and a linear transformation vector difference (LTVD).

In some examples, the processor 1620, at the side of the decoder, may further obtain an LTVP index that indicates a best LTVP selected from a list of LTVP candidates, obtain an LTVD value corresponding to the LTVP index, and obtain an LTV based on the LTVP index and the LTVD value.

The list of LTVP candidates may include various examples. For example, the list of LTVP candidates may be a 2-parameter LTVP list including one or more inherited LTVPs from adjacent neighboring blocks, one or more inherited LTVPs from non-adjacent neighbor blocks, one or more constructed LTVPs from adjacent neighboring blocks, and one or more constructed LTVPs from non-adjacent neighboring blocks. In some other examples, the list of LTVP candidates may be a 4-parameter LTVP list comprising one or more inherited LTVPs from adjacent neighboring blocks, one or more inherited LTVPs from non-adjacent neighboring blocks, one or more constructed LTVPs from adjacent neighboring blocks, and one or more constructed LTVPs from non-adjacent neighboring blocks; a 6-parameter LTVP list comprising one or more inherited LTVPs from adjacent neighboring blocks, one or more inherited LTVPs from non-adjacent neighboring blocks, one or more constructed LTVPs from adjacent neighboring blocks, and one or more constructed LTVPs from non-adjacent neighboring blocks; or a zero padded LTVP list comprising one or more zero candidates.

In some examples, the processor 1620, at the side of the decoder, may obtain a displacement vector from a current sample to a reference sample in the current block based on model parameters of the different models.

In some examples, the processor 1620, at the side of the decoder, may reorder one or more LTVP candidates in the list of LTVP candidates based on a predetermined cost, where the predetermined cost may include at least one of following costs: a bilateral matching cost or a template cost.

In some examples, the processor 1620, at the side of the decoder, may refine one or more LTVP candidates in the list of LTVP candidates based on a gradient-based iterative motion estimation process.

In some examples, the processor 1620, at the side of the decoder, may obtain a refinement for each initial LTVP candidate by refining each initial LTVP candidate in the list of LTVP candidates, obtain the best LTVP from the list of LTVP candidates based on a Sum of Absolute Transformed Difference (SATD) cost, where the best LTVP has a minimum SATD cost, and obtain the LTVD value based on the refinement corresponding to the best LTVP.

In some examples, the processor 1620, at the side of the decoder, may obtain the best LTVP with a minimum SATD cost from the list of LTVP candidates by performing the gradient-based iterative motion estimation process and refine each LTVP candidate in the list of LTVP candidates based on the gradient-based iterative motion estimation process.

In some examples, the processor 1620, at the side of the decoder, may obtain a newly updated LTV after performing the gradient-based iterative motion estimation process and compare the newly updated LTV and one or more best final LTV candidates of a parent block.

In some examples, the processor 1620, at the side of the decoder, may determine that a number of the one or more best final LTV candidates of the parent block is N and N equals to 1 in response to determining that only one LTVP candidate of the parent block is iteratively refined. In some other examples, the processor 1620, at the side of the decoder, may scale up the one or more best final LTV candidates based on a ratio of sizes between the current block and the parent block. The parent block is a block that contains the current block, i.e., the block from which the current block is split from. When an encoder tests the best partition granularity, the encoder will test large blocks, e.g., the parent blocks, first, then further split the current large blocks into smaller blocks. The encoder may explicitly derive the best motion by performing the motion estimation, then signal the best candidate index and the motion difference to the decoder, the motion difference=best motion—best candidate, where the candidate is called motion predictor which are selected from the candidate list. That is, the motion estimation process may be performed only at the encoder, but the output (motion predictor that is determined by the signaled candidate index, and the motion difference) is signaled to the decoder.

In some examples, the processor 1620, at the side of the decoder, may apply regularization to delta refinements at each iteration.

In some examples, the processor 1620, at the side of the decoder, may reduce the delta refinement in response to determining that a refined LTV yields a higher SATD cost than the refined LTV from a previous iteration.

In some examples, the processor 1620, at the side of the decoder, may obtain the one or more LTVs for the current block based on one or more adjacent or non-adjacent neighboring blocks of the current block. Furthermore, the one or more adjacent or non-adjacent neighboring blocks may include one or more adjacent or non-adjacent neighbor blocks with 4-parameter or 6-parameter models used for inherited candidate generation.

In some examples, the inherited candidate generation may be based on vector concatenation. The vector concatenation may be implemented using following steps: obtaining neighboring LTVs of an adjacent or non-adjacent neighboring block; obtaining a displacement vector between the adjacent or non-adjacent neighboring block and the current block; and obtaining the one or more LTVs for the current block based on the neighboring LTVs, the displacement vector, and sizes of the adjacent or non-adjacent neighboring block and the current block.

In some examples, the one or more adjacent or non-adjacent neighboring blocks are used for constructed candidate generation in one of following manners: affine AMVP or merge mode for inter prediction.

In some other examples, the processor 1620, at the side of the decoder, may derive the one or more LTVs for the current block based on one or more neighboring blocks of the current block. For example, the processor 1620 may derive the one or more LTVs for the current block based on LTVs of one or more spatial neighboring blocks.

In some examples, the processor 1620 may obtain an LTV index that indicates a best LTV selected from a list of LTV candidates, where the list of LTV candidates has a predetermined size.

In some examples, the LTV index may be determined by an encoder based on rate-distortion optimization algorithms.

In some examples, the processor 1620 may obtain a reordered list of LTV candidates by reordering one or more LTV candidates in the list of LTV candidates based on a predetermined cost, where the predetermined cost may include at least one of following costs: a bilateral matching cost or a template cost.

In some examples, the processor 1620 may further predefine a distance set of LTV with vector differences (LTVDs), select a base LTV candidate from first N candidates in the reordered list of LTV candidates, where N is a positive integer, and obtain a reordered list of LTVD refinement positions by reordering one or more LTVD refinement positions for the base LTV candidate based on a SAD cost between a template of the current block and a reference of each refinement position.

In some examples, the processor 1620 may further determine the one or more LTVD refinement positions based on a size of the distance set and a size of LTVD directions and select first M refinement positions from the reordered list of LTVD refinement positions for LTVD index coding.

In some examples, the processor 1620 may determine whether a reference block of the current block is within a reconstructed area, determine that the one or more LTVs are valid in response to determining that the reference block is within the reconstructed area, and determine that the one or more LTVs are invalid in response to determining that the reference block is not within the reconstructed area.

For example, the processor 1620 may determine whether the reference block of the current block is within the reconstructed area by determining whether four reference blocks corresponding to four corner sub-blocks of the current block are within the reconstructed area. For example, the four corner sub-blocks (top-left, top-right, bottom-left and bottom-right positions) of the current block may be checked.

In some examples, the processor 1620 may restrict precision of the one or more LTVs in one of following manners: restricting the precision of the one or more LTVs to be integer values or restricting the precision of the one or more LTVs to be no finer than a specific sub-pixel precision.

In some examples, the processor 1620 may restrain that the multi-model IBC applies 2-parameter model only in response to determining that two LTVs of the one or more LTVs are equal. In some other examples, the processor 1620 may determine that the multi-model IBC that adaptively switches among the different models, where each of the different models has a degree of parameters no less than 2. For example, the IBC mode never falls back to traditional mode, but at least use 2-parameter model, i.e., the degree of parameters of the model is at least 2. That is, the multi-model IBC adaptively switches among different models that have higher degree (no less than 2) of parameters. For example, the different models may include 2-parameter models, 4-parameter models, 6-parameter models, etc., thus, the degrees of parameters are 2, 4, or 6.

In some examples, the 2-parameter model performs in one of following manners: the 2-parameter model comprises one translational vector and performs block level motion compensation, or the 2-parameter model comprises one translation vector and performs sub-block level motion compensation.

FIG. 20 is a flowchart illustrating a method for video encoding corresponding the method for video decoding as shown in FIG. 19. The method may be implemented for encoding a current block.

In Step 2001, the processor 1620, at the side of an encoder, may obtain one or more linear transformation vectors (LTVs) for a current block.

In some examples, the multi-model IBC may adaptively switch among the different models, including one of following manners: the multi-model IBC adaptively switches between explicit derivation of the one or more LTVs and implicit derivation of the one or more LTVs; the multi-model IBC adaptively switches among a 2-parameter linear transformation model, a 4-parameter linear transformation model, and a 6-parameter linear transformation model; the multi-model IBC adaptively switches among different mode decision flows; the multi-model IBC adaptively switches among different precisions of the one or more LTVs; or the multi-model IBC adaptively switches among different representations of the one or more LTVs.

In Step 2002, the processor 1620 may encode, based on the one or more LTVs, the current block according to multi-model Intra block copy (IBC) that adaptively switches among different models.

In some examples, the processor 1620, at the side of the encoder, may signal the one or more LTVs, where at least one of the one or more LTVs may include a linear transformation vector predictor (LTVP) and a linear transformation vector difference (LTVD).

In some examples, the processor 1620, at the side of the encoder, may further obtain an LTVP index that indicates a best LTVP selected from a list of LTVP candidates, obtain an LTVD value corresponding to the LTVP index, and obtain an LTV based on the LTVP index and the LTVD value.

The list of LTVP candidates may include various examples. For example, the list of LTVP candidates may be a 2-parameter LTVP list including one or more inherited LTVPs from adjacent neighboring blocks, one or more inherited LTVPs from non-adjacent neighbor blocks, one or more constructed LTVPs from adjacent neighboring blocks, and one or more constructed LTVPs from non-adjacent neighboring blocks. In some other examples, the list of LTVP candidates may be a 4-parameter LTVP list comprising one or more inherited LTVPs from adjacent neighboring blocks, one or more inherited LTVPs from non-adjacent neighboring blocks, one or more constructed LTVPs from adjacent neighboring blocks, and one or more constructed LTVPs from non-adjacent neighboring blocks; a 6-parameter LTVP list comprising one or more inherited LTVPs from adjacent neighboring blocks, one or more inherited LTVPs from non-adjacent neighboring blocks, one or more constructed LTVPs from adjacent neighboring blocks, and one or more constructed LTVPs from non-adjacent neighboring blocks; or a zero padded LTVP list comprising one or more zero candidates.

In some examples, the processor 1620, at the side of the encoder, may obtain a displacement vector from a current sample to a reference sample in the current block based on model parameters of the different models.

In some examples, the processor 1620, at the side of the encoder, may reorder one or more LTVP candidates in the list of LTVP candidates based on a predetermined cost, where the predetermined cost may include at least one of following costs: a bilateral matching cost or a template cost.

In some examples, the processor 1620, at the side of the encoder, may refine one or more LTVP candidates in the list of LTVP candidates based on a gradient-based iterative motion estimation process.

In some examples, the processor 1620, at the side of the encoder, may obtain a refinement for each initial LTVP candidate by refining each initial LTVP candidate in the list of LTVP candidates, obtain the best LTVP from the list of LTVP candidates based on a Sum of Absolute Transformed Difference (SATD) cost, where the best LTVP has a minimum SATD cost, and obtain the LTVD value based on the refinement corresponding to the best LTVP.

In some examples, the processor 1620, at the side of the encoder, may obtain the best LTVP with a minimum SATD cost from the list of LTVP candidates by performing the gradient-based iterative motion estimation process and refine each LTVP candidate in the list of LTVP candidates based on the gradient-based iterative motion estimation process.

In some examples, the processor 1620, at the side of the encoder, may obtain a newly updated LTV after performing the gradient-based iterative motion estimation process and compare the newly updated LTV and one or more best final LTV candidates of a parent block.

In some examples, the processor 1620, at the side of the encoder, may determine that a number of the one or more best final LTV candidates of the parent block is N and N equals to 1 in response to determining that only one LTVP candidate of the parent block is iteratively refined. In some other examples, the processor 1620, at the side of the encoder, may scale up the one or more best final LTV candidates based on a ratio of sizes between the current block and the parent block. The parent block is a block that contains the current block, i.e., the block from which the current block is split from. When an encoder tests the best partition granularity, the encoder will test large blocks, e.g., the parent blocks, first, then further split the current large blocks into smaller blocks.

In some examples, the processor 1620, at the side of the encoder, may apply regularization to delta refinements at each iteration.

In some examples, the processor 1620, at the side of the encoder, may reduce the delta refinement in response to determining that a refined LTV yields a higher SATD cost than the refined LTV from a previous iteration.

In some examples, the processor 1620, at the side of the encoder, may obtain the one or more LTVs for the current block based on one or more adjacent or non-adjacent neighboring blocks of the current block. Furthermore, the one or more adjacent or non-adjacent neighboring blocks may include one or more adjacent or non-adjacent neighbor blocks with 4-parameter or 6-parameter models used for inherited candidate generation.

In some examples, the inherited candidate generation may be based on vector concatenation. The vector concatenation may be implemented using following steps: obtaining neighboring LTVs of an adjacent or non-adjacent neighboring block; obtaining a displacement vector between the adjacent or non-adjacent neighboring block and the current block; and obtaining the one or more LTVs for the current block based on the neighboring LTVs, the displacement vector, and sizes of the adjacent or non-adjacent neighboring block and the current block.

In some examples, the one or more adjacent or non-adjacent neighboring blocks are used for constructed candidate generation in one of following manners: affine AMVP or merge mode for inter prediction.

In some other examples, the processor 1620, at the side of the encoder, may signal an LTV index based on rate-distortion optimization algorithms, where the LTV index that indicates a best LTV selected from a list of LTV candidates, where the list of LTV candidates has a predetermined size, and where a decoder derives one or more LTVs for the current block based on one or more neighboring blocks of the current block and the LTV index.

In some examples, the processor 1620 may determine whether a reference block of the current block is within a reconstructed area, determine that the one or more LTVs are valid in response to determining that the reference block is within the reconstructed area, and determine that the one or more LTVs are invalid in response to determining that the reference block is not within the reconstructed area.

For example, the processor 1620 may determine whether the reference block of the current block is within the reconstructed area by determining whether four reference blocks corresponding to four corner sub-blocks of the current block are within the reconstructed area. For example, the four corner sub-blocks (top-left, top-right, bottom-left and bottom-right positions) of the current block may be checked.

In some examples, the processor 1620 may restrict precision of the one or more LTVs in one of following manners: restricting the precision of the one or more LTVs to be integer values or restricting the precision of the one or more LTVs to be no finer than a specific sub-pixel precision.

In some examples, the processor 1620 may restrain that the multi-model IBC applies 2-parameter model only in response to determining that two LTVs of the one or more LTVs are equal. In some other examples, the processor 1620 may determine that the multi-model IBC that adaptively switches among the different models, where each of the different models has a degree of parameters no less than 2. For example, the IBC mode never falls back to traditional mode, but at least use 2-parameter model, i.e., the degree of parameters of the model is at least 2. That is, the multi-model IBC adaptively switches among different models that have higher degree (no less than 2) of parameters. For example, the different models may include 2-parameter models, 4-parameter models, 6-parameter models, etc., thus, the degrees of parameters are 2, 4, or 6.

In some examples, the 2-parameter model performs in one of following manners: the 2-parameter model comprises one translational vector and performs block level motion compensation, or the 2-parameter model comprises one translation vector and performs sub-block level motion compensation.

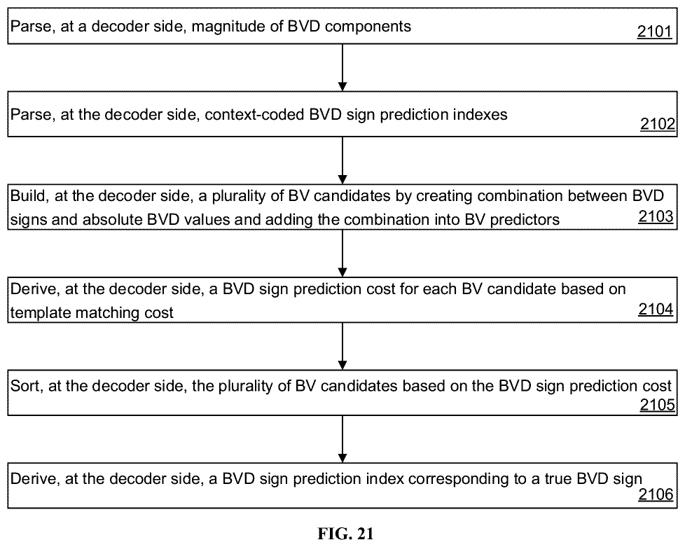

FIG. 21 is a flowchart illustrating a method for video decoding according to an example of the present disclosure.

In Step 2101, the processor 1620, at the side of a decoder, may parse magnitude of block vector difference (BVD) components.

In Step 2102, the processor 1620 may parse context-coded BVD sign prediction indexes.

In Step 2103, the processor 1620 may build a plurality of BV candidates by creating combination between BVD signs and absolute BVD values and add the combination into BV predictors.

In Step 2104, the processor 1620 may derive a BVD sign prediction cost for each BV candidate based on template matching cost.

In Step 2105, the processor 1620 may sort the plurality of BV candidates based on the BVD sign prediction cost.

In Step 2106, the processor 1620 may derive a BVD sign prediction index corresponding to a true BVD sign.

In some examples, the processor 1620 may further apply BVD sign prediction to one of following modes: Intra block copy (IBC) advanced motion vector prediction (AMVP) mode, IBC affine AMVP mode, IBC merge mode with motion vector difference (MMVD), or IBC affine MMVD mode.

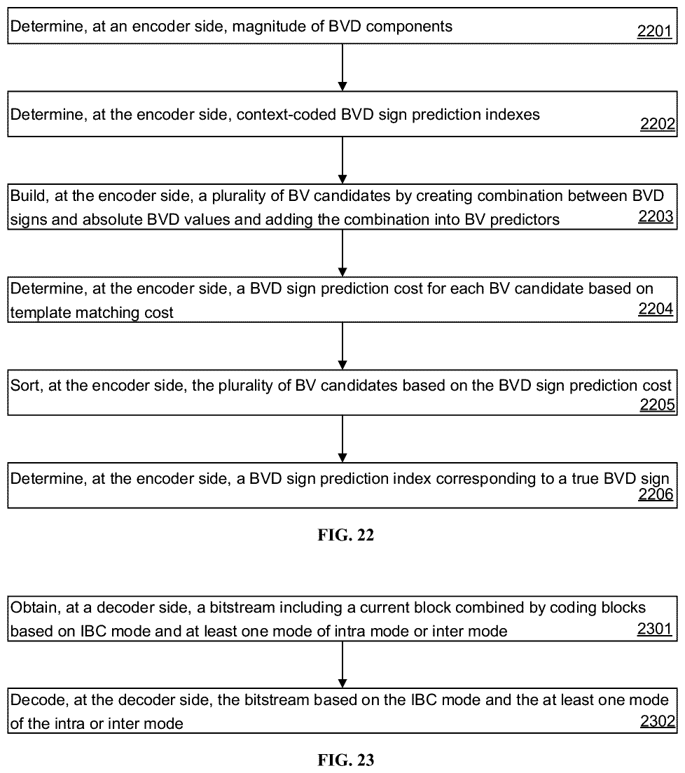

FIG. 22 is a flowchart illustrating a method for video encoding corresponding the method for video decoding as shown in FIG. 21.

In Step 2201, the processor 1620, at the side of an encoder, may determine magnitude of block vector difference (BVD) components.

In Step 2202, the processor 1620 may determine context-coded BVD sign prediction indexes.

In Step 2203, the processor 1620 may build a plurality of BV candidates by creating combination between BVD signs and absolute BVD values and add the combination into BV predictors.

In Step 2204, the processor 1620 may determine a BVD sign prediction cost for each BV candidate based on template matching cost.

In Step 2205, the processor 1620 may sort the plurality of BV candidates based on the BVD sign prediction cost.

In Step 2206, the processor 1620 may determine a BVD sign prediction index corresponding to a true BVD sign.

In some examples, the processor 1620 may further apply BVD sign prediction to one of following modes: Intra block copy (IBC) advanced motion vector prediction (AMVP) mode, IBC affine AMVP mode, IBC merge mode with motion vector difference (MMVD), or IBC affine MMVD mode.

FIG. 23 is a flowchart illustrating a method for video decoding according to an example of the present disclosure.

In Step 2301, the processor 1620, at the side of a decoder, may obtain a bitstream including a current block combined by coding blocks based on Intra block copy (IBC) mode and at least one mode of intra mode or inter mode.

In Step 2302, the processor 1620 may decode the bitstream based on the IBC mode and the at least one mode of the intra or inter mode.

In some examples, the bitstream is coded by combining coding blocks that are coded in one of following manners: combining a first coding block coded with IBC merge mode and a second coding block coded with planar intra prediction mode; combining the first coding block coded with IBC merge-TM mode and the second coding block coded with TIMD derived intra prediction mode; combining the first coding block coded with IBC merge mode and the second coding block coded with inter merge mode, wherein the first coding block and the second coding block are combined in an equally averaging manner; or combining the first coding block coded with IBC mode, the second coding block coded with intra mode, and a third coding block coded with inter mode. For example, combining the first coding block coded with IBC mode, the second coding block coded with intra mode, and the third coding block coded with inter mode may be implemented by combining the first coding block coded with IBC mode, the second coding block coded with intra mode, and the third coding block coded with inter mode in an equally averaging manner.

In some examples, combining the first coding block coded with IBC mode, the second coding block coded with intra mode, and the third coding block coded with inter mode may be implemented by obtaining a first combined coding block by combining the first coding block coded with IBC mode and the second coding block coded with intra mode; obtaining a second combined coding block by combining the first coding block coded with IBC mode and the second coding block coded with inter mode; and combining the first combined coding block and the second combined coding block in an equally averaging manner.

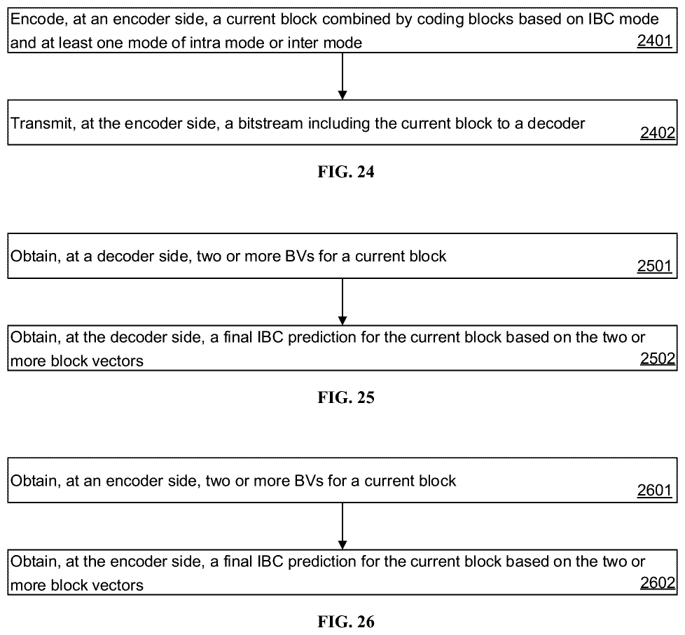

FIG. 24 is a flowchart illustrating a method for video encoding corresponding the method for video decoding as shown in FIG. 23.

In Step 2401, the processor 1620, at the side of an encoder, may encode a current block combined by coding blocks based on Intra block copy (IBC) mode and at least one mode of intra mode or inter mode.

In Step 2402, the processor 1620 may transmit a bitstream including the current block to a decoder.

In some examples, the bitstream is coded by combining coding blocks that are coded in one of following manners: combining a first coding block coded with IBC merge mode and a second coding block coded with planar intra prediction mode; combining the first coding block coded with IBC merge-TM mode and the second coding block coded with TIMD derived intra prediction mode; combining the first coding block coded with IBC merge mode and the second coding block coded with inter merge mode, wherein the first coding block and the second coding block are combined in an equally averaging manner; or combining the first coding block coded with IBC mode, the second coding block coded with intra mode, and a third coding block coded with inter mode. For example, combining the first coding block coded with IBC mode, the second coding block coded with intra mode, and the third coding block coded with inter mode may be implemented by combining the first coding block coded with IBC mode, the second coding block coded with intra mode, and the third coding block coded with inter mode in an equally averaging manner.

In some examples, combining the first coding block coded with IBC mode, the second coding block coded with intra mode, and the third coding block coded with inter mode may be implemented by obtaining a first combined coding block by combining the first coding block coded with IBC mode and the second coding block coded with intra mode; obtaining a second combined coding block by combining the first coding block coded with IBC mode and the second coding block coded with inter mode; and combining the first combined coding block and the second combined coding block in an equally averaging manner.

FIG. 25 is a flowchart illustrating a method for video decoding according to an example of the present disclosure.

In Step 2501, the processor 1620, at the side of a decoder, may obtain two or more block vectors (BVs) for a current block.

In Step 2502, the processor 1620 may obtain a final intra block copying (IBC) prediction for the current block based on the two or more block vectors.

In some examples, the processor 1620 may obtain a first BV corresponding to a smallest rate distortion matrix in IBC AMVP mode, obtain a second BV corresponding to a second smallest rate distortion matrix in IBC AMVP mode, and obtain the final IBC prediction by equally averaging the first BV and the second BV.

In some examples, the processor 1620 may obtain a first IBC prediction based on a first BV corresponding to an IBC AMVP mode, obtain a second IBC prediction based on a second BV corresponding to an IBC merge mode, and obtain the final IBC prediction by equally averaging the first IBC prediction and the second IBC prediction.

In some examples, the processor 1620 may obtain the final IBC prediction using an iterative accumulation method.

In some examples, the processor 1620 may obtain the two or more BVs respectively corresponding to different rate distortion metrics in IBC AMVP mode and obtain the final IBC prediction by equally averaging the two or more BVs.

FIG. 26 is a flowchart illustrating a method for video encoding corresponding the method for video decoding as shown in FIG. 25.

In Step 2601, the processor 1620, at the side of an encoder, may obtain two or more block vectors (BVs) for a current block.

In Step 2602, the processor 1620 may obtain a final intra block copying (IBC) prediction for the current block based on the two or more block vectors.

In some examples, the processor 1620 may obtain a first BV corresponding to a smallest rate distortion matrix in IBC AMVP mode, obtain a second BV corresponding to a second smallest rate distortion matrix in IBC AMVP mode, and obtain the final IBC prediction by equally averaging the first BV and the second BV.

In some examples, the processor 1620 may obtain a first IBC prediction based on a first BV corresponding to an IBC AMVP mode, obtain a second IBC prediction based on a second BV corresponding to an IBC merge mode, and obtain the final IBC prediction by equally averaging the first IBC prediction and the second IBC prediction.

In some examples, the processor 1620 may obtain the final IBC prediction using an iterative accumulation method.

In some examples, the processor 1620 may obtain the two or more BVs respectively corresponding to different rate distortion metrics in IBC AMVP mode and obtain the final IBC prediction by equally averaging the two or more BVs.

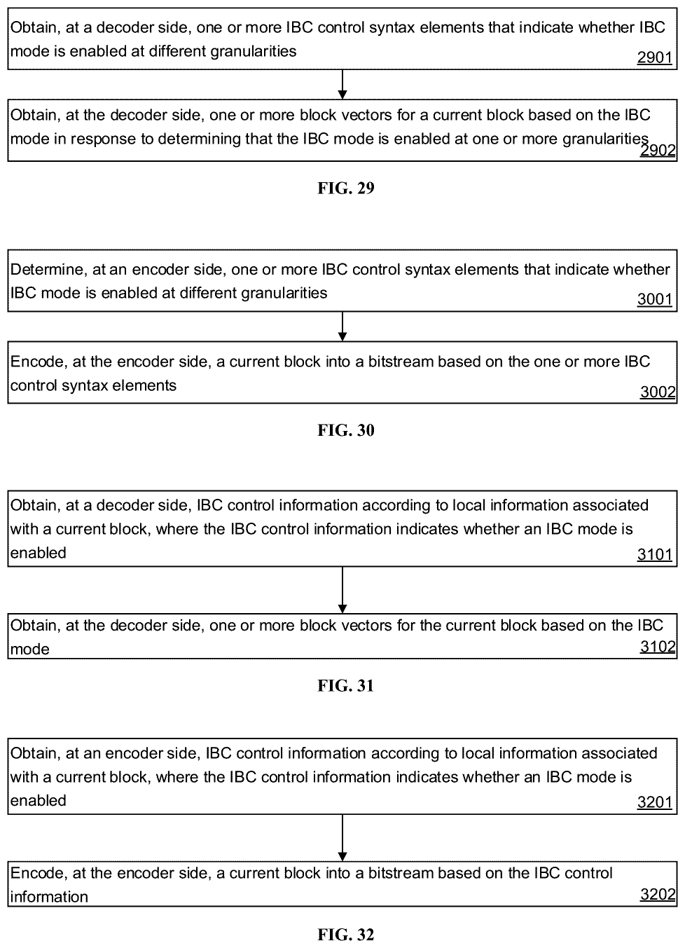

FIG. 29 is a flowchart illustrating a method for video decoding according to an example of the present disclosure. In the method illustrated in FIG. 29, the on/off control of intra block copy may be based on explicit signaling methods.

In Step 2901, the processor 1620, at the side of a decoder, may obtain one or more IBC control syntax elements that indicate whether IBC mode is enabled at different granularities.

In some examples, the different granularities may include a plurality of coding levels, and the one or more IBC control syntax elements indicate whether the IBC mode is enabled at the plurality of coding levels.

In some examples, when any combination of different levels of flags are used, the transmission of lower level of flags are dependent on the on/off of higher level of flags. For example, if the frame level flag indicates the turned off of IBC mode, no more flags are transmitted at slice or block level. Otherwise, lower-level flag(s) is/are further transmitted. In some examples, the plurality of coding levels may include a sequence level, a frame level, a slice level, a coding tree unit level, and a block level, each control syntax element indicates whether the IBC mode is enabled at at least one of the plurality of coding levels, the one or more IBC control syntax elements may include a first control syntax element and a second control syntax element, the first control syntax element indicates whether the IBC mode is enabled at a first coding level, the second control syntax element indicates whether the IBC mode is enabled at a second coding level, and the first coding level is higher than the second coding level.

Furthermore, the processor 1620 may perform at least one of following steps including: obtain the second control syntax element and determine whether the second control syntax element indicates that the IBC mode is enabled at the second coding level in response to determining that the first control syntax element indicates that the IBC mode is enabled at the first coding level; or determine that no second control syntax element is transmitted in response to determining that the first control syntax element indicates that the IBC mode is not enabled at the first coding level.

In some examples, the flexible on/off control for the application of the IBC mode is based on different regions. For example, the different granularities may include different regions and the processor 1620, at the side of the decoder, may predefine the different regions as non-overlapping areas within one of followings: a frame, a slice, or a CTU. For example, the processor 1620 may predefine sizes of the different regions as a set of fixed values.

In Step 2902, the processor 1620, at the side of the decoder, may obtain one or more block vectors for a current block based on the IBC mode in response to determining that the IBC mode is enabled at one or more granularities.

FIG. 30 is a flowchart illustrating a method for video encoding corresponding the method for video decoding as shown in FIG. 29.

In Step 2801, the processor 1620, at the side of an encoder, may determine one or more IBC control syntax elements that indicate whether IBC mode is enabled at different granularities.

In some examples, the different granularities may include a plurality of coding levels, and the one or more IBC control syntax elements indicate whether the IBC mode is enabled at the plurality of coding levels.

In some examples, when any combination of different levels of flags are used, the transmission of lower level of flags are dependent on the on/off of higher level of flags. For example, if the frame level flag indicates the turned off of IBC mode, no more flags are transmitted at slice or block level. Otherwise, lower-level flag(s) is/are further transmitted. In some examples, the plurality of coding levels may include a sequence level, a frame level, a slice level, a coding tree unit level, and a block level, each control syntax element indicates whether the IBC mode is enabled at at least one of the plurality of coding levels, the one or more IBC control syntax elements may include a first control syntax element and a second control syntax element, the first control syntax element indicates whether the IBC mode is enabled at a first coding level, the second control syntax element indicates whether the IBC mode is enabled at a second coding level, and the first coding level is higher than the second coding level.

Furthermore, the processor 1620 may perform at least one of following steps including: determine the second control syntax element and transmit the second control syntax element that indicates whether the IBC mode is enabled at the second coding level in response to determining that the first control syntax element indicates that the IBC mode is enabled at the first coding level; or determine not to transmit the second control syntax element in response to determining that the first control syntax element indicates that the IBC mode is not enabled at the first coding level.

In some examples, the flexible on/off control for the application of the IBC mode is based on different regions. For example, the different granularities may include different regions and the processor 1620, at the side of the encoder, may predefine the different regions as non-overlapping areas within one of followings: a frame, a slice, or a CTU. For example, the processor 1620 may predefine sizes of the different regions as a set of fixed values.

In Step 3002, the processor 1620, at the side of the encoder, may encode a current block into a bitstream based on the one or more IBC control syntax elements.

FIG. 31 is a flowchart illustrating a method for video decoding according to an example of the present disclosure. In the method illustrated in FIG. 31, the on/off control of intra block copy may be based on local information, and no explicit signaling is required.

In Step 3101, the processor 1620, at the side of a decoder, may obtain IBC control information according to local information associated with a current block, where the IBC control information indicates whether IBC mode is enabled.

In some examples, the local information may include at least one of following information: prediction information, coding information, frame types, or block information.

In some examples, the on/off control of the IBC mode may be based on the prediction information. For example, the processor 1620 may perform one of following steps: determine that the IBC control information indicates that the IBC mode is not enabled in response to determining that the current block is an inter predicted block, e.g., in inter-coded frames such as B or P frames; determine that the IBC control information indicates that the IBC mode is enabled in response to determining that the current block is an intra predicted block, either in inter-coded frames (such as B and P frames) or intra-coded frames (such as I frame); determine that that the IBC control information indicates that the IBC mode is not enabled in response to determining that the current block is a uni-predicted inter block; determine that the IBC control information indicates that the IBC mode is not enabled in response to determining that the current block is coded at a sub-block mode; determine that the IBC control information indicates that the IBC mode is not enabled in response to determining that the current block is not coded at a sub-block mode; determine that the IBC control information indicates that the IBC mode is not enabled in response to determining that a coding mode other than the IBC mode is applied to the current block; determine that the IBC control information indicates that the IBC mode is not enabled in response to determining that the current block is a B frame block or a P frame block; determine that the IBC control information indicates that the IBC mode is not enabled in response to determining that a size of the current block is smaller than or larger than a specific size, for example, smaller than a specific size such as 8×8 or larger than a specific size such as 64×64; or determine that the IBC control information indicates that the IBC mode is not enabled in response to determining that the current block is a wide block or a long block.

In some examples, the wide block has a first width and a first height, and the first width is M times longer than the first height, the long block has a second width and a second height, and the second height is N times longer than the second width, and M and N are fixed values or signaled at a sequence level or a frame level.

In Step 3102, the processor 1620, at the side of the decoder, may obtain one or more block vectors for the current block based on the IBC mode in response to determining that the IBC mode is enabled.

FIG. 32 is a flowchart illustrating a method for video encoding corresponding the method for video decoding as shown in FIG. 31.

In Step 3201, the processor 1620, at the side of an encoder, may obtain IBC control information according to local information associated with a current block, where the IBC control information indicates whether IBC mode is enabled.

In some examples, the local information may include at least one of following information: prediction information, coding information, frame types, or block information.

In some examples, the on/off control of the IBC mode may be based on the prediction information. For example, the processor 1620 may perform one of following steps: determine that the IBC control information indicates that the IBC mode is not enabled in response to determining that the current block is an inter predicted block, e.g., in inter-coded frames such as B or P frames; determine that the IBC control information indicates that the IBC mode is enabled in response to determining that the current block is an intra predicted block, either in inter-coded frames (such as B and P frames) or intra-coded frames (such as I frame); determine that that the IBC control information indicates that the IBC mode is not enabled in response to determining that the current block is a uni-predicted inter block; determine that the IBC control information indicates that the IBC mode is not enabled in response to determining that the current block is coded at a sub-block mode; determine that the IBC control information indicates that the IBC mode is not enabled in response to determining that the current block is not coded at a sub-block mode; determine that the IBC control information indicates that the IBC mode is not enabled in response to determining that a coding mode other than the IBC mode is applied to the current block; determine that the IBC control information indicates that the IBC mode is not enabled in response to determining that the current block is a B frame block or a P frame block; determine that the IBC control information indicates that the IBC mode is not enabled in response to determining that a size of the current block is smaller than or larger than a specific size, for example, smaller than a specific size such as 8×8 or larger than a specific size such as 64×64; or determine that the IBC control information indicates that the IBC mode is not enabled in response to determining that the current block is a wide block or a long block.

In some examples, the wide block has a first width and a first height, and the first width is M times longer than the first height, the long block has a second width and a second height, and the second height is N times longer than the second width, and M and N are fixed values or signaled at a sequence level or a frame level.

In Step 3202, the processor 1620, at the side of the encoder, may encode a current block into a bitstream based on the IBC control information.

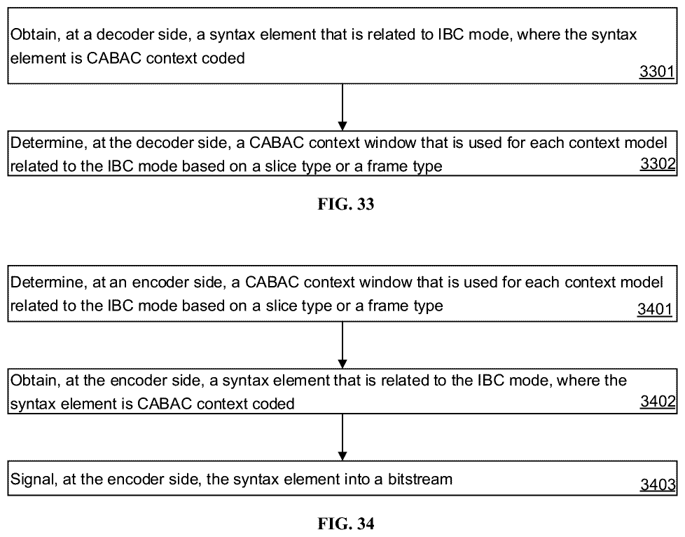

FIG. 33 is a flowchart illustrating a method for video decoding according to an example of the present disclosure. In the method illustrated in FIG. 33, multiple windows may be predefined bases on different slice and/or frame types.

In Step 3301, the processor 1620, at the side of a decoder, may obtain a syntax element that is related to IBC mode, where the syntax element is CABAC context coded.

In Step 3302, the processor 1620, at the side of the decoder, may determine a CABAC context window that is used for each context model related to the IBC mode based on a slice type or a frame type.

In some examples, the processor 1620 may determine that multiple CABAC context windows are predefined for different slice types or different frame types based on the slice type or the frame type. For example, the processor 1620 may determine that three different CABAC context windows are predefined for three different slice types, where the three different slice types may include I, B, and P. In another example, the processor 1620 may determine that two different CABAC context windows are predefined for different slices with different slice types and different prediction modes.

In some examples, the processor 1620 may determine that a first CABAC context window is used for the current slice in response to determining that a current slice is an intra-predicted I slice and determine that a second CABAC context window is used for the current slice in response to determining that the current slice is an inter-predicted B slice or an inter-predicted P slice, where the first CABAC context window and the second CABAC context window are two different CABAC context windows.

In some examples, when multiple windows are defined for different slices or frames, the context window sizes and initialization parameters may also be retrained separately or jointly.

FIG. 34 is a flowchart illustrating a method for video encoding corresponding the method for video decoding as shown in FIG. 33.

In Step 3401, the processor 1620, at the side of an encoder, may determine a CABAC context window that is used for each context model related to IBC mode based on the slice type or the frame type.

In Step 3402, the processor 1620, at the side of the encoder, may obtain a syntax element that is related to the IBC mode, where the syntax element is CABAC context coded.

In Step 3403, the processor 1620, at the side of the encoder, may signal the syntax element into a bitstream.

In some examples, the processor 1620 may determine that multiple CABAC context windows are predefined for different slice types or different frame types based on the slice type or the frame type. For example, the processor 1620 may determine that three different CABAC context windows are predefined for three different slice types, where the three different slice types may include I, B, and P. In another example, the processor 1620 may determine that two different CABAC context windows are predefined for different slices with different slice types and different prediction modes.

In some examples, the processor 1620 may determine that a first CABAC context window is used for the current slice in response to determining that a current slice is an intra-predicted I slice and determine that a second CABAC context window is used for the current slice in response to determining that the current slice is an inter-predicted B slice or an inter-predicted P slice, where the first CABAC context window and the second CABAC context window are two different CABAC context windows.

In some examples, when multiple windows are defined for different slices or frames, the context window sizes and initialization parameters may also be retrained separately or jointly.

According to an aspect of present disclosure, a method for video decoding is provided, the method comprises obtaining, by a decoder, one or more Intra Block Copy (IBC) control syntax elements that indicate whether IBC mode is enabled at different granularities, and in response to determining that the IBC mode is enabled at one or more granularities, obtaining, by the decoder, one or more block vectors for a current block based on the IBC mode.

In some examples, the different granularities comprise a plurality of coding levels, and the one or more IBC control syntax elements indicate whether the IBC mode is enabled at the plurality of coding levels.

In some examples, the plurality of coding levels comprise a sequence level, a frame level, a slice level, a coding tree unit level, and a block level, each control syntax element indicates whether the IBC mode is enabled at at least one of the plurality of coding levels, the one or more IBC control syntax elements comprise a first control syntax element and a second control syntax element, the first control syntax element indicates whether the IBC mode is enabled at a first coding level, the second control syntax element indicates whether the IBC mode is enabled at a second coding level, and the first coding level is higher than the second coding level, wherein the method further comprises at least one of following steps: in response to determining that the first control syntax element indicates that the IBC mode is enabled at the first coding level, obtaining, by the decoder, the second control syntax element and determining, by the decoder, whether the second control syntax element indicates that the IBC mode is enabled at the second coding level; or in response to determining that the first control syntax element indicates that the IBC mode is not enabled at the first coding level, determining, by the decoder, that no second control syntax element is transmitted.

In some examples, the different granularities comprise different regions, and wherein the method further comprises predefining the different regions as non-overlapping areas within one of followings: a frame, a slice, or a CTU.

In some examples, the method further comprises predefining sizes of the different regions as a set of fixed values.

According to an aspect of present disclosure, a method for video encoding is provided, the method comprises: determining, by an encoder, one or more Intra Block Copy (IBC) control syntax elements that indicate whether IBC mode is enabled at different granularities, and encoding, by the encoder, a current block into a bitstream based on the one or more IBC control syntax elements.

According to an aspect of present disclosure, a method for video decoding is provided, the method comprises: obtaining, by a decoder, Intra Block Copy (IBC) control information according to local information associated with a current block, wherein the IBC control information indicates whether IBC mode is enabled, and in response to determining that the IBC mode is enabled, obtaining, by the decoder, one or more block vectors for the current block based on the IBC mode.

In some examples, the local information comprises at least one of following information: prediction information, coding information, frame types, or block information.

In some examples, the method further comprises one of following steps: in response to determining that the current block is an inter predicted block, determining, by the decoder, that the IBC control information indicates that the IBC mode is not enabled; in response to determining that the current block is an intra predicted block, determining, by the decoder, that the IBC control information indicates that the IBC mode is enabled; in response to determining that the current block is a uni-predicted inter block, determining, by the decoder, that the IBC control information indicates that the IBC mode is not enabled; in response to determining that the current block is a bi-predicted inter block, determining, by the decoder, that the IBC control information indicates that the IBC mode is not enabled; in response to determining that the current block is coded at a sub-block mode, determining, by the decoder, that the IBC control information indicates that the IBC mode is not enabled; or in response to determining that the current block is not coded at a sub-block mode, determining, by the decoder, that the IBC control information indicates that the IBC mode is not enabled.

In some examples, the method further comprises: in response to determining that a coding mode other than the IBC mode is applied to the current block, determining, by the decoder, that the IBC control information indicates that the IBC mode is not enabled.

In some examples, the method further comprises: in response to determining that the current block is a B frame block or a P frame block, determining, by the decoder, that the IBC control information indicates that the IBC mode is not enabled.

In some examples, the method further comprises one of following steps: in response to determining that a size of the current block is smaller than or larger than a specific size, determining, by the decoder, that the IBC control information indicates that the IBC mode is not enabled; or in response to determining that the current block is a wide block or a long block, determining, by the decoder, that the IBC control information indicates that the IBC mode is not enabled.

In some examples, the wide block has a first width and a first height, and the first width is M times longer than the first height, wherein the long block has a second width and a second height, and the second height is N times longer than the second width, and wherein M and N are fixed values or signaled at a sequence level or a frame level.

According to an aspect of present disclosure, a method for video encoding is provided, the method comprises: obtaining, by an encoder, Intra Block Copy (IBC) control information according to local information associated with a current block, wherein the IBC control information indicates whether an IBC mode is enabled; and encoding, by the encoder, a current block into a bitstream based on the IBC control information.

According to an aspect of present disclosure, a method for video decoding is provided, the method comprises: obtaining, by a decoder, a syntax element that is related to Intra Block Copy (IBC) mode, wherein the syntax element is Context Adaptive Binary Arithmetic Coding (CABAC) context coded; and determining, by the decoder and based on a slice type or a frame type, a CABAC context window that is used for each context model related to the IBC mode.

In some examples, the method further comprises: determining, by the decoder and based on the slice type or the frame type, that multiple CABAC context windows are predefined for different slice types or different frame types.

In some examples, the method further comprises: determining, by the decoder, that three different CABAC context windows are predefined for three different slice types, wherein the three different slice types comprise I, B, and P.

In some examples, the method further comprises: determining, by the decoder, that two different CABAC context windows are predefined for different slices with different slice types and different prediction modes.

In some examples, the method further comprises: comprises: in response to determining that a current slice is an intra-predicted I slice, determining, by the decoder, that a first CABAC context window is used for the current slice; and in response to determining that the current slice is an inter-predicted B slice or an inter-predicted P slice, determining, by the decoder, that a second CABAC context window is used for the current slice, wherein the first CABAC context window and the second CABAC context window are two different CABAC context windows.

In some examples, the method further comprises: jointly or separately retraining sizes and initialization parameters of the multiple CABAC context windows.

According to an aspect of present disclosure, a method for video encoding is provided, the method comprises: determining, by an encoder and based on a slice type or a frame type, a Context Adaptive Binary Arithmetic Coding (CABAC) context window that is used for each context model related to Intra Block Copy (IBC) mode; obtaining, by the encoder, a syntax element that is related to the IBC mode, wherein the syntax element is CABAC context coded; and encoding, by the encoder, the syntax element into a bitstream.

In some examples, there is provided an apparatus for video coding. The apparatus includes a processor 1620 and a memory 1640 configured to store instructions executable by the processor; where the processor, upon execution of the instructions, is configured to perform any method as illustrated in FIGS. 19-26 and 29-34.

In some other examples, there is provided a non-transitory computer readable storage medium, having instructions stored therein. When the instructions are executed by a processor 1620, the instructions cause the processor to perform any method as illustrated in FIGS. 19-26 and 29-34. In one example, the plurality of programs may be executed by the processor 1620 in the computing environment 1610 to receive (for example, from the video encoder 20 in FIG. 1G) a bitstream or data stream including encoded video information (for example, video blocks representing encoded video frames, and/or associated one or more syntax elements, etc.), and may also be executed by the processor 1620 in the computing environment 1610 to perform the decoding method described above according to the received bitstream or data stream. In another example, the plurality of programs may be executed by the processor 1620 in the computing environment 1610 to perform the encoding method described above to encode video information (for example, video blocks representing video frames, and/or associated one or more syntax elements, etc.) into a bitstream or data stream, and may also be executed by the processor 1620 in the computing environment 1610 to transmit the bitstream or data stream (for example, to the video decoder 30 in FIG. 2B). Alternatively, the non-transitory computer-readable storage medium may have stored therein a bitstream or a data stream including encoded video information (for example, video blocks representing encoded video frames, and/or associated one or more syntax elements etc.) generated by an encoder (for example, the video encoder 20 in FIG. 1G) using, for example, the encoding method described above for use by a decoder (for example, the video decoder 30 in FIG. 2B) in decoding video data. The non-transitory computer-readable storage medium may be, for example, a ROM, a Random Access Memory (RAM), a CD-ROM, a magnetic tape, a floppy disc, an optical data storage device or the like.

Other examples of the disclosure will be apparent to those skilled in the art from consideration of the specification and practice of the disclosure disclosed here. This application is intended to cover any variations, uses, or adaptations of the disclosure following the general principles thereof and including such departures from the present disclosure as come within known or customary practice in the art. It is intended that the specification and examples be considered as exemplary only.

It will be appreciated that the present disclosure is not limited to the exact examples described above and illustrated in the accompanying drawings, and that various modifications and changes can be made without departing from the scope thereof.

What is claimed is:

1. A method for video decoding, comprising:
obtaining, by a decoder, a current block that is Intra block copy (IBC) coded based on multi-model IBC, wherein the multi-model IBC adaptively switches among different models; and
obtaining, by the decoder, one or more linear transformation vectors (LTVs) for the current block.

2. The method of claim 1, wherein the multi-model IBC adaptively switches among the different models comprises at least one of following manners:
the multi-model IBC adaptively switches between explicit derivation of the one or more LTVs and implicit derivation of the one or more LTVs;
the multi-model IBC adaptively switches among a 2-parameter linear transformation model, a 4-parameter linear transformation model, and a 6-parameter linear transformation model;
the multi-model IBC adaptively switches among different mode decision flows;
the multi-model IBC adaptively switches among different precisions of the one or more LTVs; or
the multi-model IBC adaptively switches among different representations of the one or more LTVs.

3. The method of claim 1, wherein obtaining the one or more LTVs for the current block comprises:
obtaining, by the decoder, the one or more LTVs signaled by an encoder, wherein at least one of the one or more LTVs comprises a linear transformation vector predictor (LTVP) and a linear transformation vector difference (LTVD).

4. The method of claim 3, further comprising:
obtaining, by the decoder, an LTVP index that indicates a best LTVP selected from a list of LTVP candidates; and
obtaining, by the decoder, an LTVD value corresponding to the LTVP index; and
obtaining, by the decoder, an LTV based on the LTVP index and the LTVD value,
wherein the list of LTVP candidates comprises at least one of following lists:
a 2-parameter LTVP list comprising one or more inherited LTVPs from adjacent neighboring blocks, one or more inherited LTVPs from non-adjacent neighbor blocks, one or more constructed LTVPs from adjacent neighboring blocks, and one or more constructed LTVPs from non-adjacent neighboring blocks;
a 4-parameter LTVP list comprising one or more inherited LTVPs from adjacent neighboring blocks, one or more inherited LTVPs from non-adjacent neighboring blocks, one or more constructed LTVPs from adjacent neighboring blocks, and one or more constructed LTVPs from non-adjacent neighboring blocks;
a 6-parameter LTVP list comprising one or more inherited LTVPs from adjacent neighboring blocks, one or more inherited LTVPs from non-adjacent neighboring blocks, one or more constructed LTVPs from adjacent neighboring blocks, and one or more constructed LTVPs from non-adjacent neighboring blocks; or
a zero padded LTVP list comprising one or more zero candidates.

5. The method of claim 1, further comprising:
obtaining, by the decoder, a displacement vector from a current sample to a reference sample in the current block based on model parameters of the different models.

6. The method of claim 4, further comprising:
reordering, by the decoder, one or more LTVP candidates in the list of LTVP candidates based on a predetermined cost, wherein the predetermined cost comprises at least one of following costs: a bilateral matching cost or a template cost.

7. The method of claim 4, further comprising:
refining, by the decoder, one or more LTVP candidates in the list of LTVP candidates based on a gradient-based iterative motion estimation process.

8. The method of claim 7, further comprising:
obtaining, by the decoder, a refinement for each initial LTVP candidate by refining each initial LTVP candidate in the list of LTVP candidates;
obtaining, by the decoder, the best LTVP from the list of LTVP candidates based on a Sum of Absolute Transformed Difference (SATD) cost, wherein the best LTVP has a minimum SATD cost; and
obtaining, by the decoder, the LTVD value based on the refinement corresponding to the best LTVP.

9. The method of claim 7, further comprising:
obtaining, by the decoder, the best LTVP with a minimum SATD cost from the list of LTVP candidates by performing the gradient-based iterative motion estimation process; and
refining, by the decoder, each LTVP candidate in the list of LTVP candidates based on the gradient-based iterative motion estimation process.

10. The method of claim 7, further comprising:
obtaining, by the decoder, a newly updated LTV after performing the gradient-based iterative motion estimation process; and
comparing, by the decoder, the newly updated LTV and one or more best final LTV candidates of a parent block,
wherein a number of the one or more best final LTV candidates of the parent block is N, and N is a positive integer;
wherein the method further comprises:
in response to determining that only one LTVP candidate of the parent block is iteratively refined, determining, by the decoder, that N equals to 1; or
scaling up the one or more best final LTV candidates based on a ratio of sizes between the current block and the parent block.

11. The method of claim 7, further comprising:
applying, by the decoder, regularization to delta refinements at each iteration; and
in response to determining that a refined LTV yields a higher SATD cost than the refined LTV from a previous iteration, reducing, by the decoder, the delta refinement.

12. The method of claim 1, wherein obtaining, by the decoder, the one or more LTVs for the current block comprises:
obtaining, by the decoder, the one or more LTVs for the current block based on one or more adjacent or non-adjacent neighboring blocks of the current block,
wherein the one or more adjacent or non-adjacent neighboring blocks comprise one or more adjacent or non-adjacent neighbor blocks with 4-parameter or 6-parameter models used for inherited candidate generation, and
wherein the inherited candidate generation is based on vector concatenation, and
wherein the one or more adjacent or non-adjacent neighboring blocks are used for constructed candidate generation in one of following manners: affine AMVP or merge mode for inter prediction,
wherein the vector concatenation comprises:
obtaining, by the decoder, neighboring LTVs of an adjacent or non-adjacent neighboring block;
obtaining, by the decoder, a displacement vector between the adjacent or non-adjacent neighboring block and the current block; and
obtaining, by the decoder, the one or more LTVs for the current block based on the neighboring LTVs, the displacement vector, and sizes of the adjacent or non-adjacent neighboring block and the current block.

13. The method of claim 1, wherein obtaining, by the decoder, the one or more LTVs for the current block comprises:
deriving, by the decoder, the one or more LTVs for the current block based on LTVs of one or more spatial neighboring blocks.

14. The method of claim 13, further comprising:
obtaining, by the decoder, an LTV index that indicates a best LTV selected from a list of LTV candidates, wherein the list of LTV candidates has a predetermined size, wherein the LTV index is determined by an encoder based on rate-distortion optimization algorithms.

15. The method of claim 14, further comprising:
obtaining, by the decoder, a reordered list of LTV candidates by reordering one or more LTV candidates in the list of LTV candidates based on a predetermined cost, wherein the predetermined cost comprises at least one of following costs: a bilateral matching cost or a template cost, wherein the obtaining of the reordered list of LTV candidates comprises:
predefining, by the decoder, a distance set of LTV with vector differences (LTVDs); and
selecting, by the decoder, a base LTV candidate from first N candidates in the reordered list of LTV candidates, wherein N is a positive integer; and
obtaining, by the decoder, a reordered list of LTVD refinement positions by reordering one or more LTVD refinement positions for the base LTV candidate based on a SAD cost between a template of the current block and a reference of each refinement position,
wherein the method further comprises:
determining, by the decoder, the one or more LTVD refinement positions based on a size of the distance set and a size of LTVD directions; or
selecting, by the decoder, first M refinement positions from the reordered list of LTVD refinement positions for LTVD index coding.

16. The method of claim 1, further comprising:
determining, by the decoder, whether a reference block of the current block is within a reconstructed area;
in response to determining that the reference block is within the reconstructed area, determining, by the decoder, that the one or more LTVs are valid; and
in response to determining that the reference block is not within the reconstructed area, determining, by the decoder, that the one or more LTVs are invalid,
wherein determining whether the reference block of the current block is within the reconstructed area comprises:
determining whether four reference blocks corresponding to four corner sub-blocks of the current block are within the reconstructed area.

17. The method of claim 1, further comprising:
restricting, by the decoder, precision of the one or more LTVs in one of following manners:
restricting the precision of the one or more LTVs to be integer values; or
restricting the precision of the one or more LTVs to be no finer than a specific sub-pixel precision.

18. The method of claim 1, further comprising:
in response to determining that two LTVs of the one or more LTVs are equal, restraining, by the decoder, that the multi-model IBC applies 2-parameter model only; or
determining, by the decoder, that the multi-model IBC that adaptively switches among the different models, wherein each of the different models has a degree of parameters that is no less than 2,
wherein the 2-parameter model performs in one of following manners:
the 2-parameter model comprises one translational vector and performs block level motion compensation; or
the 2-parameter model comprises one translation vector and performs sub-block level motion compensation.

19. An apparatus for video decoding, comprising:
one or more processors; and
a memory coupled to the one or more processors and configured to store instructions executable by the one or more processors,
wherein the one or more processors, upon execution of the instructions, are configured to receive a bitstream and perform operations for video decoding based on the bitstream, the operations comprise:
obtaining, by a decoder, a current block that is Intra block copy (IBC) coded based on multi-model IBC, wherein the multi-model IBC adaptively switches among different models; and
obtaining, by the decoder, one or more linear transformation vectors (LTVs) for the current block.

20. A non-transitory computer-readable storage medium for storing a bitstream to be decoded by a method for video decoding comprising:
obtaining, by a decoder, a current block that is Intra block copy (IBC) coded based on multi-model IBC, wherein the multi-model IBC adaptively switches among different models; and
obtaining, by the decoder, one or more linear transformation vectors (LTVs) for the current block.
